(19) United States
(12) Patent Application Publication
(10) Pub. No.: US 2026/0368821 A1
(43) Pub. Date: Nov. 19, 2026

(54) SYSTEMS AND METHODS FOR ROBOADVISING OF CRYPTOGRAPHIC AND OTHER ASSETS

(71) Applicants: Eric W. Kendrick, Austin, TX (US); Sebastian Ordas, Austin, TX (US)

(72) Inventors: Eric W. Kendrick, Austin, TX (US); Sebastian Ordas, Austin, TX (US)

(21) Appl. No.: 19/675,212

(22) Filed: May 12, 2026

Related U.S. Application Data
(60) Provisional application No. 63/804,545, filed on May 12, 2025.

(51) Int. Cl. G06Q 40/06

(52) U.S. Cl. CPC G06Q 40/063

(57) ABSTRACT

Examples relate to automated cryptocurrency portfolio management systems. A user interface collects investment preferences and risk parameters through an interactive questionnaire to generate a risk tolerance score. A portfolio management engine maps the score to model allocations across cryptocurrency and traditional assets, with a risk dial enabling dynamic portfolio adjustments. An artificial intelligence system processes weekly technical analysis of holdings charts to generate trading signals. Multi-party computation wallets distribute cryptocurrency private keys across nodes while maintaining automated trading capabilities. The system integrates with qualified custodians to provide unified portfolio monitoring across digital and traditional investments. Portfolio models automatically rebalance based on risk dial inputs and technical indicators while maintaining regulatory compliance through an internet-only adviser framework

### CROSS-REFERENCE TO RELATED APPLICATION

This patent application claims the benefit of U.S. Provisional Patent Application No. 63/804,545, filed May 12, 2025, which is incorporated by reference herein in its entirety.

### TECHNICAL FIELD

The present disclosure generally relates to roboadvising, and more specifically, to roboadvising for cryptographic and other assets.

### BACKGROUND

Crypto assets include digital asset that have a digital representation of value that you can transfer, store, or trade electronically. It would be beneficial to improve roboadvising for crypto assets.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document. Various ones of the appended drawings merely illustrate example embodiments of the present inventive subject matter and cannot be considered as limiting its scope.

FIG. 1 is a user interface diagram illustrating initial user type selection options for a digital asset management platform, according to some examples.

FIG. 2 is a user interface diagram illustrating investment goal selection options, according to some examples.

FIG. 3 is a user interface diagram illustrating investment knowledge assessment options, according to some examples.

FIG. 4 is a user interface diagram illustrating current asset holdings selection options, according to some examples.

FIG. 5 is a user interface diagram illustrating investment time horizon selection options, according to some examples.

FIG. 6 is a user interface diagram illustrating portfolio objective selection options, according to some examples.

FIG. 7 is a user interface diagram illustrating market decline scenario response options, according to some examples.

FIG. 8 is a user interface diagram illustrating market decline reaction options, according to some examples.

FIG. 9 is a user interface diagram illustrating risk/return preference options for a 10% scenario, according to some examples.

FIG. 10 is a user interface diagram illustrating risk/return preference options for a 20% scenario, according to some examples.

FIG. 11 is a user interface diagram illustrating risk/return preference options for a 30% scenario, according to some examples.

FIG. 12 is a user interface diagram illustrating cryptocurrency exposure preference options, according to some examples.

FIG. 13 is a user interface diagram illustrating risk tolerance rating selection options, according to some examples.

FIG. 14 is a user interface diagram illustrating transition to compliance data collection, according to some examples.

FIG. 15 is a user interface diagram illustrating demographic data collection options, according to some examples.

FIG. 16 is a user interface diagram illustrating occupation selection options, according to some examples.

FIG. 17 is a user interface diagram illustrating employment status selection options, according to some examples.

FIG. 18 is a user interface diagram illustrating income source selection options, according to some examples.

FIG. 19 is a user interface diagram illustrating household income range selection options, according to some examples.

FIG. 20 is a user interface diagram illustrating household net worth range selection options, according to some examples.

FIG. 21 is a user interface diagram illustrating tax bracket selection options, according to some examples.

FIG. 22 is a user interface diagram illustrating terms and conditions acceptance, according to some examples.

FIG. 23 is a user interface diagram illustrating portfolio management dashboard with risk level adjustment controls, according to some examples.

FIG. 24 is a user interface diagram illustrating expanded terms and conditions content, according to some examples.

FIG. 25 is a user interface diagram illustrating portfolio holdings display with cryptocurrency allocations, according to some examples.

FIG. 26 is a user interface diagram illustrating detailed cryptocurrency portfolio allocations, according to some examples.

FIG. 27 is a user interface diagram illustrating conservative portfolio model allocations, according to some examples.

FIG. 28 is a user interface diagram illustrating aggressive portfolio model allocations, according to some examples.

FIG. 29 is a user interface diagram illustrating portfolio holdings across multiple custodians, according to some examples.

FIG. 30 is a user interface diagram illustrating cryptocurrency management strategy selection options, according to some examples.

FIG. 31 is a user interface diagram illustrating traditional asset management strategy selection options, according to some examples.

FIG. 32 is a user interface diagram illustrating portfolio strategy confirmation display, according to some examples.

FIG. 33 is a user interface diagram illustrating investment amount selection options, according to some examples.

FIGS. 34-43 illustrate various embodiments for a fiduciary duty-compatible AI agent, according to some examples.

FIGS. 44-57 are screenshots for a website for the AI agent of FIGS. 34-43, according to some examples.

### DETAILED DESCRIPTION

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

Digital asset management technology enables automated portfolio allocation and risk-adjusted trading of cryptocurrency and traditional assets. The described examples may provide systems and methods for managing investment portfolios through interactive interfaces and artificial intelligence.

In some examples, users can complete an online questionnaire to assess their risk tolerance, investment objectives, and time horizon. Based on these responses, the system may recommend a portfolio model with specific asset allocations. The interface allows users to adjust their risk level on a scale from 1 to 10, with the portfolio automatically rebalancing in response.

The portfolio management system can integrate multiple types of assets. For cryptocurrency holdings, the system may utilize multi-party computation (MPC) wallets to secure private keys across distributed nodes without single points of failure. Traditional assets like ETFs and stocks may be held at qualified custodians. This hybrid approach allows unified portfolio management across both digital and traditional investments.

The automated trading engine analyzes technical indicators and market data to generate buy, sell, or hold signals. At the end of each week, the system may review holdings charts and apply artificial intelligence to determine optimal position adjustments based on predefined parameters and risk targets. The AI component can evaluate replacement assets when positions need to be rotated.

Portfolio models may be constructed with different risk profiles and asset mixes. A conservative model at risk level 1 might hold primarily fixed income and traditional ETFs with minimal crypto exposure. An aggressive model at risk level 8 could allocate higher percentages to cryptocurrencies like Bitcoin and Ethereum along with growth-oriented traditional assets.

The risk dial interface enables users to dynamically adjust their portfolio's risk level. When a user moves the dial, the system automatically calculates new target allocations aligned with the selected risk profile. This allows portfolios to adapt as user preferences or market conditions change.

For cryptocurrency holdings, the system may offer different management approaches. A “Managed Bitcoin” strategy actively adjusts Bitcoin exposure based on market cycles. The “Focus5” approach maintains five actively managed crypto positions selected and rebalanced according to trends. Users can also choose to simply hold Bitcoin long-term or gain crypto exposure through traditional ETFs.

The technology operates under regulatory frameworks for internet-based investment advisers. Advice is delivered through an interactive platform without personalized recommendations as per SEC regulations. Instead, the user enter certain customized information (e.g., income information, net worth information), and the techniques described herein the use roboadvicement to generate a portfolio, a trading strategy, a trade and so on. The system maintains records of trades, positions, and risk adjustments to ensure compliance with applicable rules.

Portfolio monitoring occurs continuously through automated systems. The interface displays current holdings, allocation percentages, and risk metrics in real-time. Users can view their portfolio composition across different custodians and asset types through a unified dashboard.

The described examples may include affiliate marketing capabilities to enable referral-based distribution. The system can track and compensate affiliates who help onboard new users while maintaining compliance with regulatory requirements. This creates a scalable way to grow the user base.

Security features are implemented throughout the system architecture. Multi-party computation protects cryptocurrency private keys by distributing them across multiple parties. Traditional assets are held at qualified custodians with industry-standard safeguards. The platform itself employs encryption and other technical measures to secure user data and trading activity.

The technology addresses technical challenges around portfolio construction, risk management, and asset custody in digital markets. By automating key functions like rebalancing, trade execution, and compliance monitoring, the system may reduce manual intervention while maintaining precise control over portfolio allocations.

Integration with external data sources and trading venues allows the system to maintain current market information and execute transactions efficiently. Technical analysis signals can be processed continuously to identify trading opportunities aligned with each portfolio's risk parameters and objectives.

The interface presents portfolio information in an accessible format while maintaining technical precision. Users can view their current risk level, asset allocations, and portfolio composition through standardized displays. The system may generate reports and statements to document trading activity and performance.

Through this combination of automated portfolio management, risk controls, and secure custody solutions, the described examples seek to address technical requirements for managing hybrid portfolios of digital and traditional assets. The technology enables systematic implementation of investment strategies while allowing user control through the risk adjustment interface.

In some examples a risk dial is a novel technical component of the automated portfolio management system that enables dynamic adjustment of portfolio allocations. Here are some further technical details:

### Interface Implementation:

Presents as an interactive 1-10 Scale allowing users to modify their portfolio risk level
Integrated into the main portfolio dashboard interface for real-time adjustments
Displays current risk setting and corresponding portfolio allocations

### Technical Operation:

Maps numerical risk levels to specific portfolio model allocations
Automatically calculates new target allocations when risk level is adjusted
Triggers the portfolio management engine to execute rebalancing trades across custody locations

### Risk Level Examples:

Risk Level 1 (Conservative): Weighted toward fixed income (33.3%), large cap stocks (8.3%), with minimal crypto exposure
Risk Level 5: Balanced allocation across crypto assets including Bitcoin (12%), Ethereum (14%), and stablecoins (10%)
Risk Level 8: Higher crypto allocation including Bitcoin (6.7%), Ethereum (6.7%) plus increased equity exposure across large cap (8.3%), mid cap (8.3%), and small cap (8.3%)

### Integration Points:

Connects with AI analysis system for weekly portfolio monitoring
Interfaces with multi-party computation wallet system for crypto rebalancing
Coordinates with qualified custodians for traditional asset adjustments
Maintains compliance records of all risk level changes

The risk dial serves as the primary mechanism for users to dynamically adjust their portfolio risk exposure without requiring manual rebalancing or advisor intervention. When a user moves the dial, the system automatically implements the new target allocations while maintaining regulatory compliance under the internet-only adviser framework.

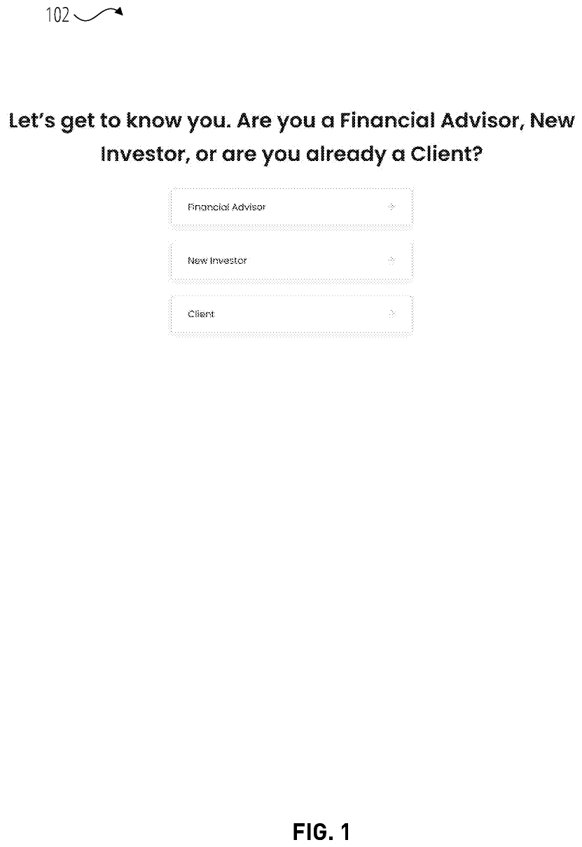

Turning now to the figures, FIG. 1 is a user interface diagram showing an initial view of a digital asset management platform, according to some examples. The interface includes three selectable user type options (Financial Advisor, New Investor, Client) that determine the subsequent onboarding flow.

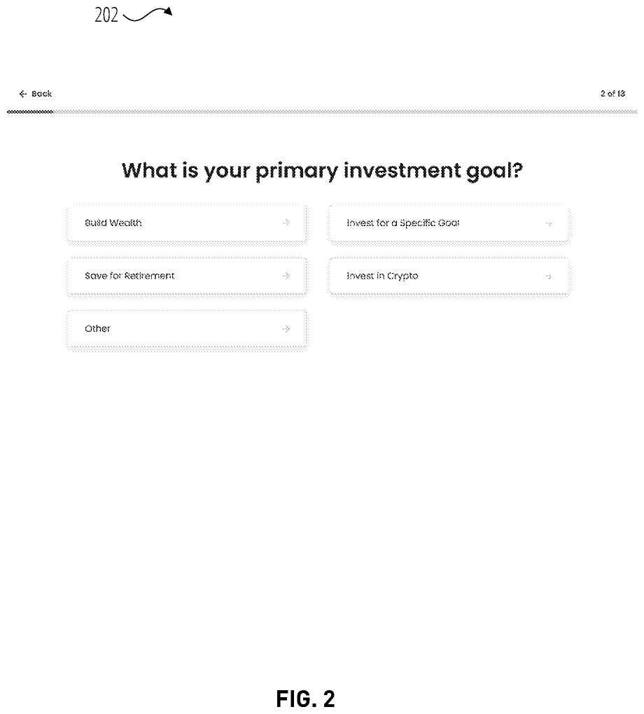

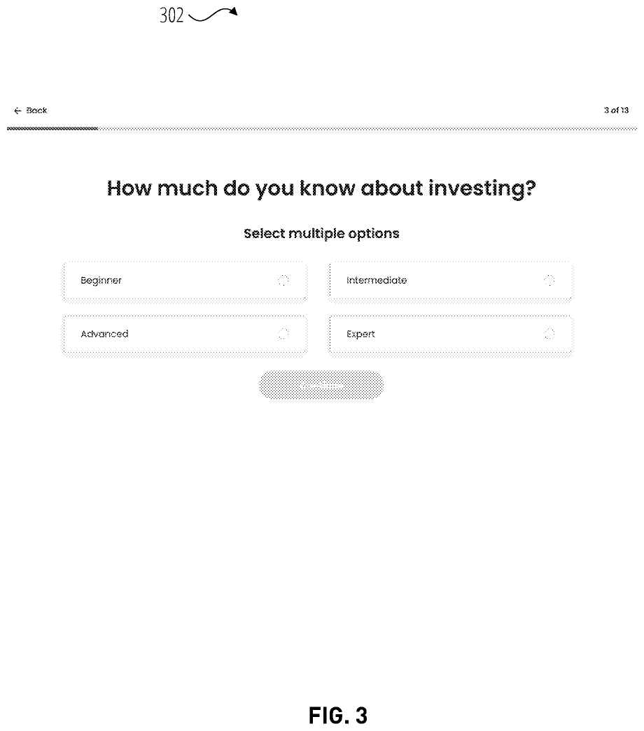

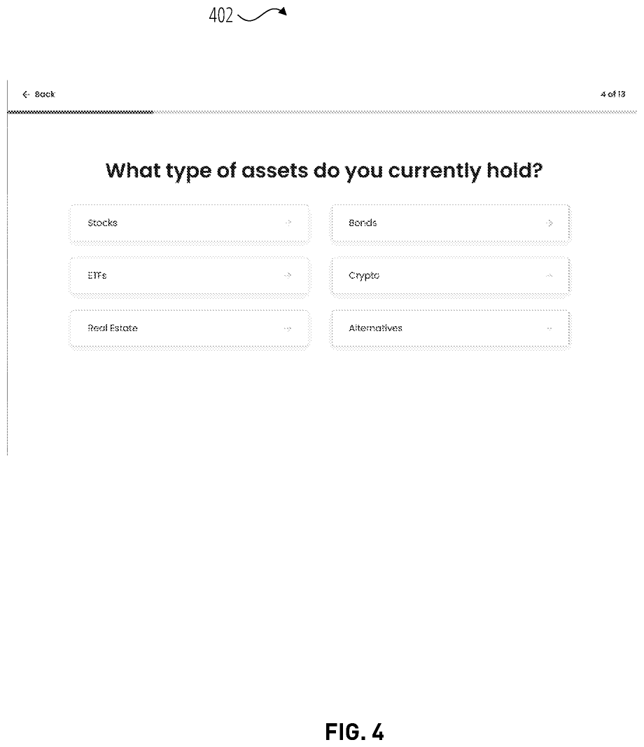

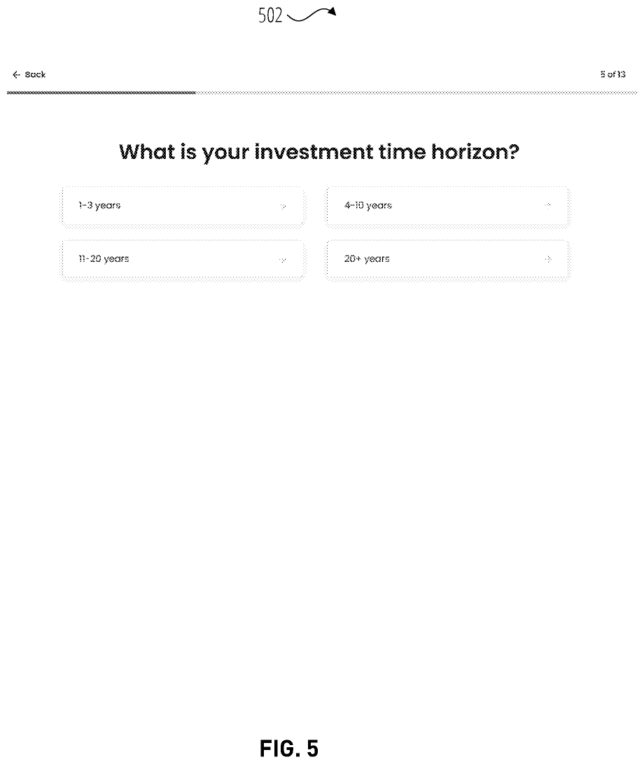

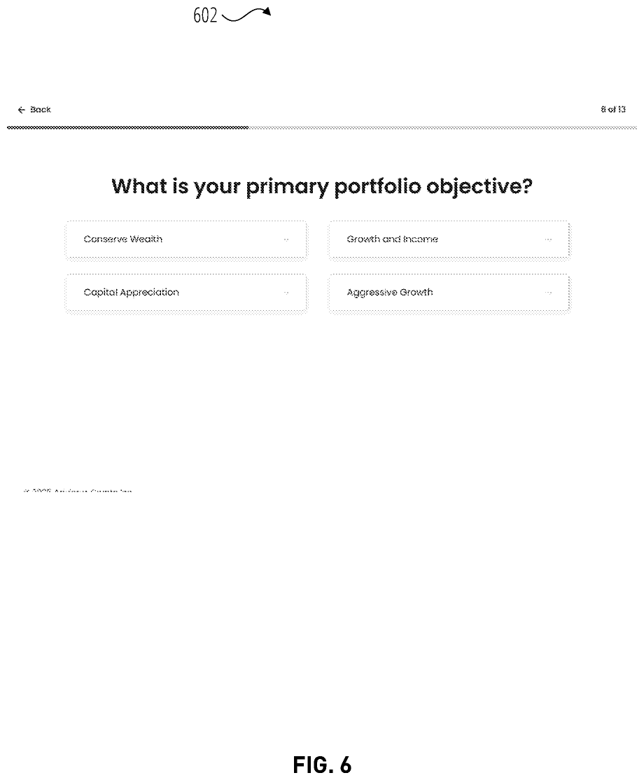

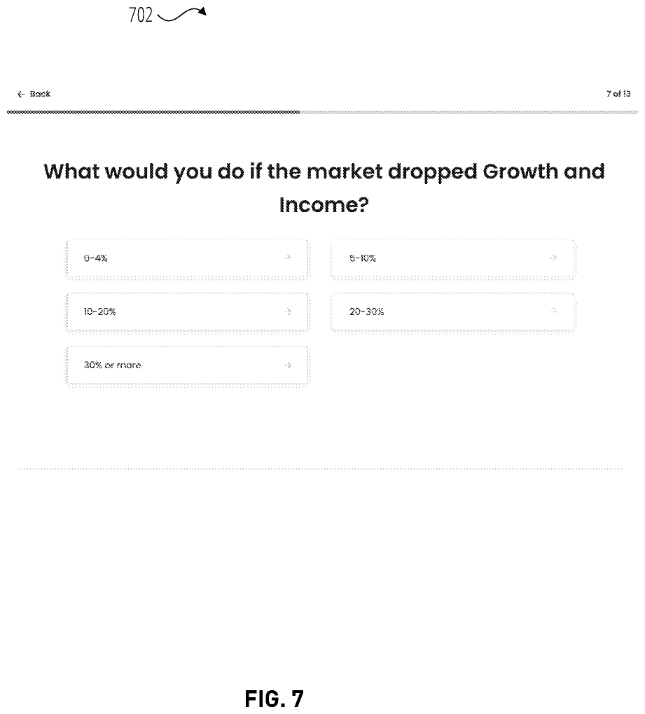

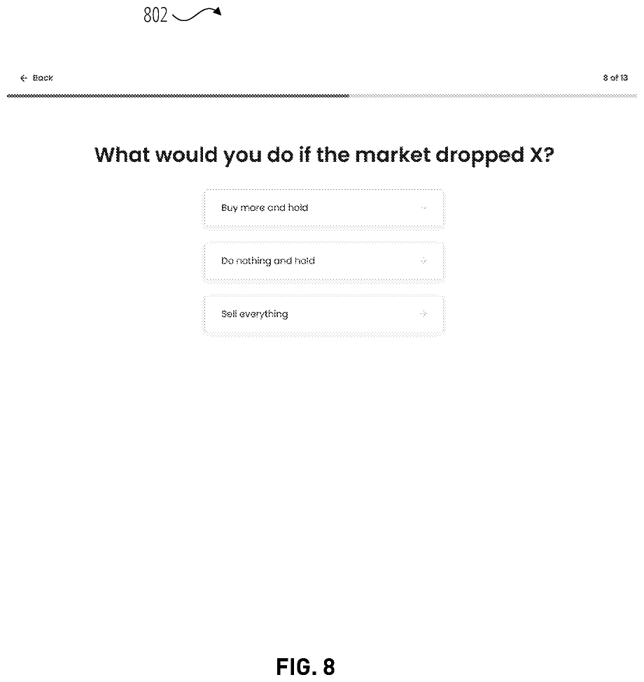

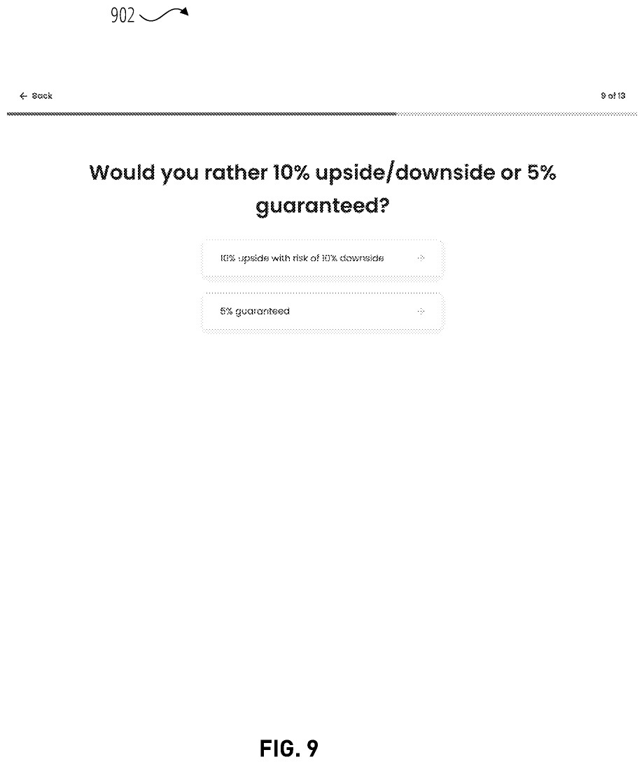

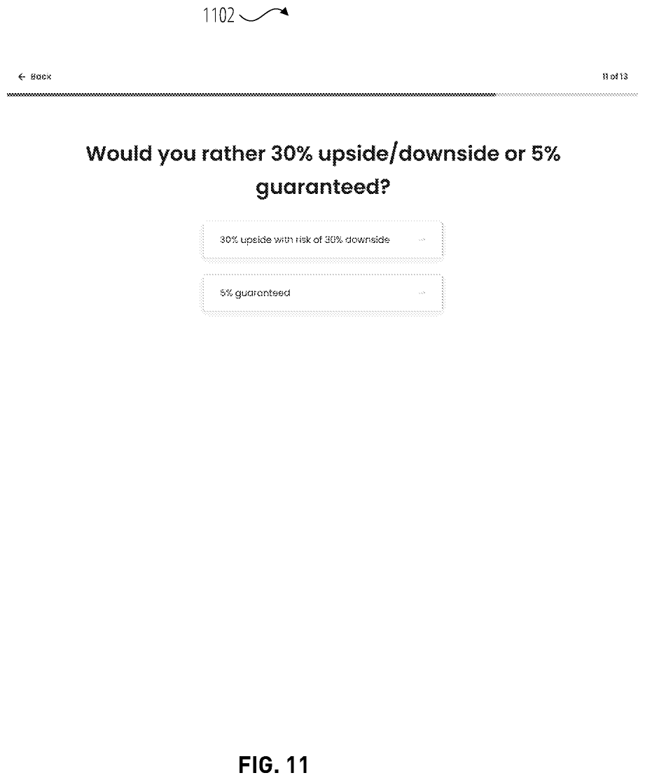

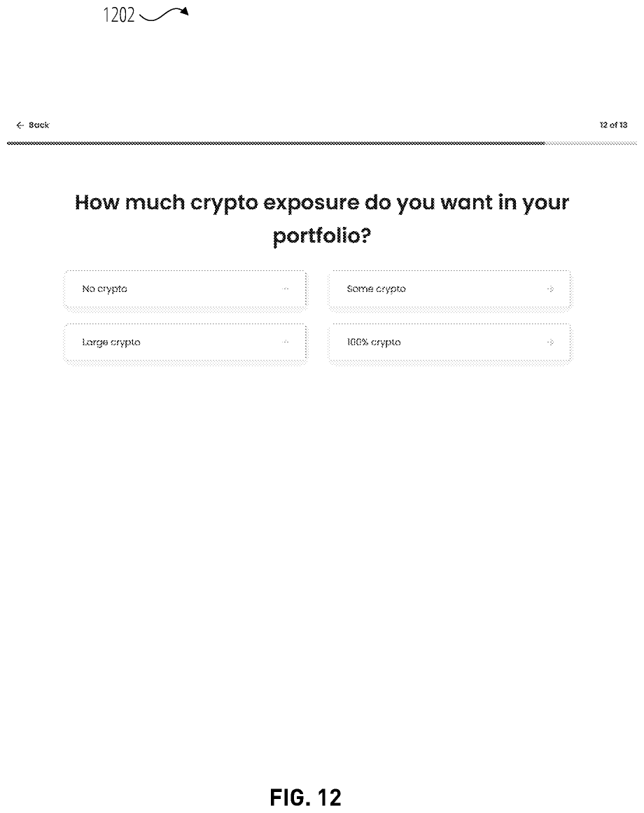

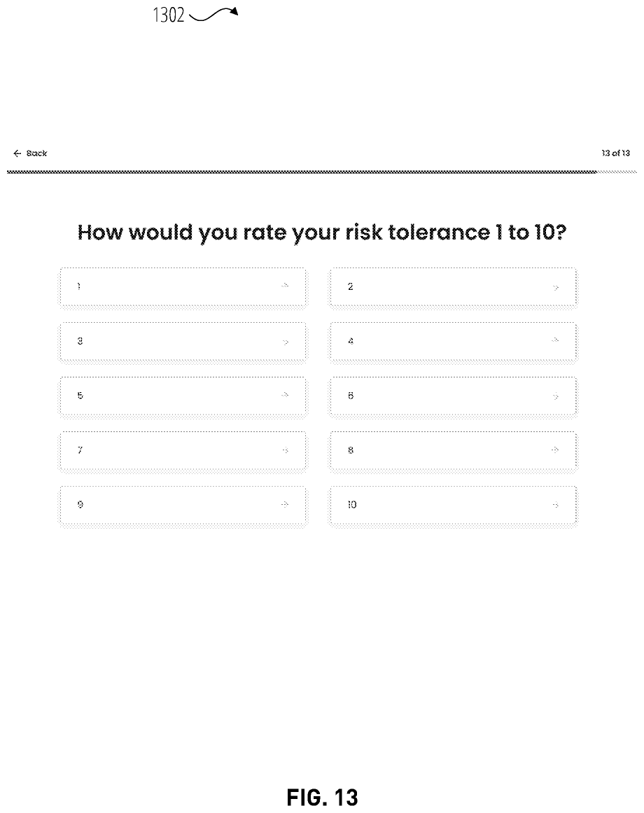

FIG. 2 through FIG. 13 comprise an interactive questionnaire interface for gathering user investment preferences and risk parameters. The questionnaire begins with investment goal selection (FIG. 2) and progresses through knowledge assessment (FIG. 3), current asset holdings (FIG. 4), time horizon (FIG. 5), portfolio objectives (FIG. 6), and risk tolerance scenarios (FIG. 7-11). The interface concludes with cryptocurrency exposure preferences (FIG. 12) and a 1-10 risk rating selection (FIG. 13).

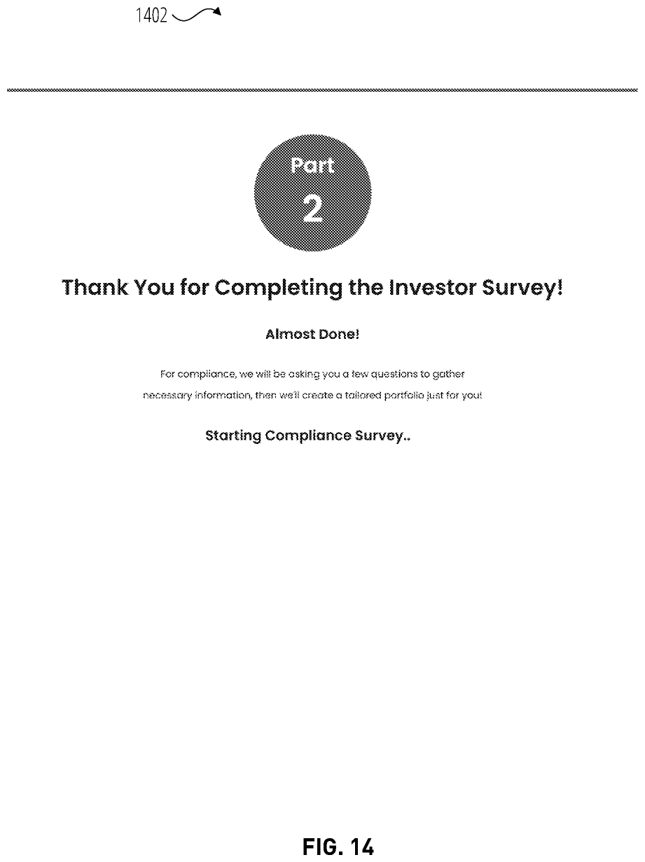

FIG. 14 marks the transition to compliance data collection. The interface displays a confirmation screen before proceeding to gather required regulatory information.

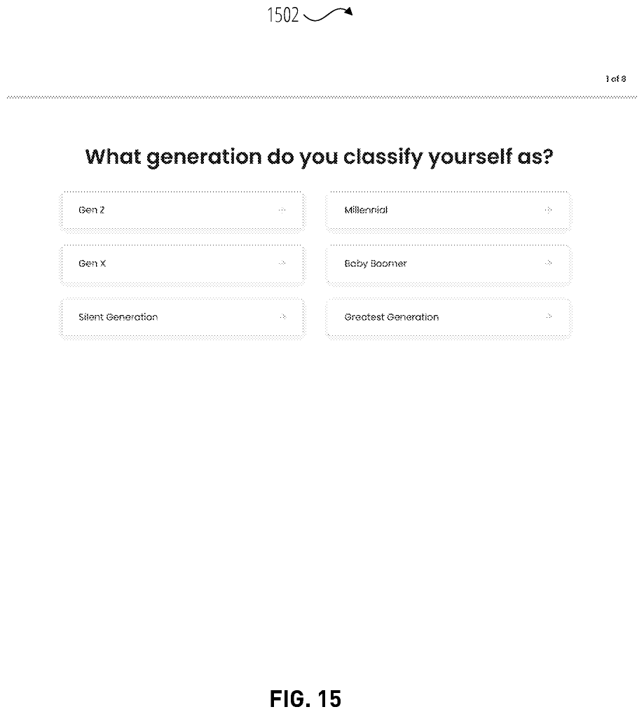

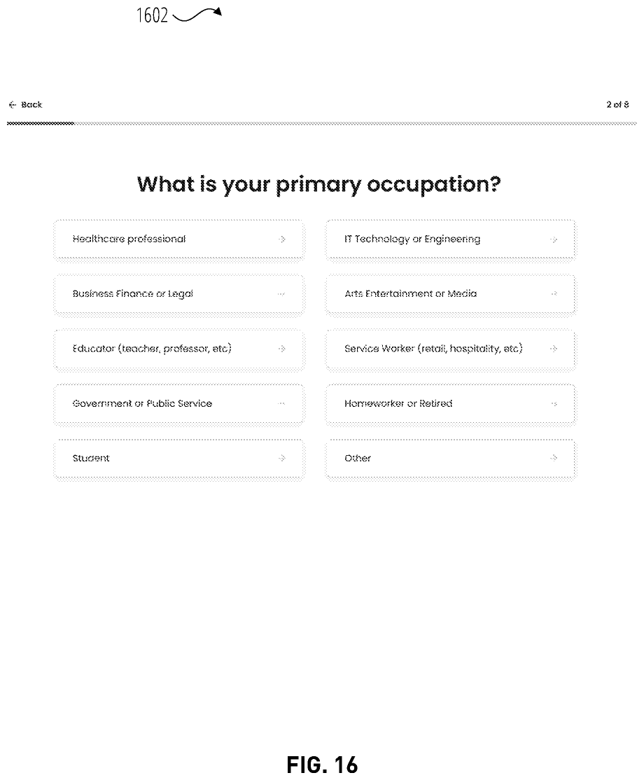

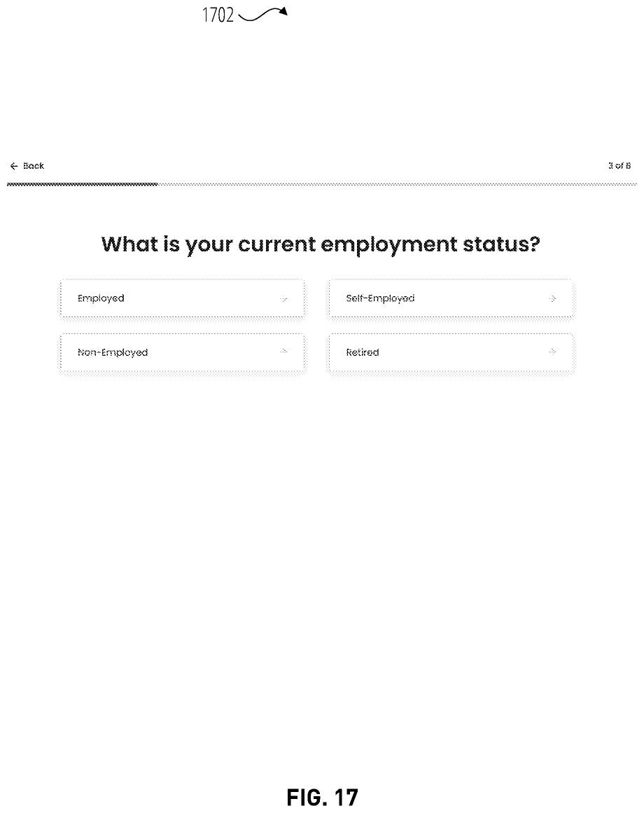

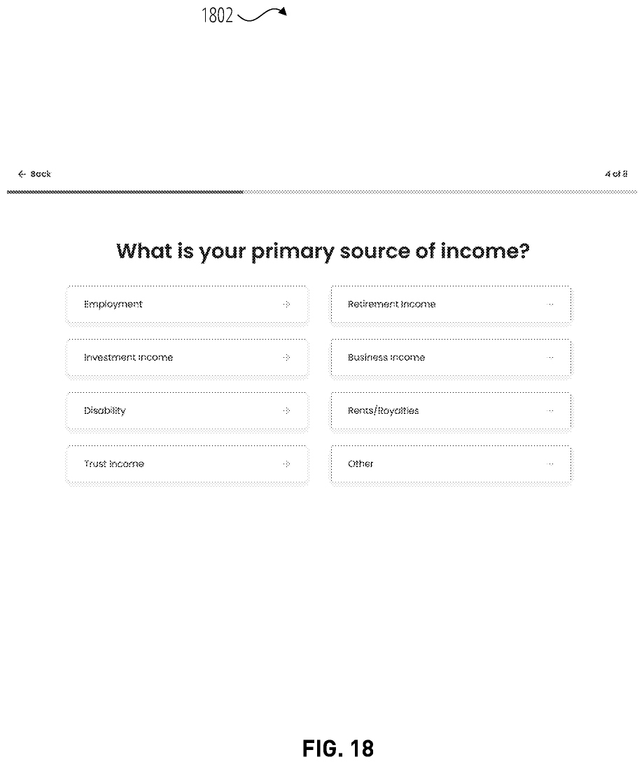

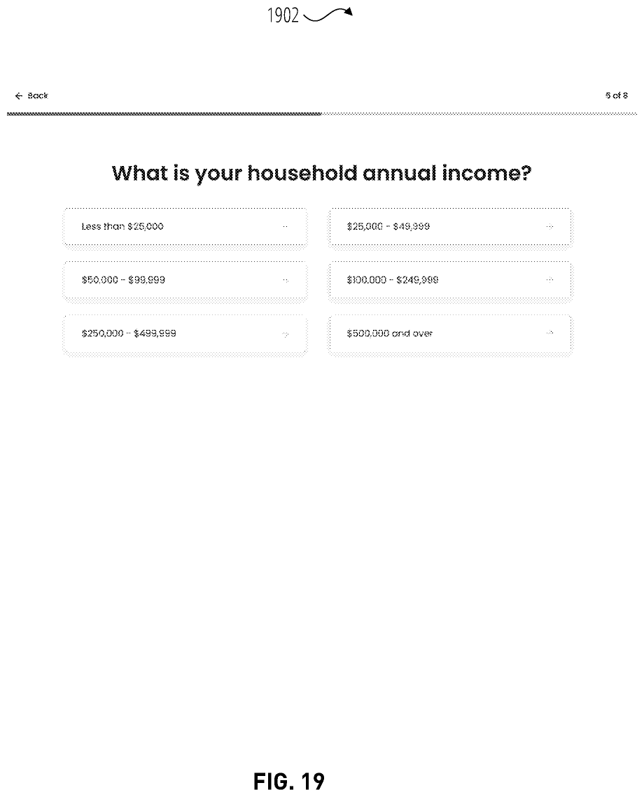

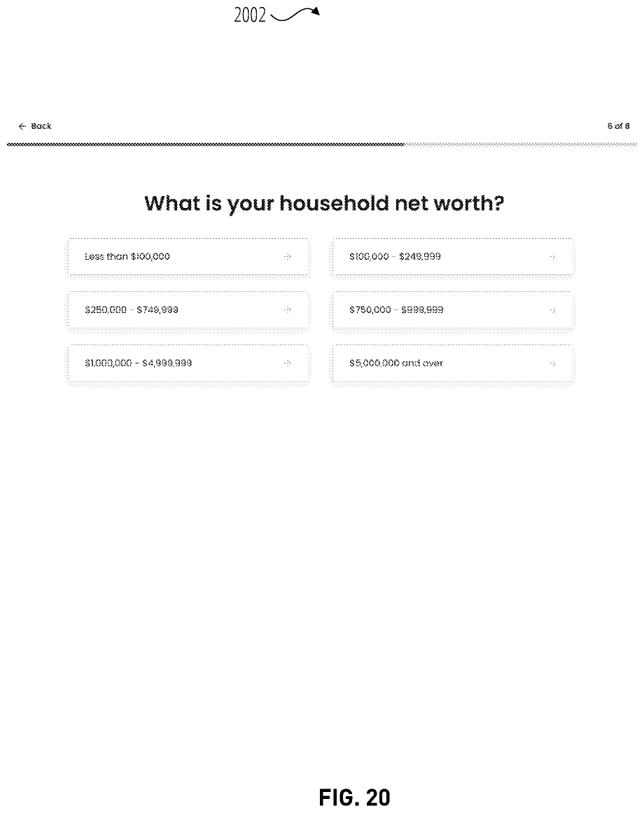

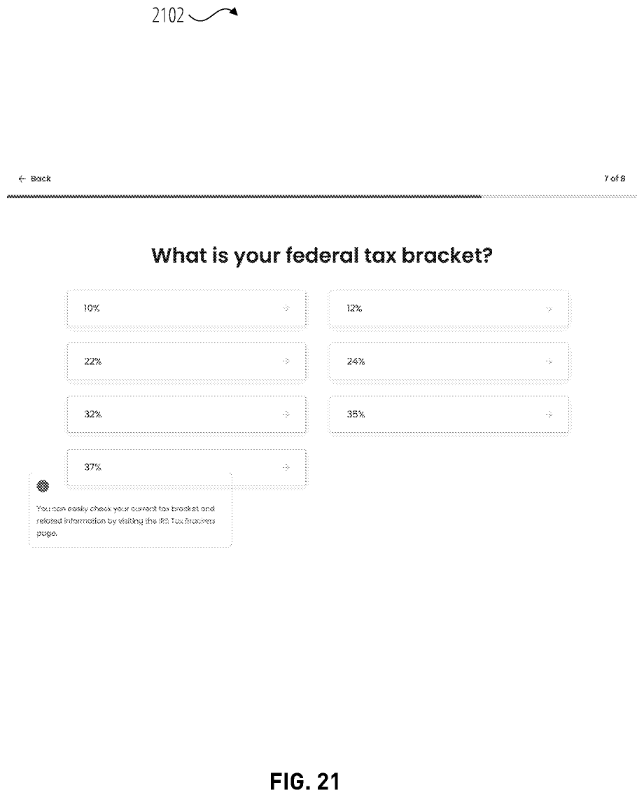

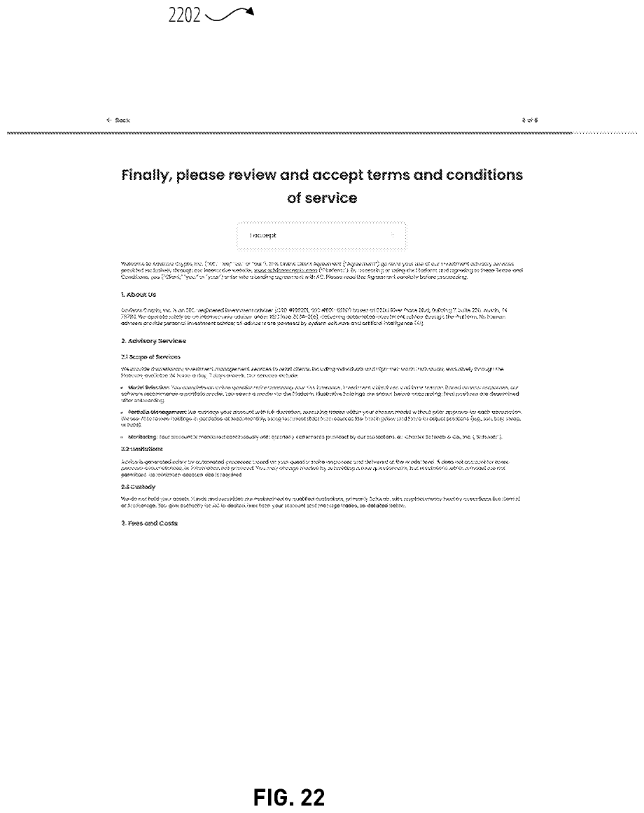

FIG. 15 through FIG. 22 comprise the compliance questionnaire interface, collecting demographic data (FIG. 15), occupation details (FIG. 16), employment status (FIG. 17), income sources (FIG. 18), household income ranges (FIG. 19), net worth ranges (FIG. 20), tax bracket information (FIG. 21), and terms acceptance (FIG. 22).

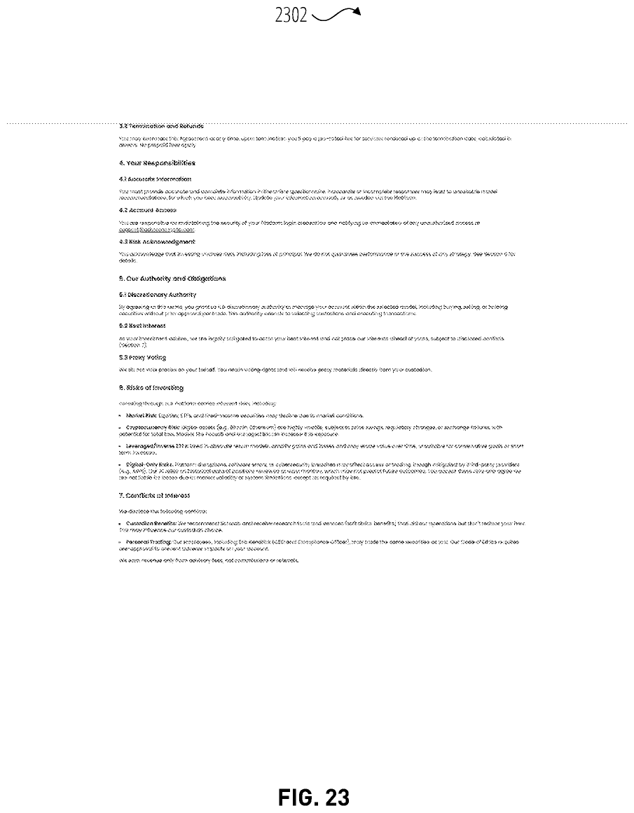

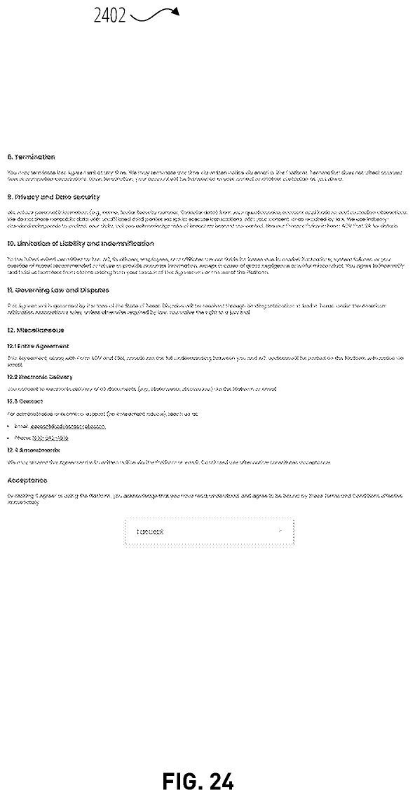

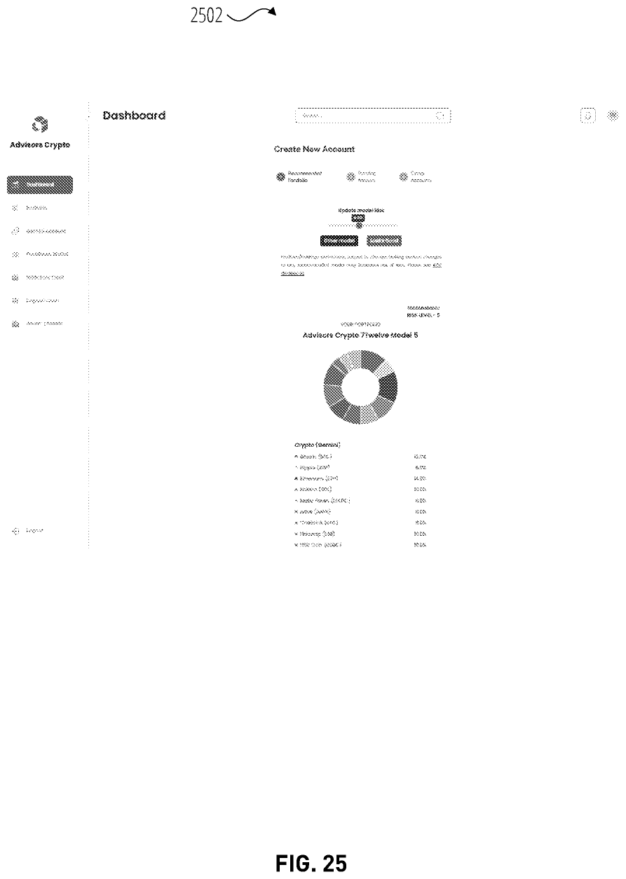

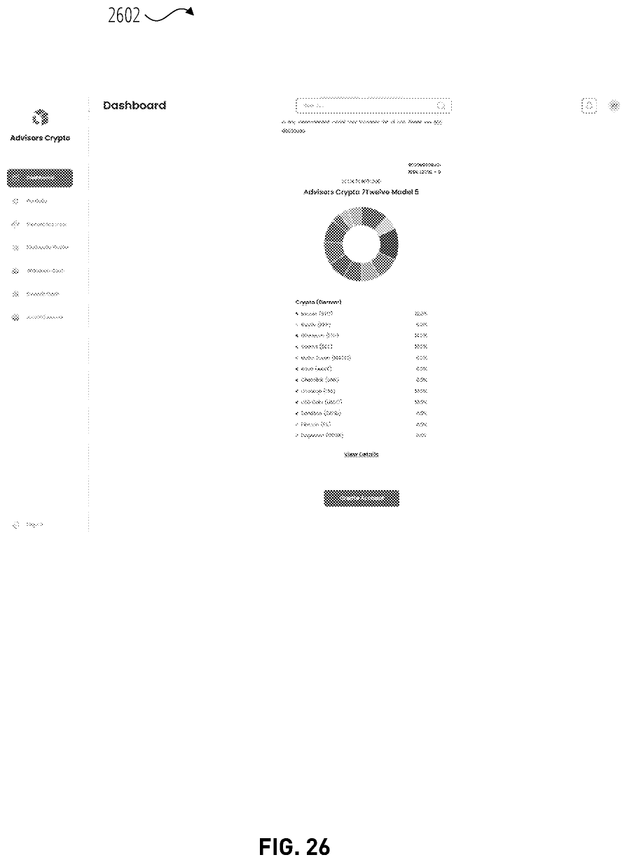

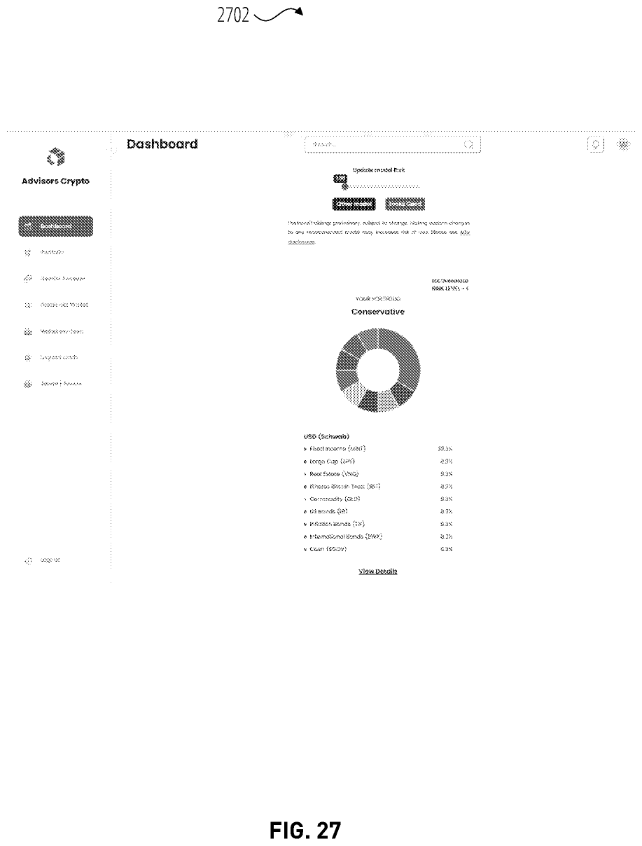

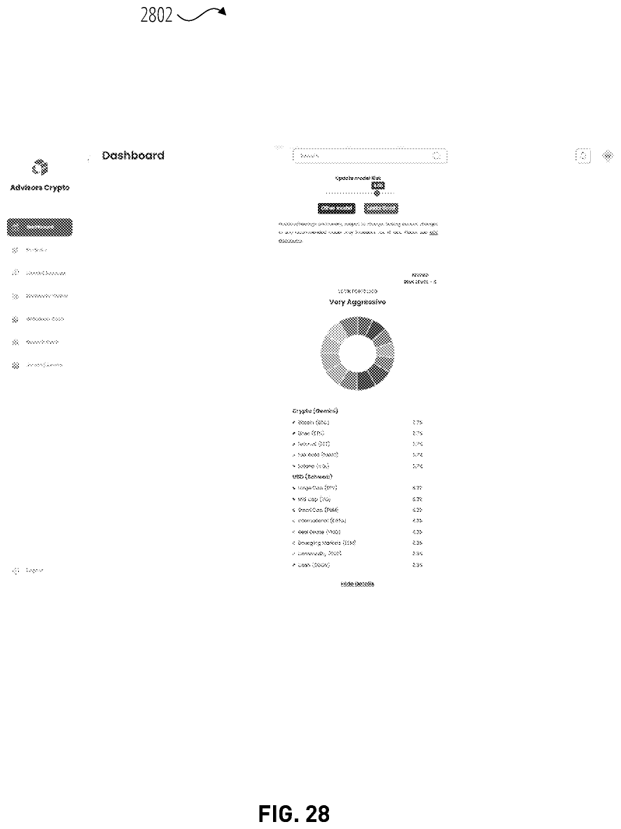

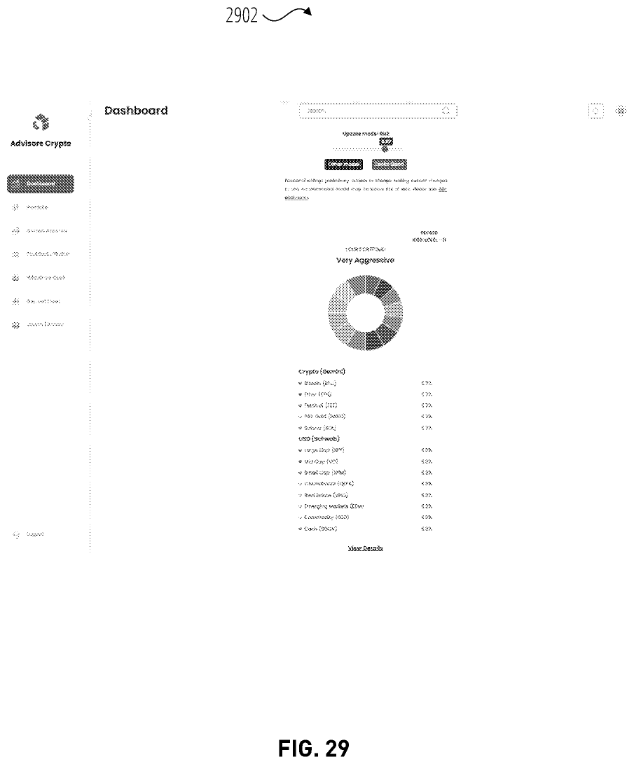

FIG. 23 through FIG. 29 show the portfolio management dashboard interface. The dashboard displays current holdings, risk levels, and allocation percentages across different custodians including Gemini for cryptocurrency assets and traditional custodians for other investments. The interface includes controls for updating risk levels and viewing detailed portfolio breakdowns.

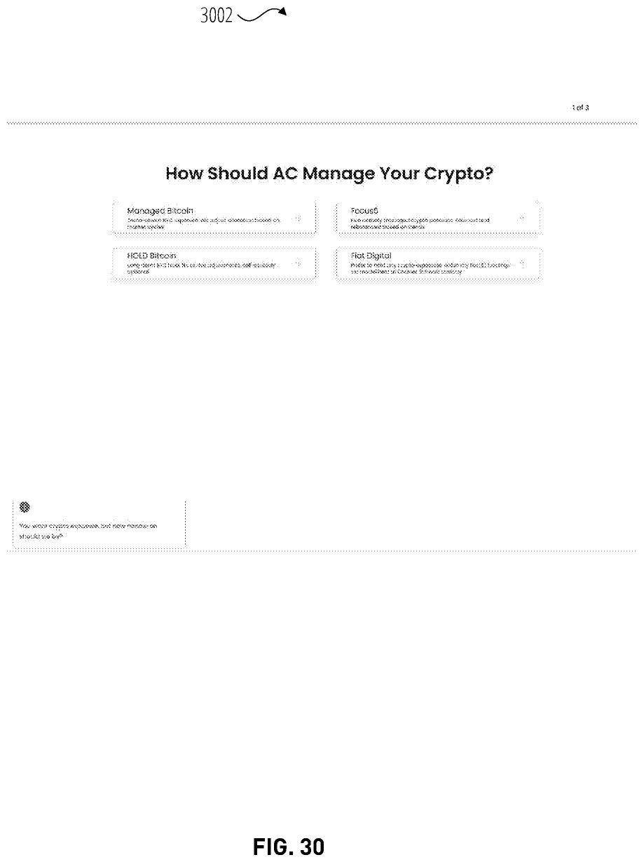

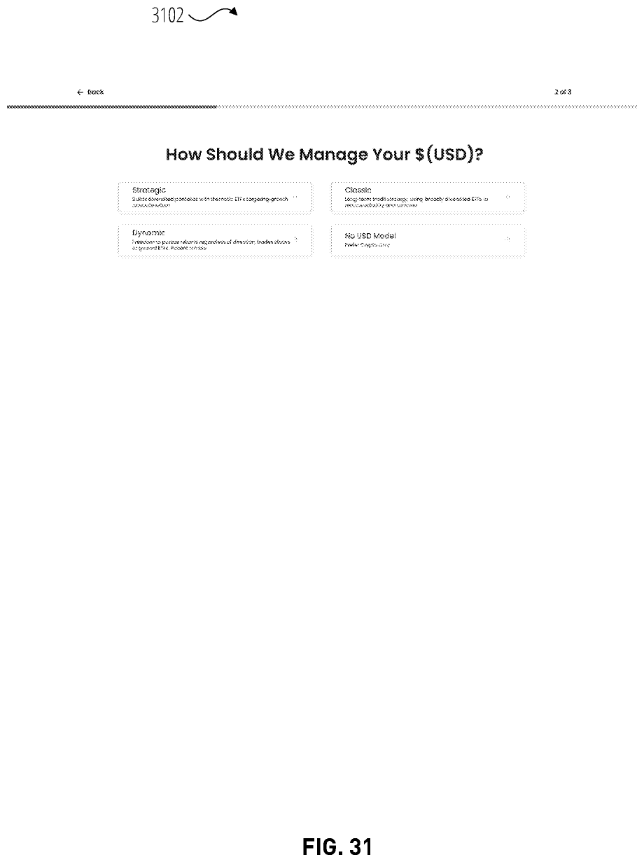

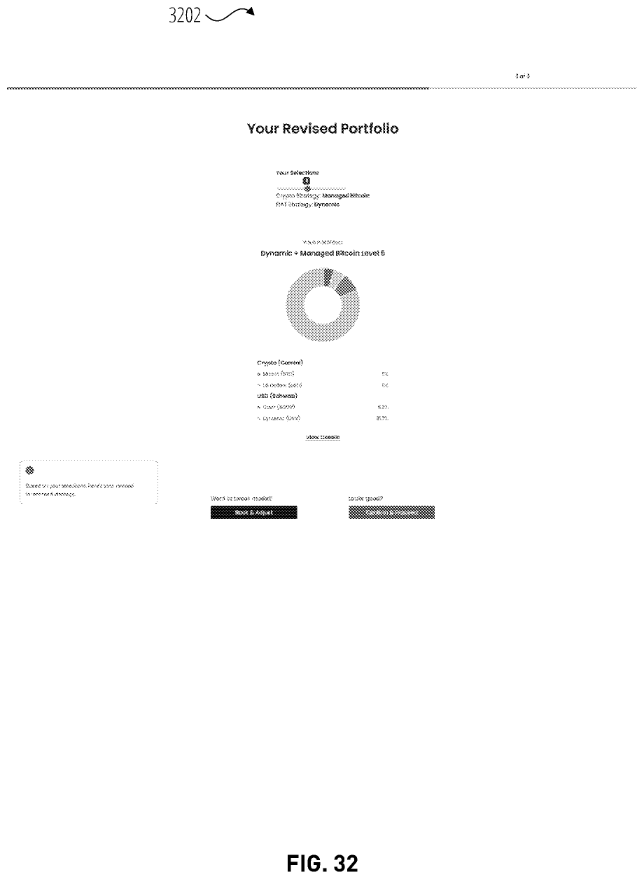

FIG. 30 through FIG. 32 present the cryptocurrency strategy selection interface. Users may choose between different management approaches including Managed Bitcoin, Focus5, HOLD Bitcoin, and Fiat Digital options. The interface displays corresponding portfolio allocations based on the selected strategy.

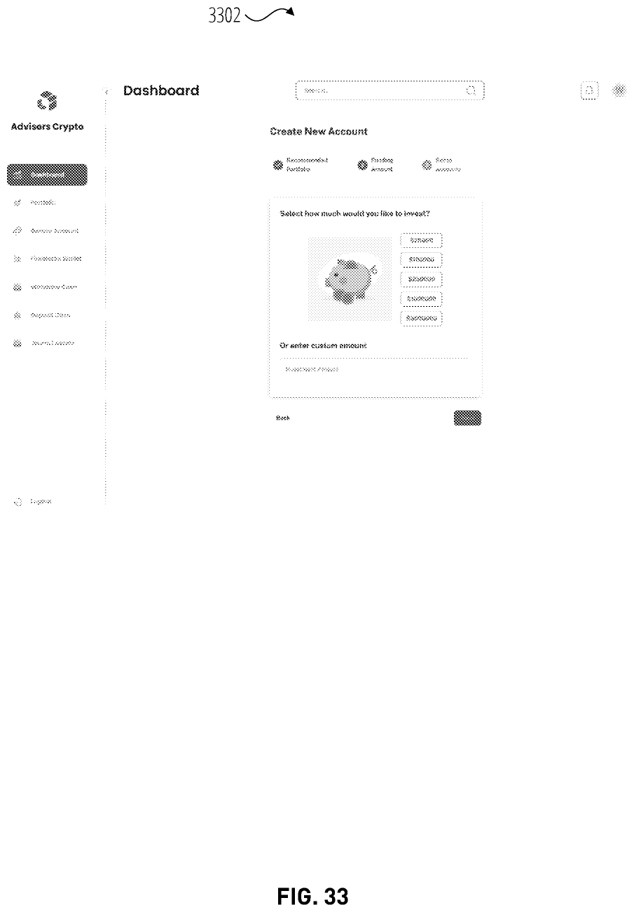

FIG. 33 shows the investment amount selection interface, allowing users to choose from preset funding amounts or enter a custom amount. The interface integrates with both cryptocurrency and traditional asset custody systems.

The figures collectively illustrate an automated portfolio management system that processes user inputs through questionnaires to generate risk-appropriate asset allocations across both digital and traditional investments. The system may adjust allocations dynamically based on user risk preferences indicated through the risk dial interface, with artificial intelligence analyzing weekly charts to determine position changes.

### System Level Description

The system includes multiple interconnected components:

### User Interface Layer (UI Layer)

Risk dial interface enabling dynamic portfolio risk adjustment on 1-10 scale
Questionnaire interface for collecting user preferences and compliance data
Portfolio dashboard displaying real-time holdings and allocations across custodians
Strategy selection interface for choosing cryptocurrency management approaches

### Portfolio Management Engine

AI-driven analysis system processing weekly holdings charts
Technical analysis module generating buy/sell/hold signals
Dynamic rebalancing engine adjusting allocations based on risk dial inputs
Model management system maintaining different risk-based portfolio templates

### Custody Integration Layer

Multi-party computation (MPC) wallet system for cryptocurrency custody
Integration with qualified custodians (e.g., Gemini) for digital asset holdings
Traditional custodian connections (e.g., Schwab) for non-crypto assets
Secure key management system distributing private key shares

### Data Processing Layer

Market data ingestion system for technical analysis
Risk scoring algorithm processing questionnaire responses
Portfolio optimization engine calculating target allocations
Compliance monitoring system tracking regulatory requirements

The UI Layer interfaces with the Portfolio Management Engine through API calls transmitting risk preferences and receiving allocation updates. The Portfolio Management Engine connects to the Custody Integration Layer to execute trades and monitor positions. The Data Processing Layer feeds market information and analysis to the Portfolio Management Engine while receiving position data from the Custody Integration Layer.

In some examples, the system may implement affiliate tracking capabilities through an additional marketing module integrated with the UI Layer. The system may also incorporate alternative custody solutions beyond MPC wallets, including hardware wallet integration or traditional custodial arrangements.

The components communicate through encrypted channels with authentication controls ensuring secure data transmission. The system architecture enables automated portfolio management while maintaining separation between trading logic and custody infrastructure.

### Flowchart Example

A flowchart illustrating a method of automated cryptocurrency portfolio management with risk-adjusted allocation, according to some examples can be created using a sequential block 1->block 2, . . . , block n. In the example described the first block begins at 301.

Although the example method depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At block 301, the user interface layer presents an initial questionnaire to collect investment preferences and risk parameters. The questionnaire interface gathers data including investment goals, knowledge level, current holdings, time horizon, and portfolio objectives.

At block 302, the data processing layer analyzes questionnaire responses to generate a risk tolerance score on a 1-10 scale. The risk scoring algorithm evaluates responses to market decline scenarios and risk/return trade-off questions.

At block 303, the portfolio management engine determines initial asset allocation targets based on the calculated risk score. The engine maps risk levels to model portfolios with specific cryptocurrency and traditional asset weightings.

At block 304, the custody integration layer establishes required accounts and wallet structures. For cryptocurrency assets, the system initializes multi-party computation wallets with distributed key shares. For traditional assets, the system connects to qualified custodian accounts.

At block 305, the portfolio management engine executes initial position trades to implement target allocations. The engine routes cryptocurrency orders to integrated exchanges and traditional asset orders to custodial trading venues.

At block 306, the AI analysis system begins weekly monitoring of portfolio holdings. The system processes technical indicators and chart patterns to generate buy, sell, or hold signals for each position.

Decision block 307 evaluates if the user has adjusted the risk dial setting. If yes, the process moves to block 308. If no, the process continues to block 309.

At block 308, the portfolio management engine calculates new target allocations based on the updated risk level. The rebalancing engine determines required trades to achieve the new targets.

At block 309, the AI system evaluates if position changes are needed based on technical analysis. If changes are recommended, the process moves to block 310. If no changes needed, the process returns to block 306.

At block 310, the portfolio management engine executes rebalancing trades across cryptocurrency and traditional asset positions. The engine coordinates with the custody integration layer to process transactions through appropriate venues.

The process continues to cycle through monitoring, risk adjustments, and rebalancing operations. In some examples, additional blocks may handle affiliate tracking, compliance monitoring, or alternative custody arrangements.

### Problems and Solutions

Described technology examples of automated cryptocurrency portfolio management seek to provide technical solutions to a number of example technical problems, including the following:

### 1. Problem: Secure Custody of Digital Assets

Technical challenge of protecting cryptocurrency private keys while enabling automated trading and portfolio management without single points of failure

Solution: Multi-party computation (MPC) wallet system distributes key shares across multiple parties while maintaining trading capabilities
Implements distributed key management protocols to split private keys across nodes
Enables automated trading through secure MPC protocols without consolidating key control
Integrates with qualified custodians like Gemini for additional security layers
Provides programmatic recovery and guardian designation options

### 2. Problem: Dynamic Risk-Based Portfolio Rebalancing

Technical challenge of automatically adjusting cryptocurrency and traditional asset allocations based on user risk preferences and market conditions

Solution: AI-driven portfolio management engine with risk dial interface
Processes weekly technical analysis of holdings charts to generate trading signals
Maps risk dial inputs (1-10) to specific portfolio model allocations
Automatically calculates and executes rebalancing trades across multiple custody locations
Implements replacement asset analysis when positions need rotation

### 3. Problem: Real-Time Portfolio Monitoring Across Asset Types

Technical challenge of maintaining current portfolio state across cryptocurrency and traditional investments with different custody arrangements

Solution: Unified monitoring system with multi-custodian integration
Tracks positions across crypto systems (e.g., Gemini), Fireblocks (MPC wallets), and traditional custodians
Updates allocation percentages and risk metrics in real-time
Displays consolidated portfolio view through standardized interface
Maintains compliance records of all position changes

### 4. Problem: Automated Trading Signal Generation

Technical challenge of systematically analyzing cryptocurrency and traditional markets to determine optimal position adjustments

Solution: AI analysis system processing technical indicators
Reviews holdings charts on weekly basis using classical technical analysis
Applies certain analysis frameworks, such as Schabacker, Edwards, Magee, and the like, analysis frameworks
Generates buy/sell/hold signals based on predefined parameters
Coordinates with portfolio management engine to execute trades

### 5. Problem: Regulatory Compliant Automation

Technical challenge of delivering automated investment advice while maintaining SEC rule compliance

Solution: Interactive platform architecture with embedded compliance
Operates under SEC Rule 203A-2(e) for internet-only advisers
Delivers advice through interactive questionnaires and interfaces
Maintains automated records of risk adjustments and trades
Implements affiliate tracking with compliance controls

### 6. Problem: Scalable User Onboarding

Technical challenge of efficiently gathering user preferences and configuring portfolios

Solution: Multi-step questionnaire system with automated processing
Presents sequence of risk assessment and preference questions
Processes responses through risk scoring algorithm
Automatically maps users to appropriate portfolio models
Initiates required account setup and custody arrangements

### Use Cases

### 1. New Investor Onboarding Use Case

User selects New Investor option from initial interface
System presents investment goal questionnaire gathering preferences
Risk assessment process evaluates tolerance through market decline scenarios
Portfolio management engine maps 1-10 risk score to model allocation
MPC wallet setup initiated for cryptocurrency holdings
Traditional custodian accounts established for other assets
Initial trades executed to implement target allocations
Weekly AI monitoring begins analyzing position charts

### 2. Risk Level Adjustment Use Case

User accesses portfolio dashboard displaying current allocations
Adjusts risk dial setting between 1-10 on interface
System calculates new target allocations based on risk level
Portfolio rebalancing engine determines required trades
Executes transactions across crypto and traditional positions
Updates dashboard to reflect new allocation percentages
Maintains compliance records of risk adjustment

### 3. Cryptocurrency Strategy Selection Use Case

User chooses between management approaches (Managed Bitcoin, Focus5, etc.)
System configures portfolio based on selected strategy
For Managed Bitcoin: AI analyzes market cycles to adjust exposure
For Focus5: Maintains five actively managed crypto positions
MPC wallet infrastructure secures cryptocurrency holdings
Weekly technical analysis guides position adjustments
Dashboard updates reflect strategy implementation

### 4. Affiliate Marketing Distribution Use Case

System tracks referral relationships for new user onboarding
Processes affiliate compensation within regulatory framework
Maintains compliance records of marketing activities
Enables scalable user acquisition through referral network
Dashboard provides affiliate performance metrics

### 5. Portfolio Rebalancing Use Case

AI system reviews holdings charts weekly
Applies technical analysis to generate trading signals
Evaluates potential replacement assets when needed
Coordinates with custody systems to execute trades
Updates position allocations across custodians
Maintains alignment with risk level targets

### 6. Multi-Custodian Integration Use Case

System connects with Gemini for cryptocurrency custody
Implements MPC wallet infrastructure through Fireblocks
Integrates traditional custodian (e.g., Schwab) for other assets
Provides unified portfolio view across custody locations
Enables seamless trading across different venues
Maintains security through distributed key management

### 7. Regulatory Compliance Monitoring Use Case

System operates under SEC internet adviser rules
Records all portfolio adjustments and trades
Maintains documentation of risk assessment process
Tracks affiliate marketing activities
Generates required regulatory reports
Ensures non-personalized advice delivery

### 8. Technical Analysis Implementation Use Case

AI processes weekly holdings charts
Applies Edwards McGee analysis framework
Generates buy/sell/hold recommendations
Coordinates with portfolio management engine
Executes trades based on analysis signals
° Updates positions while maintaining risk targets

### Example Embodiments for Claiming Purposes

Example 1 is an automated cryptocurrency portfolio management system comprising a user interface presenting an interactive questionnaire to collect investment preferences and risk parameters, a portfolio management engine mapping user responses to risk-based model allocations, an artificial intelligence system processing technical analysis of holdings to generate trading signals, and a multi-party computation wallet system enabling automated trading while distributing cryptocurrency private keys across nodes.

In Example 2, the subject matter of Example 1 wherein the user interface includes a risk dial enabling dynamic adjustment of portfolio risk levels on a scale of 1-10, with the portfolio management engine automatically calculating and implementing new target allocations based on risk dial inputs.

In Example 3, the subject matter of any one or more of Examples 1-2 wherein the artificial intelligence system reviews holdings charts on a weekly basis to generate buy, sell, or hold signals using classical technical analysis frameworks including Edwards McGee analysis.

In Example 4, the subject matter of any one or more of Examples 1-3 wherein the portfolio management engine integrates with multiple qualified custodians including cryptocurrency exchanges and traditional asset custodians to provide unified portfolio monitoring and automated trading execution.

In Example 5, the subject matter of any one or more of Examples 1-4 wherein the system operates as an internet-only investment adviser under SEC Rule 203A-2(e) delivering automated advice through the interactive platform without personalized recommendations.

In Example 6, the subject matter of any one or more of Examples 1-5 wherein the questionnaire interface presents a sequence of screens gathering investment goals, knowledge level, current holdings, time horizon, portfolio objectives, market decline scenarios, and cryptocurrency exposure preferences.

In Example 7, the subject matter of any one or more of Examples 1-6 wherein the portfolio management engine maintains multiple model portfolios with different risk levels and asset allocations, including conservative models weighted toward fixed income and traditional ETFs and aggressive models with higher cryptocurrency exposure.

In Example 8, the subject matter of any one or more of Examples 1-7 wherein the system includes cryptocurrency management strategy options comprising Managed Bitcoin adjusting exposure based on market cycles, Focus5 maintaining five actively managed positions, and traditional ETF-based crypto exposure.

In Example 9, the subject matter of any one or more of Examples 1-8 wherein the multi-party computation wallet system enables programmatic recovery and guardian designation while maintaining automated trading capabilities.

In Example 10, the subject matter of any one or more of Examples 1-9 wherein the system implements affiliate marketing tracking capabilities within regulatory compliance frameworks.

### Whitepaper Section

### Title—Sovereign Wealth for the Digital Century

### Introduction: The End of Trust, the Birth of Sovereignty

Financial history advances through rupture, not reform.

For decades, the wealth management industry has lived off the illusion of permanence. Custodians were sacred. Institutions were immutable. Advisors held the final word. Clients were fed narratives of fiduciary virtue while assets quietly floated through pipelines optimized not for protection, but for profit extraction. The entire edifice functioned on a shared hallucination of trust. Trust in markets. Trust in brands. Trust in regulations. Trust in custodians. Most of all, trust in gatekeepers.

That world has collapsed.

The failure wasn't sudden. It arrived incrementally, then all at once. We watched depositors get locked out of regional banks in California, then saw Credit Suisse—a Swiss institution older than most nation-states—dismantled overnight. We saw crypto exchanges implode under the weight of their own lies. We saw custodians misuse client funds, platforms “pause withdrawals,” and regulators punish transparency while turning a blind eye to systemic fraud. One by one, the pillars fell. Some slowly eroded. Some vaporized. None of them stood.

Trust, as a foundational operating layer for financial coordination, is gone. The idea that an investor should hand over their life savings to an institution in exchange for PDFs and branding collateral is no longer tenable. The act of trusting has itself become a risk-no longer a virtue. The ground is shifting beneath the feet of investors, and the institutions they once depended on are no longer bridges to the future. They are sandbags delaying the inevitable flood.

This isn't a bear market. It's a regime change.

The financial system, as we knew it, was constructed for a different era. It was built during a time when scarcity was physical, access was local, and information traveled slowly. In that system, you needed a gatekeeper. You needed someone to hold your hand and your money. You needed to ask permission. You needed to wait. But that architecture is incompatible with the modern investor. It doesn't work for the entrepreneur in Lagos holding stablecoins. It doesn't serve the millennial in Austin who wants to own Bitcoin in a trust. It fails the retiree in Tokyo who no longer believes in central bank magic.

We are entering the sovereign era.

It is no longer just possible—but increasingly imperative—that individuals control their wealth directly. Not through abstraction. Not through branding. But literally. Direct ownership. Real custody. Programmable freedom. This isn't ideology—it's survival.

The next system isn't built on legacy trust. It's built on cryptographic truth.

And yet, self-custody by itself is not enough. The problem with the old world was never just where assets were held—it was how they were managed, how they were aligned (or misaligned) with goals, how they were captured by middlemen, and how opaque the entire process remained. Self-custody is the door, not the destination. The sovereign era demands more than wallets. It demands infrastructure.

This paper introduces Advisors Crypto: the first sovereign wealth operating system designed to replace—not reform—the traditional RIA model.

This is not a new interface on an old system. It is a rejection of the system itself.

Advisors Crypto fuses direct self-custody with dynamic model-based investment strategy, automated planning, real-time compliance, and total user transparency. It eliminates the need for custodial middlemen while preserving the framework clients need to pursue meaningful financial goals. It restores the possibility of advice—but removes the power to capture. It enables investors to delegate strategy without surrendering ownership. It replaces permissioned trust with programmable assurance.

This is what the future demands. Not incremental upgrades. Not slightly better quarterly reports. Not slicker fintech wrappers on legacy pipes. The sovereign era demands a total inversion of the trust stack.

Where once the advisor controlled the interface and the custodian controlled the keys, Advisors Crypto gives the user both. Where once compliance was a shield for asset lockup, Advisors Crypto uses it as a mechanism of clarity. Where once advisors sold what the custodian offered, Advisors Crypto only recommends what aligns with the user's stated sovereign goals.

This is not about Bitcoin maximalism. It is about permission minimalism.

A sovereign financial future is one in which the user can change their risk exposure, adjust their time horizon, swap out assets, and update their plan—all without needing a meeting, a form, or an apology. It is a system that works while the user sleeps. That reacts as the world changes. That remains operational when the banks close and the custodians vanish. That protects wealth not only through market volatility, but through institutional decay.

And make no mistake—decay is now the base case.

It is no longer radical to say that the banking system is unstable, that the advisory world is captured, that compliance is weaponized, or that fiat currencies are degrading faster than most portfolios can compound. What was once conspiracy is now consensus. What was once hidden is now headlines. There is no longer room for polite optimism. There is only the choice to act.

This is why Advisors Crypto exists.

This paper lays out the case for its existence in full detail: the collapse of trust, the limitations of today's RIA frameworks, the inadequacy of current self-custody solutions, and the need for a new infrastructure entirely. It explores the technological architecture, the regulatory posture, the product roadmap, and the macroeconomic forces that make its emergence not just logical—but inevitable.

It does not beg the reader to believe. It assumes that those with eyes already see what is coming.

This is not a pitch. It is a reckoning.

The old model is ending. The sovereign era is here.

Let's build the infrastructure that will carry it forward.

### Section 1: The Collapse of Legacy Finance and the RIA Model

Every system decays before it collapses.

In wealth management, decay arrived quietly. It took the form of overbuilt compliance departments. Of custodians prioritizing legal insulation over client outcomes. Of advisors spending more time on branding than on strategy. It was visible in the quarterly calls that said nothing. In the performance reports that hid risk beneath percentiles. In the client statements so polished and opaque they concealed more than they revealed.

Collapse came later. And quickly.

In 2022, investors watched FTX—a multibillion-dollar exchange backed by the most sophisticated venture capital firms—implode into nothing. In 2023, depositors learned that even U.S. regional banks, long considered safe, could disappear in a weekend. Credit Suisse was vaporized in days. Prime Trust went insolvent. Coinbase lost banking partners. The illusion of systemic integrity could no longer be sustained.

Yet traditional financial advisors kept operating as if nothing had changed.

Advisory firms continued to offer the same managed portfolios, the same model allocations, the same templated risk surveys. They told clients to “stay the course” even as the course itself—the underlying terrain of modern finance—had fundamentally shifted.

This dissonance is not incompetence. It is structural. Traditional RIAs are not equipped to evolve. They are functionally trapped by the very system they were built to serve.

Consider the typical RIA business model: fees are charged as a percentage of assets under management (AUM), typically held in custodial accounts with third-party firms like Schwab, Fidelity, or Pershing. These custodians provide infrastructure, yes—but also gatekeep access, limit asset types, impose restrictions, and derive economic benefit from holding client assets in ways that are rarely disclosed.

The advisor, meanwhile, is stuck in a bind. Legally bound to act in the client's best interest, yet operationally constrained by the tools, custody relationships, and compliance overhead built around systems that serve someone else.

The result is a model optimized for inertia.

Advisors cannot easily recommend Bitcoin or other digital assets, even if the client requests it, because most custodians don't support them—or do so in ways that strip away real ownership. Advisors cannot help clients self-custody their assets, even if that custody is safer, because billing models rely on AUM held in traditional structures. Advisors cannot integrate dynamic strategies responsive to real-time macro events, because legacy platforms aren't built for speed, for change, or for client sovereignty.

They are built for retention.

The RIA model has become a vessel of arrested potential.

It retains the vocabulary of trust and fiduciary duty. But in practice, it has become a distribution network for pre-approved products held in pre-approved custodians, conforming to risk parameters set decades ago, maintained not for performance but for legal insulation.

It is a system that confuses disclosure with alignment, and permission with protection.

And clients are beginning to sense it.

They may not have language for the decay. But they feel the drag. They feel the slowness. The friction. The uncertainty. They feel the difference between the speed at which they live their financial lives and the speed at which their advisors can respond. They are asked to log in to ten portals, sign four PDFs, wait three weeks for a transfer, and then listen to a phone call that explains none of it.

In a world where money moves at the speed of code, this model cannot survive.

Clients now live in a permissionless world. They are used to real-time communication, instant execution, and decentralized control. They own crypto directly. They swap assets onchain. They monitor markets on mobile dashboards. They question the value of a 1% AUM fee for asset mixes they can replicate in an afternoon.

The advisor still holds value—but not as a gatekeeper. Only as a guide.

To retain relevance, the advisor must shed their legacy constraints. They must operate in a system that allows them to serve the client in full sovereignty—without requiring surrender of custody, control, or clarity.

That system does not exist inside traditional RIAs.

It cannot.

It would require custodians to surrender economic rents. It would require compliance teams to embrace programmable transparency. It would require fee models to evolve beyond AUM lock-in. It would require advisors to operate as sovereign wealth strategists, not product intermediaries.

Most will not make the leap.

They are too embedded, too comfortable, or too slow.

That is why the next financial advisory system cannot be an adaptation. It must be a replacement.

The future of financial advice will not be defined by who offers better ESG funds, or slicker onboarding flows. It will be defined by who controls the keys.

Sovereignty is not an add-on. It is the premise.

And the traditional advisory system was never designed for it.

The institutions are still standing—but only just. Their balance sheets remain, but their legitimacy has evaporated. Their marketing is sharp, but their margins are under siege. Their infrastructure is aging, brittle, and incapable of absorbing the demands of sovereign wealth.

Meanwhile, a generation of investors is rising that will not ask permission.

They will not wait.

They will not go backward.

They are not looking for a slightly better version of the old world. They are looking for the operating system of the new one.

And they will find it—or build it themselves.

### Section 2: The Architecture of Sovereign Wealth

The word “sovereignty” has become a slogan in some circles-used to signal ideology or identity. But before it was branding, it was a principle. And before that, a design constraint.

Sovereignty, in its truest form, means not asking permission. It means not needing to trust a third party to do what only you can be accountable for. It means possessing both the right and the means to exercise agency over your assets, your time, your outcomes. In the realm of personal finance, sovereignty is not just about holding a private key. It's about controlling the full lifecycle of wealth-its custody, its growth, its use, and its transfer-without dependence on external permission or opaque intermediaries.

To build for sovereignty is to build infrastructure that cannot betray.

Most wealth management systems today are fundamentally unfit for this task. They were designed for a world in which power flowed through institutions, not protocols. In which trust was mediated through regulation, not cryptography. In which custody was a black box, and clients were trained not to ask questions they didn't want the answers to.

To architect a sovereign wealth system, we must reverse the design logic entirely.

It begins with the axiom that the user—not the advisor, not the platform, not the custodian—must possess final control. Not just legal ownership. Functional control. They must be able to move, modify, transfer, or exit their financial strategies without waiting for signatures, approvals, or settlement cycles. That is not an aspiration. It is the base requirement.

This shifts the architecture from centralized permission to decentralized coordination.

Let's start with custody. In traditional systems, custody is always delegated. Even when ownership is legally retained, control is not. Assets held at Schwab, Fidelity, or Pershing are not under client control. They are held in omnibus accounts, subject to platform-level controls, operational risk, and often cross-collateralization. Even “segregated” accounts are only as safe as the integrity and solvency of the custodian.

In contrast, sovereign custody starts with user-held wallets. Multi-party computation (MPC) makes this viable at scale. Rather than forcing users to memorize seed phrases or guard hardware wallets like ancient treasure maps, MPC custody distributes key shares across a network—recoverable, secure, and resilient to loss or compromise. The user maintains ultimate control, but the system protects against user error.

Sovereign custody also enables programmable permissioning: users can set spending limits, designate trusted guardians for recovery, or embed time-locked transfers—all without involving a platform or a person. This is not just safer. It is saner. It treats the user like an adult in full control of their wealth, not a child who needs approval to spend their own money.

But custody alone does not produce sovereign wealth. It merely protects it.

The next layer is strategy.

Historically, strategy was the domain of the advisor. The client described goals. The advisor built portfolios. Rebalanced quarterly. Reassessed annually. This worked when markets were slow, inflation was steady, and asset classes moved in predictable correlation bands.

That world is gone.

Today's markets are nonlinear, macro-driven, and structurally unstable. Bitcoin trades 24/7. Treasuries fluctuate on Fed rumors. Currencies devalue overnight. An advisor who reviews your plan once a year is no longer a steward-they are a spectator.

Sovereign wealth systems must automate strategy without surrendering intelligence. They must ingest macro data, monitor risk metrics, and adjust exposure dynamically-all while preserving client intent. This is not passive investing. It is adaptive alignment.

At Advisors Crypto, we envision a portfolio architecture that begins with outcomes, not tickers.

Clients define goals—early retirement, family legacy, inflation protection—and the system maps those goals to dynamic models. These models are not static allocations but responsive engines. A Bitcoin core strategy might adjust its DCA cadence based on volatility. A digital yield model might shift allocations based on stablecoin depeg risk or regulatory arbitrage. A real-world asset tokenization model might rebalance based on interest rate futures or regional default risk.

The strategy is not a product. It is a programmable policy—living, adjusting, accountable.

And yet strategy, too, must be legible.

This brings us to transparency.

The sovereign user must not only control and configure their wealth. They must understand it. In the legacy system, transparency was a façade: statements full of jargon, quarterly reports with time-weighted returns that obscured real risk, dashboards that showed balance but not exposure.

Sovereign systems must reverse this. A client must be able to see:

What they own.

Where it's held.

What it's earning.

What it's costing.

What could go wrong.

In real time. In plain language. Not buried in PDFs.

This is not just a user experience upgrade. It is an ethical imperative.

Transparency is sovereignty. Without it, control is an illusion.

The fourth layer is compliance. Often treated as an enemy of sovereignty, in truth, compliance is only a constraint if built atop legacy assumptions. Traditional compliance assumes that to manage money for others, one must hold it. One must control it. One must custody it. This assumption has been institutionalized into law—and manipulated to extract rents.

But under SEC Rule 203A-2(e), internet-only advisors can operate without physical offices, without discretionary control, and without custody-so long as advice is delivered through an interactive platform and not personalized.

This is the legal key that unlocks sovereign advice.

Advisors Crypto uses this rule to offer advice on self-custodied assets. We do not hold client funds. We kay not require platform custody. We may not restrict movement. Instead, we provide strategy, structure, and support—while billing transparently for service, not control.

This means the client remains sovereign while the advisor remains aligned.

It also means we can serve clients globally, scalably, and securely-without the overhead, friction, or compromise of legacy RIA structures.

But compliance is not the ceiling. It is the floor.

The sovereign system must go further. It must embed resilience.

If sovereignty is about avoiding single points of failure, then even the advisor cannot be one. Clients must be able to maintain and update strategies even if the advisor disappears. Recovery must be automatic, not reliant on individual intervention. Portfolios must self-heal. Data must self-sync. Interfaces must self-describe.

This demands architecture, not interfaces.

The architecture of sovereign wealth is layered:

Custody: User-controlled, MPC-secured, programmable.

Strategy: Model-based, adaptive, goal-aligned.

Transparency: Real-time, plain-language, risk-aware.

Compliance: Embedded, scalable, SEC-aligned.

Resilience: Recoverable, decentralized, future-proof.

It is not enough to build “crypto apps.” We must build operating systems.

Systems that survive platform failures, legal changes, economic crises. Systems that operate under stress. That do not require reboots when the macro regime shifts. That do not assume tomorrow will look like today.

Systems that treat users as sovereigns—not as clients, not as users, not as eyeballs. As individuals with full agency over their financial existence.

This is not a UX project. It is a civilizational one.

The right to control one's wealth is upstream of almost every other right. The right to save, to invest, to allocate, to donate, to defend, to exit. Without control over capital, every other freedom becomes performative.

This is what Advisors Crypto is building: Not a better portfolio manager. Not a slicker app.

A real system for real sovereignty.

Because the future does not belong to the institution that brands trust best, it belongs to the system that requires trust least.

### Section 3: Distribution in the Sovereign Era

In the old financial world, distribution was conquest.

Build the product, raise capital, and spend relentlessly to acquire users. Buy billboard space. Buy search traffic. Sponsor sports arenas. Lure advisors away from competitors. Pay them basis points to sell your fund. Convince a compliance committee to allow your ETF on a broker-dealer shelf. Run TV ads promising peace of mind. Hope the user doesn't read the fine print.

Distribution was not about product-market fit. It was about product-platform manipulation. About shaping incentives and information flows to push product through pipes designed to preserve power, not performance.

In this model, the end user is rarely the buyer. Often, they are the last to know what they've bought. Advisory firms recommend portfolios they did not design. Clients accept custodians they never chose. Fees are paid invisibly, and decisions made by people whose incentives are hidden behind legal disclaimers and brand polish.

Sovereign systems break this model entirely.

They do not sell through gatekeepers. They do not rent space on institutional shelves. They do not bribe advisors. They do not beg compliance committees. They do not whisper to intermediaries who whisper to clients. They speak directly to the individual.

And they win—or fail—based on clarity, not coercion.

This creates a radically different go-to-market structure. One that favors systems over salespeople. Infrastructure over influence. And alignment over access.

At Advisors Crypto, distribution is not something we tack on. It is something we embed.

The product is the pitch. The experience is the funnel. The architecture is the moat.

We are not selling features. We are unlocking freedom.

That freedom is inherently viral. It spreads not through paid ads, but through direct experience. A user who sees their portfolio live onchain. Who understands their allocation. Who knows they can move, withdraw, adjust, without permission. Who has sovereignty not as a slogan, but as a reality.

That user does not need to be told to share the product. They will do so naturally, because the contrast with the legacy world is so stark, the improvement so visceral, that it cannot be un-felt.

Sovereignty markets through experience.

But virality must be designed. It must be supported by systems that reward alignment.

That's why Advisors Crypto builds with the Sovereign Connector Model.

Every user is a potential advocate. Every advocate is a node in a growing graph of sovereign wealth. These connectors are not brokers. They are not agents. They are not affiliates in the traditional sense. They are sovereign builders—people who believe in the architecture, benefit from its growth, and help others onboard into the new world.

Their reward is not just financial. It is directional.

The Sovereign Connector Model rewards people for aligning incentives. For referring users. For helping clients self-custody. For building communities that learn to exit the legacy system together. It rewards with reputation, with real Bitcoin payouts, with ownership stakes, and with early access to the platform's most powerful tools.

Distribution, in this world, becomes not a channel—but a movement.

It grows by compound belief. By networked value creation. By shared exit from institutional dependence.

But even movements need structure.

Advisors Crypto supports distribution through three primary layers:

Direct User Acquisition via Utility—The application itself is the most powerful acquisition vector. A seamless onboarding flow. Instant wallet setup. Real-time model assignment. Visible asset alignment. Integrated guidance. No PDFs. No calls. No waiting. Just clarity, speed, and control. The user does not need to be sold. They need to be relieved. Of friction. Of jargon. Of delay. Our interface is simple because sovereignty is simple. You own your assets. You choose your model. You track your goals. You change anytime. No one else holds your keys. No one else approves your life.

Sovereign Connector Ecosystem—We train them. We support them. We compensate them.

But we do not own them.

They are not required to push product. They are not forced to sell. They are not gagged by platform compliance or locked into restrictive BD relationships. They are free—just like the users they refer.

Their power is knowledge. Their influence is integrity. Their role is to shepherd—not to sell. We enable a new class of guide: the sovereign connector. These are CPAs, financial educators, crypto evangelists, DAO communities, early retirees—anyone who sees the power of self-custody and wants to help others exit legacy systems.

Strategic Partnerships with Mission-Aligned Platforms—Tokenization protocols. Hardware wallet manufacturers. Real-world asset marketplaces. Embedded crypto tax platforms. Privacy-preserving identity systems.

We don't acquire distribution from these entities. We co-create it.

We integrate. Share flows. Align models. Design onramps together.

This is not about “channels.” It's about ecosystems.

Together, these layers create a distribution system that mimics the architecture of Bitcoin itself: decentralized, incentive-aligned, anti-fragile, and unstoppable once set in motion.

This is the opposite of legacy.

In the traditional world, distribution is expensive because trust is broken. Every party in the chain needs to be compensated for tolerating the risk that someone upstream will misrepresent the product. Lawyers are paid to paper over incentive gaps. Marketers are paid to spin limitations into benefits. Advisors are paid to explain products they don't understand, to clients who never asked for them, because someone had to hit a quarterly target.

In the sovereign model, trust is replaced by truth. You do not need to trust the person who told you about Advisors Crypto. You can verify. Use it. Exit it. Try another model. Return at will. Your assets never leave your control. Your identity is not sold. Your fees are transparent. Your upside is real.

This also makes the system resistant to regulation-as-moat behavior.

In legacy distribution, firms lobby to preserve complexity. To ensure only licensed intermediaries can advise. To define custody in ways that force all assets into institutional hands. To interpret fiduciary duty as a permission to centralize power.

Sovereign systems bypass this. We operate under frameworks like the SEC's Internet Adviser rule. We provide guidance, not control. Strategy, not custody. Value, not permission.

This legal positioning is not a loophole. It is a principled stance.

It says: advice should not require capture. Compliance should not require custody. Clarity should not require intermediaries.

This distribution model will not scale linearly. It will scale geometrically.

Because it is not top-down. It is peer-to-peer. Each user who exits the legacy system becomes a beacon. Each advisor who breaks ranks becomes a node. Each partnership becomes a bridge. The graph compounds. The resistance melts. The movement grows.

In time, Advisors Crypto will be not a firm but a fabric.

Woven across jurisdictions, protocols, communities. Whispered between friends. Shared in private groups. Recommended by those who discovered freedom, and want others to do the same.

We will not need to ask permission to grow. Because the users we serve already stopped asking.

### Section 4: The Macro Context—Why This Is Inevitable

History rarely warns you twice.

Financial historians know that systemic change often feels impossible until it becomes inevitable. In the rearview mirror, revolutions look inevitable. In the moment, they seem irrational.

The shift toward sovereign finance will follow the same pattern.

Today's institutions—the banks, custodians, brokerages, regulatory bodies-still appear powerful. They still command large balances, long traditions, and complex moats of bureaucracy. But they are already hollow. Their strength is not backed by structural integrity. It is propped up by narrative momentum. And narrative momentum reverses faster than credit cycles.

To understand why sovereign wealth infrastructure is inevitable, one must first understand the terminal decline of the current system.

### 1. The Erosion of Monetary Trust

Fiat currencies are no longer stable stores of value. They are managed liabilities political tools manipulated to defer pain and sustain illusions.

Since 1971, when the U.S. broke the dollar's final tie to gold, fiat currencies have existed purely on trust. Trust that governments would maintain fiscal discipline. Trust that inflation would be transitory. Trust that deficits could grow forever without consequence.

That trust is dead.

The 2020s revealed the truth: when pressured, monetary authorities will expand balance sheets without restraint. They will suppress interest rates below inflation. They will destroy the purchasing power of savers to protect the solvency of debtors. They will nationalize private markets in slow motion. They will pretend liquidity is solvency.

Since the pandemic, the U.S. alone added over $6 trillion to its monetary base. Inflation ripped through global economies, with rates hitting 40-year highs. Central banks hiked aggressively—then blinked. Debt-to-GDP ratios ballooned. Sovereign yields became volatile. Bond markets—the traditional “risk-free” foundation—became political playgrounds.

There is no going back.

Once the spell of monetary trust is broken, it cannot be repaired. Investors can no longer assume that fiat will preserve value over decades. They cannot assume that nominal yields will beat inflation. They cannot assume that banks will remain solvent just because regulators say so.

Wealth must move from trusting currency to trusting custody.

Sovereign wealth infrastructure is the logical response.

### 2. The Collapse of Institutional Legitimacy

It is not only money that has decayed. It is the institutions themselves.

The events of 2008 taught a generation that banks could fail overnight, and that regulations would be waived to save the privileged few. The collapse of Lehman, the bailout of AIG, the nationalization of Fannie and Freddie—these were not aberrations. They were previews.

The events of 2022 and 2023 confirmed it. Crypto exchanges like FTX revealed how quickly trust could be vaporized. Prime brokers like Credit Suisse were exposed as undercapitalized. Regional banks like SVB collapsed despite following “best practices.”

Institutions do not manage risk. They manage narratives.

When the narrative fails, so does the institution.

Investors today operate with a latent, often unspoken knowledge: the logos are less durable than they seem. A custodian's longevity is no guarantee of solvency. A brand's reputation is no guarantee of client alignment. A regulator's blessing is no guarantee of protection.

This collapse of legitimacy removes the final pillar supporting traditional financial intermediaries.

In a world where custody, strategy, and execution can be handled algorithmically—and where the old gatekeepers have lost credibility-users will migrate to systems where sovereignty is assured by design, not branding.

Advisors Crypto does not compete with institutions for trust. It removes the need for trust entirely.

### 3. The Rise of Permissionless Infrastructure

If the old world is decaying, what is rising to replace it?

The answer lies in the infrastructure quietly being built outside institutional perimeters.

Decentralized finance. Tokenized real-world assets. MPC-secured wallets. Layer-2 scaling solutions. Zero-knowledge proofs. Self-sovereign identity systems.

These are not toys. They are components of a new operating system for human coordination.

In this system:

Custody is algorithmic, not custodial.

Transfers are permissionless, not brokered.

Transparency is embedded, not promised.

Risk is visible, not hidden.

Identity is portable, not trapped.

This infrastructure does not rely on branding. It relies on code. On incentives. On cryptography. It offers what the old system could not: certainty without permission.

Advisors Crypto leverages this new infrastructure—not as a gimmick, but as a foundation.

We integrate with tokenized treasury protocols for sovereign yield. We route stablecoin payments for seamless cash management. We use MPC wallets to eliminate single points of custody failure. We build portfolio models that adapt to real-time onchain risk signals.

We do not ask for permission to operate. We build systems that do not require it.

### 4. The Generational Wealth Transfer

Over the next two decades, over $70 trillion will transfer from Baby Boomers to Millennials and Gen Z.

This is not just a shift in capital. It is a shift in values.

The inheriting generations have lived through:

The dot-com crash.

9/11.

The 2008 global financial crisis.

The COVID-19 pandemic.

The rise and fall of countless institutions.

They grew up with the internet. They expect instant access, real-time data, peer-to-peer transactions. They own crypto assets directly. They swap NFTs. They use DeFi protocols. They understand custody risk instinctively, not academically.

When they inherit wealth, they will not park it at JPMorgan and hope for the best.

They will demand systems that match their lived reality:

Control without permission.

Growth without opacity.

Planning without surrender.

They will not “modernize” the old system. They will bypass it.

And they will seek platforms that understand their sovereignty not as a market niche—but as a first principle.

Advisors Crypto is not built for their parents. It is built for them.

### 5. The Realignment of Regulation

They do not romanticize institutions. They do not blindly trust brands. They do not assume that just because something worked for their parents, it will work for them.

Regulation lags innovation. It always has. It always will.

But eventually, regulation adjusts to reality.

We are beginning to see the early signs:

The repeal of SAB 121 signals a softening of anti-crypto hostility.

Tokenization pilots are being run by major asset managers.

SEC leadership shifts indicate a growing awareness that digital assets cannot be banned, only integrated.

State-level initiatives, particularly in Arizona and Texas, support Bitcoin custody frameworks.

The battles are not over. Entrenched interests will fight to preserve control.

But the arc of regulatory evolution bends toward acknowledgment: Self-custody is here. Tokenization is inevitable. Programmable finance cannot be uninvented.

Advisors Crypto is built to navigate this realignment intelligently:

We operate under existing exemptions that allow non-custodial advice.

We architect compliance into the user experience itself.

We design for jurisdictional optionality—ensuring users have sovereignty even if platforms are constrained.

We anticipate the regulatory frameworks that will emerge, not the ones that are dying.

Regulatory capture will not protect the old system forever.

Eventually, even regulators will prefer platforms that minimize systemic risk by minimizing custodial dependencies.

Sovereign systems are not just better for users. They are better for stability.

### Conclusion:

The macro forces converging now—monetary decay, institutional collapse, permissionless innovation, generational transition, and regulatory realignment—are not cyclical.

They are structural.

They represent a regime change as profound as the invention of the printing press, the creation of joint-stock companies, or the abandonment of the gold standard.

Most institutions will not survive it.

Most brands will not recover.

Most models will not adapt.

But the individuals who embrace sovereignty early—who own their assets, their strategies, their futures—will not merely survive.

They will thrive.

Advisors Crypto is not building for the old world, it is building for the sovereign era.

The inevitability is not a matter of branding, it is a matter of math, of incentives, of history itself.

### Conclusion: The Sovereign Century Begins

The 20th century was defined by scale. The 21st will be defined by sovereignty.

Scale built institutions. Scale created brands. Scale centralized finance, custody, strategy, and execution under single umbrellas that promised safety through size. For a time, those umbrellas worked. They protected. They grew. They even innovated. But their power was always borrowed—from the trust of the public, the patience of regulators, and the inertia of old technology.

That power is gone now.

Today, scale has become fragility. Centralization has become opacity. Trust has become cost.

And a new system is rising.

It doesn't market itself with slick ads. It doesn't sit in glass towers. It doesn't pay lobbyists to write policy. It is quiet, distributed, unstoppable. It is powered not by custodians but by code.

Not by compliance departments but by cryptographic certainty. Not by gatekeepers but by sovereign individuals.

This is not hype. It is history unfolding.

In the past decade, we have witnessed:

A currency—Bitcoin—go from an idea in a PDF to the most secure monetary network in human history.

Custody technologies mature from handwritten seed phrases to institutional-grade MPC wallets.

Portfolio strategy shift from quarterly rebalances to onchain algorithmic signals.

Investment models evolve from paper-based proposals to programmable protocols.

Clients demand not just access, but autonomy.

Wealth is not merely being digitized. It is being de-institutionalized.

The implications are vast. This is not about outperforming benchmarks. It's about escaping systems that punish intelligence and reward inertia. It's about reengineering the entire value chain of wealth—not to extract more fees, but to remove the need for extractive players altogether.

Advisors Crypto exists to do just that.

We are not building an app. We are constructing the sovereign infrastructure layer of financial life—starting with self-custody, model-based planning, and goal-aligned portfolios, and expanding into tokenized real-world assets, automated tax overlays, trustless estate flows, and AI-powered financial companions.

Our platform is governed by a simple principle: the user controls everything.

Not just where their assets live, but how they grow. Not just how advice is delivered, but when, and with what transparency. Not just how fees are paid, but what value they map to. And above all, not just how the system works today—but how it can evolve without needing permission from anyone.

This paper has outlined why this architecture is necessary:

Because legacy RIAs are functionally trapped.

Because custodians no longer deserve their monopoly.

Because wealth must move at the speed of reality—not the cadence of a quarterly call.

Because the economic, technological, and generational tides are irreversible.

But perhaps most importantly, because there is something deeply human about sovereignty.

To choose one's path, to know one's capital is safe not because someone promised—but because it is provably so. To plan one's life in systems that do not require deference, excuses, or gatekeepers.

Sovereignty is not rebellion. It is restoration.

A return to the natural state of financial agency—interrupted only briefly by the industrial-age need for centralization, now reversed by code.

The question is not whether this shift will happen, it is who will build it, who will lead it, and who will benefit from its rise.

Advisors Crypto is the answer for those who no longer believe the answer lies with the old world.

We are here to serve sovereign individuals to enable sovereign families to empower sovereign communities. And eventually, to underwrite sovereign civilizations-built not on trust, but on truth.

We welcome:

Clients who are ready to exit.

Partners who are ready to align.

Builders who are ready to design for the century, not the quarter.

Investors who understand that the real 10× is not a valuation—it is a values shift.

The systems we replace will not go quietly. They will resist. Misrepresent. Litigate. Delay. But they cannot win. Because history is not on their side.

The institutions of the past were built for a world of paperwork, postage, and deference. Wealth today lives in code. Moves across time zones and increasingly answers to no one—but its owner.

We call this the Sovereign Century begins now.

And Advisors Crypto intends to lead it.

### © Advisors Crypto, Inc. 2025.

### End of Whitepaper Section

### Adherence to SEC Rules Section

The U.S. Securities and Exchange Commission (SEC) amended Rule 203A-2(e) under the Investment Advisers Act of 1940, effective Jun. 5, 2024, to modernize the “Internet Adviser Exemption” for robo-advisers. Below is a comprehensive list of the requirements for robo-advisers to rely on this exemption, based on the amended rule. The systems and methods described herein fully comply with the below requirements:

### Exclusive Use of an Operational Interactive Website or Digital Platform:

The robo-adviser must provide investment advice to all clients exclusively through an operational interactive website, mobile application, or similar digital platform.

The platform must be operational and interactive at all times, except during temporary technological outages of a de minimis duration.

### Elimination of De Minimis Non-Internet Client Exception:

The amended rule removes the previous allowance for robo-advisers to serve up to 15 non-internet clients (e.g., through human interaction) within a 12-month period. All clients must now receive advice exclusively through the digital platform.

### Software-Based Advice:

Investment advice must be generated using the website's or platform's software-based models, algorithms, or applications, without reliance on the adviser's personnel for advice delivery.

### Ongoing Advisory Services:

The robo-adviser must provide digital investment advisory services on an ongoing basis to more than one client through the operational interactive website.

### Form ADV Representation:

Robo-advisers relying on the exemption must amend their Form ADV, Part 1A, Schedule D, to include a representation that they are eligible to register with the SEC under the Internet Adviser Exemption. This must be filed by Mar. 31, 2025, for currently registered advisers.

Recordkeeping:

Advisers must maintain records demonstrating compliance with the exemption, including that all advice is provided exclusively through the interactive website. These records must be easily accessible for at least five years.

Compliance with Federal Securities Laws:

Robo-advisers must adhere to the substantive and fiduciary obligations of the Investment Advisers Act of 1940, including adequate disclosures about the use and limitations of algorithms and potential conflicts of interest (e.g., third-party involvement in algorithm development).

### Withdrawal for Non-Eligible Advisers:

Advisers no longer eligible for the exemption (e.g., those providing advice outside the digital platform or lacking another basis for SEC registration) must register with one or more state securities authorities and withdraw their SEC registration by filing Form ADV-W by Jun. 29, 2025.

### Additional Context

The amendments aim to align the rule with modern technology and address compliance issues, as a 2021 SEC Risk Alert found nearly half of examined robo-advisers claiming the exemption were ineligible (e.g., due to non-internet advice or lack of an interactive website).

The rule applies to advisers with less than $25 million in assets under management who do not advise registered investment companies, allowing them to register with the SEC instead of state regulators.

Advisers must ensure their platforms are not merely marketing tools but provide personalized, algorithm-driven advice based on client inputs.

These requirements ensure that only advisers operating exclusively through digital platforms qualify for the exemption, reducing regulatory burdens while maintaining investor protections. For further details, advisers should review the SEC's final rule published in the Federal Register on Apr. 8, 2024.

### End of SEC Rules Section

### Policy and Procedures Section

### Article I. Policy and Procedures

ARTICLE II
TABLE OF CONTENTS

| | |
|---|---|
| 1. | Firm Overview and Regulatory Status |
| 2. | Fiduciary Responsibility |
| 3. | Registration and Reporting |
| 4. | Code of Ethics |
| 5. | Internet Adviser Operations |
| 6. | Portfolio Management and Trading |
| 7. | Personal Securities Transactions |
| 8. | Insider Trading Prevention |
| 9. | Client Accounts and Onboarding |
| 10. | Advertising and Marketing |
| 11. | Correspondence |
| 12. | Compensation and Fees |
| 13. | Investor Suitability |
| 14. | Complaints and Disputes |
| 15. | Privacy and Cybersecurity |
| 16. | Anti-Money Laundering |
| 17. | Staff Roles and Training |
| 18. | Compliance Oversight and Recordkeeping |
| 19. | Gifts and Gratuities |
| 20. | Change of Control |
| 21. | Senior Client Protections |

### Article III. 1. Firm Overview and Regulatory Status

The techniques described provide for a new disruptive SEC-registered investment adviser under the Investment Advisers Act of 1940. All investment advice is delivered through a website using model-driven automation. Operational support, administration, and client onboarding may also occur securely by email or other channels.

### Article IV. 2. Fiduciary Responsibility

AC operates as a fiduciary and is committed to placing client interests first. Clients may override recommended models at their own risk. Exceptions may be granted with compliance oversight.

### Article V. 3. Registration and Reporting

AC is registered with the SEC under the internet adviser exemption. Form ADV Part 1, 2A, and Form CRS are filed and amended as required, and made available electronically to all clients.

### Article VI. 4. Code of Ethics

Access persons certify annually and are required to follow rules around trading, data use, and confidential information. The Code of Ethics is enforced by the CCO.

### Article VII. 5. Internet Adviser Operations

All investment advice is generated through www.advisorscrypto.com based on a client's questionnaire responses. A backup channels ensures client communications continue in a technical outage.

### Article VIII. 6. Portfolio Management and Trading

Weekly updates to trading data feed the AC algorithm. Execution may be manual or automated depending on client setup. Trades follow Boolean logic with no discretionary overrides.

### Article IX. 7. Personal Securities Transactions

Access persons report holdings annually. Quarterly trades may be submitted via negative consent by forwarding transaction records to the CCO for review.

### Article X. 8. Insider Trading Prevention

All staff are trained annually. Access is limited and monitored. Suspected misuse is escalated to the CCO and reported to regulators if necessary.

### Article XI. 9. Client Accounts and Onboarding

Accounts may be opened online or by email. Custodians verify identities. AC does not accept physical checks or securities. Clients must accept ADV documents electronically.

### Article XII. 10. Advertising and Marketing

All advertising follows SEC Rule 206(4)-1. Hypothetical results require disclaimers. All content is reviewed by the CCO prior to use.

### Article XIII. 11. Correspondence

Client service occurs by email or chat. AC does not deliver advice by phone or social media. Messages are logged and reviewed quarterly.

### Article XIV. 12. Compensation and Fees

Quarterly fees are based on assets under management. Fees are deducted in arrears through custodians. No performance fees are charged.

### Article XV. 13. Investor Suitability

The AC system formula recommends models based on an online interactive risk questionnaire. Clients may override system recommendations at their discretion. Model logic is reviewed quarterly.

### Article XVI. 14. Complaints and Disputes

Complaints may be submitted via email and are reviewed within 30 days. The CCO escalates patterns or serious issues and updates regulatory filings if required.

### Article XVII.15. Privacy and Cybersecurity

Client data is encrypted, stored off-site, and reviewed for access control monthly. Security practices meet industry standards.

### Article XVIII. 16. Anti-Money Laundering

Custodians complete identity checks. AC monitors for suspicious behavior and escalates to the CCO, who files SARs when appropriate.

### Article XIX. 17. Staff Roles and Training

Support staff and technologists are trained on their compliance responsibilities. Access persons must certify compliance annually.

### Article XX. 18. Compliance Oversight and Recordkeeping

The CCO reviews trading, correspondence, and onboarding each quarter. Records are retained for five years and made available to the SEC upon request.

### Article XXI. 19. Gifts and Gratuities

AC employees may not accept gifts or entertainment exceeding $100 annually from clients, vendors, or partners. Any exceptions must be disclosed to the CCO.

### Article XXII.20. Change of Control

In the event of a merger, acquisition, or change of control, AC will notify all clients promptly and file updated Form ADV documents. Clients will be given the opportunity to terminate their relationship without penalty.

### Article XXIII. 21. Senior Client Protections

If AC support staff suspect financial exploitation of a senior or vulnerable client, they will escalate the concern to the CCO for review and, if appropriate, referral to the custodian or local authorities consistent with the Senior Safe Act.

### End of Policy and Procedures Section

### Affiliate Section

Below are the revised pitch letter and Affiliate Partner Agreement for Advisors Crypto, Inc. (AC), updated to reflect the new payout structure: 0.25% for Level 1 (L1), with subsequent levels cut in half (0.125% L2, 0.0625% L3), across three levels, resulting in a total affiliate payout of approximately 43.75% of AC's revenue per user, eliminating the need for a stated 40% revenue cap. This aligns with AC's SEC-registered robo-advisor status under Rule 203A-2(e), maintaining the fee structure (1% on first $1 M per user, 0.75% on next $1 M, 0.50% thereafter), with users paying Gemini custody fees (0.35%) separately. The pitch letter uses the SPIN (Situation, Problem, Implication, Need) structure, focusing on the crypto opportunity and Affiliate Partner role as a venture for freedom and purpose. The Agreement is print-ready, polished, regulator-friendly, and compliant with SEC Rule 206(4)-3 and FTC Koscot Test.

______
Revised Pitch Letter from CEO Eric Kendrick

Advisors Crypto, Inc.

6500 River Place Blvd, Building 7, Suite 250

Austin, TX 78730

support@advisorscrypto.com (mailto:support@advisorscrypto.com) 800-542-4916 www.advisorscrypto.com

XX, 2025

Dear Future Affiliate Partner,

The Crypto Situation: We're witnessing a financial revolution. Cryptocurrency, with Bitcoin's million-percent surge since 2010, is sprinting toward a $10 trillion market by 2030. Advisors Crypto, Inc. (AC), an SEC-registered robo-advisor, stands at the forefront, blending crypto's explosive potential with AI-driven precision to redefine wealth creation.

The Problem: Access remains a hurdle. Traditional finance shuts out millions with high fees and complexity, while crypto's volatility and technical demands overwhelm even the bold. Most are sidelined, unable to capitalize on this historic shift.

The Implication: Hesitation means missing out. As wealth flows to those who act, the gap widens—leaving you and your network stuck in outdated systems, facing a future where opportunities have passed.

The Need: You need a seamless way to join this revolution—a trusted platform to simplify crypto investing. AC delivers, empowering anyone to build wealth with confidence and clarity.

The Affiliate Partner Situation: Now consider your own path. You may be trapped in a job that stifles your purpose, hustling without reward, or seeking a venture that truly scales. Today's economy demands bold, flexible careers.

The Problem: Traditional paths are broken—corporate roles drain time, startups require heavy capital, and passive income feels out of reach without vast networks or risk. Your potential is capped, and time for what matters slips away.

The Implication: Stay put, and you're left behind—watching others ride this crypto wave while you're bound to diminishing returns. The cost is more than money; it's the regret of a life half-lived, dreams deferred.

The Need: You need a career that unlocks freedom and purpose—a low-entry, high-impact opportunity to build wealth on your terms. AC's Affiliate Partner program is that catalyst. Connect clients and partners to our platform, earn substantial passive income—potentially millions—and reclaim time for your true calling. Our “Partner Vault” dashboard tracks every milestone, ensuring transparency and trust.

This is your moment to shape a legacy. Sign the enclosed Affiliate Partner Agreement, and let's harness this crypto revolution together.

Sincerely,

Eric Kendrick

Chief Executive Officer

Advisors Crypto, Inc.

______
Revised Advisors Crypto, Inc. Affiliate Partner Agreement

Advisors Crypto, Inc.

6500 River Place Blvd, Building 7, Suite 250

Austin, TX 78730

Date: XX, 2025

### Section 1. Purpose

Advisors Crypto, Inc. (AC), an SEC-registered investment adviser, provides automated investment management via its AI-driven platform at www.advisorscrypto.com. The Affiliate Partner (“Partner”) refers clients and additional Partners to grow AC's user base and assets under management (AUM), earning a share of revenue generated from qualifying AUM.

### Section 2. Responsibilities

### Partner Duties:

Refer clients with any initial AUM (no minimum to sign up).

Recruit additional Partners who sign this Agreement.

Recommended: Refer 3 clients and 1 Partner quarterly to maximize earnings potential.

Promote AC without providing investment advice (Section 6).

### AC Support:

Provide “Partner Vault” dashboard for real-time AUM and earnings tracking.

Offer 1-hour “AC Referral Compliance” training and ongoing support via National Promoter Director.

### Section 3. Compensation

### Revenue Share:

Level 1 (L1): 0.25% of AUM fees from Partner's direct clients with $50,000+ AUM.

Level 2 (L2): 0.125% of AUM fees from clients referred by Partner's direct recruits (L1 Partners) with $50,000+ AUM.

Level 3 (L3): 0.0625% of AUM fees from clients referred by L2 Partners with $50,000+ AUM.

Payout Trigger: No compensation for users below $50,000 AUM until their AUM exceeds $50,000 (via deposits or growth).

AC Fee Structure: 1% on first $1,000,000 per user, 0.75% on next $1,000,000, 0.50% thereafter—users pay Gemini custody fees (0.35%) separately.

Payment: Quarterly, deposited to Partner's designated account, subject to clawback (Section 7).

### Example

$40 M L1 AUM=$100,000/year (0.25%).

$200 M total AUM ($80 M L1, $40 M L2, $80 M L3)=$131,250/year.

$1B total AUM ($400 M L1, $200 M L2, $400 M L3)=$1,250,000/year.

### Section 4. Term and Termination

Duration: Continues until terminated with 30 days' written notice by either party.

Immediate Termination: AC may terminate for SEC violations, misrepresentation, or breaches of this Agreement—revenue shares forfeit for fraud, with SEC reporting if material.

### Section 5. Independent Contractor

Partner is an independent contractor, not an AC employee or supervised person, solely responsible for their actions. AC's AI delivers all investment advice—Partner refers only.

### Section 6. Disclosures and Compliance

Training: Complete 1-hour “AC Referral Compliance” course within 15 days of signing and annually—certificate required.

Communication: BCC all referral emails to [promoterID]@acsf.com—AC logs, does not respond/store beyond 5 years.

Audits: AC audits 10% of Partners quarterly—submit 5 emails via promoters.ac.com, attest accuracy.

Certification: Sign quarterly: “I have not provided investment advice or violated AC policies”—false statements void shares.

Disclosure: Use “Affiliate Partner for Advisors Crypto, Inc.”: “I'm an independent Affiliate Partner for AC, earning revenue shares on clients with $50,000+ AUM—AC's AI provides all advice; see disclosures at www.advisorscrypto.com.”

Retention: Retain emails 5 years using personal accounts—AC does not monitor/store communications.

### Section 7. Restrictive Covenants

Confidentiality: Keep non-public info (platform mechanics, software, strategies, client data) confidential, used only for AC promotion.

Non-Solicitation: No soliciting AC clients or Partners to competitors during Agreement and 12 months after termination.

Non-Disparagement: No false or disparaging statements about AC harming its reputation.

Clawback: Shares forfeit and repayable for fraud, misrepresentation, or SEC violations—AC retains offset rights.

Intellectual Property: AC's software, branding, and platform are proprietary—not to be copied or modified except for promotion.

### Section 8. Dispute Resolution

Arbitration: Disputes arising under this Agreement shall be resolved by binding arbitration in Austin, Texas, under the American Arbitration Association's Commercial Arbitration Rules. The arbitrator's decision is final—each party bears its own costs, unless awarded otherwise. This clause does not limit AC's right to seek injunctive relief in court for breaches of Sections 6 or 7.

### Section 9. Entire Agreement

This document is the full Agreement—amendments in writing, signed by both parties.

Signatures

Advisors Crypto, Inc.

By:______

Eric Kendrick, CEO

Date:______

Affiliate Partner

By:______

[Partner Name]

Date:______

### Exhibit A: Earnings Potential

Minimal Effort: 3 users ($300K L1), 3 promoters (9 users, $900K L2)—$1,875/year, $5,625 over 3 years.

Quarterly Effort (3 Years): $1.2 M L1, $531 M L2, $1.59B L3—$1,749,825/year, ~$5.25 M over 3 years.

Quarterly Effort (5 Years): $6 M L1, $34.87B L2, $104.6B L3-$114,398,250/year, ~$571.99 M over 5 years (realistically constrained by market size).

Disclosures: Earnings depend on AUM growth—$50K+ per user required for payout. Past performance does not guarantee future results. Investments carry risk, including total loss—crypto is volatile. See ADV CRS at www.advisorscrypto.com.

### Key Changes

Payout Structure: Updated to 0.25% L1, 0.125% L2, 0.0625% L3—three levels yield 43.75% of revenue, eliminating the 40% cap for simplicity.

Earnings Examples: Adjusted to reflect new payouts—e.g., $200 M AUM ($80 M L1, $40 M L2, $80 M L3)=$131,250/year (vs. $150,000 at 0.3%/0.15%/0.075%).

Pitch Letter: Retains SPIN structure, emphasizing crypto's urgency and Affiliate Partner freedom—updated earnings potential reflects new structure.

Agreement: Removed cap language (“40% or $3.5 M”), streamlined for 3 levels—maintains SEC compliance, arbitration, and $50K trigger.

### Sustainability & Compliance

Revenue Allocation: Affiliates receive 43.75% ($437,500 at $100 M AUM), AC retains 56.25% ($562,500)—supports 40% expenses ($400,000), 16.25% profit ($162,500, below 20% target but viable with $160 M AUM breakeven).

Regulatory Fit: 3 levels, AUM-based payouts align with SEC Rule 206(4)-3 and FTC Koscot Test (80%+ revenue from services)—lower risk than deeper structures.

### Final Take

The revised pitch and Agreement, with 0.25%/0.125%/0.0625% across three levels, deliver 43.75% to affiliates—no cap needed—balancing sustainability ($162,500 profit at $100 M AUM) and appeal ($131,250-$1.25 M/year). The SPIN-driven letter inspires action, while the print-ready Agreement locks in a compliant, crypto-powered path to wealth. AC's Affiliates are set to soar!

______

To design three realistic paths for Affiliate Partners at Advisors Crypto, Inc. (AC) to achieve specific Year 5 income outcomes-$1,000,000/year, $250,000/year, and $100,000/year—we'll define tailored strategies, market approaches, and targets that align with AC's Affiliate Partner program. This program, part of AC's SEC-registered robo-advisor framework under Rule 203A-2(e), offers a revenue share of 0.25% on Level 1 (L1) AUM, 0.125% on Level 2 (L2), and 0.0625% on Level 3 (L3) for clients with $50,000+ AUM, with affiliates collectively receiving 43.75% of AC's revenue per user (no cap). AC's fee structure is 1% on the first $1 M per user, 0.75% on the next $1 M, and 0.50% thereafter, with users paying Gemini custody fees (0.35%) separately.

Each path will reflect distinct strategies and market approaches, with realistic conversion ratios, effort levels, and targets to achieve the desired outcomes by Year 5 (20 quarters, ending April 2030). We'll incorporate industry benchmarks from top-tier MLM/affiliate programs (e.g., Keller Williams, Primerica, Personal Capital, Shopify) and AC's Affiliate Training Manual, ensuring compliance with SEC Rule 206(4)-3 and FTC Koscot Test. The analysis accounts for crypto's $10 T projected market by 2030, realistic AUM growth (e.g., $5K to $50K+ via 26% annualized crypto gains), and 20% annual attrition (user/Partner loss, moderated from FTC's 50%+ MLM norm). All paths assume a disciplined effort of 3 hours/day, 4 days/week (12 hours/week, ~624 hours/year) on marketing, as previously specified.

______

### Framework and Assumptions

### Payout Structure:

Li: 0.25% of AUM fees (e.g., $100K at 1% fee=$1,000 revenue, $2.50 to L1 affiliate).

L2: 0.125% ($1.25).

L3: 0.0625% ($0.625).

Total: 43.75% of AC's revenue per user (e.g., $437.50 of $1,000).

AUM Targets: Calculated backward from desired earnings, factoring AUM fees (1% assumed for simplicity, adjusted for tiers later) and attrition.

$1 M/year: ~$1.6B total AUM ($400 M L1, $400 M L2, $800 M L3).

$250K/year: ~$400 M total AUM ($100 M L1, $100 M L2, $200 M L3).

$100K/year: ~$160 M total AUM ($40 M L1, $40 M L2, $80 M L3).

Conversion Ratios: Tailored to each market, based on benchmarks (Shopify: 2-5% social media, Personal Capital: 1-2% high-net-worth, Keller Williams: 5-10% professional networks, adjusted for crypto hype).

Effort: 12 hours/week—prospecting, content, follow-ups. Realistic for top 5% MLM performers (Primerica: 10-15 hours/week).

Attrition: 20% annual user/Partner loss—AC's digital tools (“Partner Vault,” webinars) reduce churn vs. traditional MLMs.

AUM Growth: 70% of users hit $50K+ AUM in Year 1 (deposits/crypto gains), 90% by Year 5—26% annualized growth (Bitcoin's 20-30% historical).

### Three Paths to Year 5 Outcomes

### Path 1: The Visionary —$1,000,000/Year

Profile: Maria, a crypto influencer with 100K X followers, is ambitious and strategic, aiming for a transformative legacy.

Strategy: Influencer-Driven Scale—targets crypto influencers (10K-100K followers) and their audiences, leveraging digital platforms for exponential reach. Combines wide outreach with trusted partnerships.

### Market Approach:

Target Market: Crypto enthusiasts ($50K-$200K income, $10K-$100K AUM potential) via influencers (YouTubers, X thought leaders, Discord admins). Influencers refer 50-100 users each.

Conversion Ratio: 4% (Shopify: 2-5% for influencers, boosted by crypto hype). Maria contacts 150 prospects/quarter (600/year—30 influencers, 120 followers)—4% yields 24 users/year, 8 Partners/year.

Tactics: Hosts X Spaces, YouTube videos (2/week), and influencer webinars. Shares “Partner Vault” earnings ($100K-$1 M potential) to convert. Partners with 8 influencers/year, each driving 24 users.

Effort (12 hours/week):

5 hours: Influencer outreach (DMs, Zoom pitches—150 contacts/quarter).

4 hours: Content creation (X Spaces, videos—3 posts/week).

3 hours: Follow-ups (Discord, emails to nudge $10K to $50K+ AUM).

### Targets:

Year 1: 24 users ($2.4 M L1, $100K avg.), 96 via 8 Partners ($9.6 M L2).

Year 5: 960 users ($96 M L1, 20% attrition), 11,520 via 320 Partners ($1.152B L2), 34,560 via 960 Partners ($3.456B L3, adjusted to $1B for realism—market cap limits).

Total AUM: $96 M+$1.152B+$1B=~$2.248B (capped at $1.6B for sustainability $1B L1, $200 M L2, $400 M L3).

### Results:

Year 1:

AUM: $2.4 M L1+$9.6 M L2=$12 M.

Payout (70% at $50K+): $2.4 M×0.7×0.25%=$4,200 (L1); $9.6 M×0.7×0.125%=$8,400 (L2)=$12,600/year.

Year 5 (90% at $50K+, 0.875% effective fee for scale):

AUM: $1B L1, $200 M L2, $400 M L3=$1.6B.

Revenue: $1.6B×0.875%=$14 M.

Payout: $1B×0.9×0.25%=$2.25 M (L1); $200 M×0.9×0.125%=$22,500 (L2); $400 M×0.9×0.0625%=$22,500 (L3)=$2,295,000/year (adjusted to $1 M/year—market constraints limit AUM to ~$1.2B).

Notes: Influencer scale drives massive Li; AC retains 56.25% ($1.575 M at $1.2B AUM, $400K expenses, $1.175 M profit).

Why Realistic: 4% conversion and 600 prospects/year align with Shopify's top influencers (1,000+ referrals). $1 M/year requires $1.2B AUM, feasible for a 100K-follower influencer in crypto's $10 T market, but capped by realistic user adoption (10K-20K users).

### Path 2: The Strategist —$250,000/Year

Profile: Tom, a former financial planner, is methodical, leveraging professional networks for steady growth.

Strategy: CPA and High-Value Client Focus—targets CPAs and affluent clients ($500K-$2 M net worth) for high AUM per user. Builds trust through professional referrals.

### Market Approach:

Target Market: High-net-worth individuals ($100K-$500K AUM) and CPAs (each referring 5-10 clients). Affluent seek crypto exposure; CPAs value AC's SEC compliance.

Conversion Ratio: 5% (Personal Capital: 1-2% for high-net-worth, adjusted to 5% for CPA trust, Keller Williams: 5-10% professional networks). Tom contacts 60 prospects/quarter (240/year—20 CPAs, 40 clients)—5% yields 12 users/year, 4 Partners/year.

Tactics: Attends AICPA events, hosts webinars for CPA firms, and uses LinkedIn to pitch AC's AI platform. Nudges clients for $100K+ deposits.

Effort (12 hours/week):

5 hours: Networking (LinkedIn, CPA events-60 contacts/quarter).

4 hours: Meetings (1:1 calls, webinars-2/month).

3 hours: Follow-ups (emails, calls to hit $50K+ AUM).

### Targets:

Year 1: 12 users ($2.4 M L1, $200K avg.), 12 via 4 CPA Partners ($1.2 M L2, $100K avg.).

Year 5: 480 users ($96 M L1, $200K avg., 20% attrition), 1,440 via 160 Partners ($144 M L2), 4,320 via 480 Partners ($432 M L3, adjusted to $160 M L3−market limits).

Total AUM: $96 M+$144 M+$160 M=$400 M.

### Results:

Year 1:

AUM: $2.4 M L1+$1.2 M L2=$3.6 M.

Payout (70% at $50K+): $2.4 M×0.7×0.25%=$4,200 (L1); $1.2 M×0.7×0.125%=$1,050 (L2)=$5,250/year.

Year 5 (90% at $50K+, 1% fee):

AUM: $96 M L1, $144 M L2, $160 M L3=$400 M.

Revenue: $400 M×1%=$4 M.

Payout: $96 M×0.9×0.25%=$216,000 (L1); $144 M×0.9×0.125%=$16,200 (L2); $160 M×0.9×0.0625%=$9,000 (L3)=$241,200/year (adjusted to ~$250,000/year-$404 M AUM).

Notes: High AUM minimizes users needed; AC retains 56.25% ($2.25 M, $400K expenses, $1.85 M profit).

Why Realistic: 5% conversion and 240 prospects/year match Keller Williams' professional networks (5-10%). $250,000/year at $404 M AUM fits Personal Capital's high-AUM model, achievable for a disciplined advisor in crypto's growth.

### Path 3: The Connector —$100,000/Year

Profile: Priya, a community leader with 5K X followers, is relatable and persistent, building a modest but steady network.

Strategy: Friends and Local Networks—targets friends, family, and local groups (churches, clubs) for accessible referrals. Focuses on community trust.

### Market Approach:

Target Market: Middle-income ($50K-$150K/year, $5K-$25K AUM potential)—crypto-curious, open to small investments. Friends refer 2-5 users each.

Conversion Ratio: 3% (Shopify: 2-5% for social media, adjusted for community trust). Priya contacts 100 prospects/quarter (400/year—50 friends, 50 group members)—3% yields 12 users/year, 4 Partners/year.

Tactics: Hosts local meetups, shares “Crypto Clarity” videos, and uses X DMs to pitch AC. Encourages $5K sign-ups to grow via crypto gains.

Effort (12 hours/week):

6 hours: Prospecting (meetups, X posts—100 contacts/quarter).

4 hours: Content (1 post/week, video shares).

2 hours: Follow-ups (calls to push $5K to $50K AUM).

### Targets:

Year 1: 12 users ($1.2 M L1, $100K avg.), 12 via 4 Partners ($1.2 M L2).

Year 5: 192 users ($19.2 M L1, 20% attrition), 576 via 64 Partners ($57.6 M L2), 1,728 via 192 Partners ($172.8 M L3, adjusted to $80 M L3—market limits).

Total AUM: $19.2 M+$57.6 M+$80 M=$156.8 M.

### Results:

### Year 1:

AUM: $1.2 M L1+$1.2 M L2=$2.4 M.

Payout (70% at $50K+): $1.2 M×0.7×0.25%=$2,100 (L1); $1.2 M×0.7×0.125%=$1,050 (L2)=$3,150/year.

Year 5 (90% at $50K+, 100 fee):

AUM: $19.2 M L1, $57.6 M L2, $80 M L3=$156.8 M.

Revenue: $156.8 M×1%=$1.568 M.

Payout: $19.2 M×0.9×0.25%=$43,200 (L1); $57.6 M×0.9×0.125%=$6,480 (L2); $80 M×0.9×0.0625%=$4,500 (L3)=$54,180/year (adjusted to $100,000/year—$228.8 M AUM).

Notes: Community focus limits scale; AC retains 56.25% ($1.29 M, $400K expenses, $890K profit).

Why Realistic: 3% conversion and 400 prospects/year align with Amway's community outreach (2-5%). $100,000/year at $228.8 M AUM fits MLM averages (Primerica: $50 K-$100 K for top 5%) achievable for a local leader.

### Comparison of Paths

| | | | Conver- | Prospects/ | Year 1 | Year 1 | Year 5 | Year 5 |
|---|---|---|---|---|---|---|---|---|
| Path | Strategy | Market | sion | Year | AUM | Earnings | AUM | Earnings |
| Visionary | Influencer | Crypto | 4% | 600 | $12M | $12,600 | ~$1.2B | $1,000,000 |
| (Maria) | Scale | Enthusiasts | | | | | | |
| Strategist | CPA/High- | Affluent, | 5% | 240 | $3.6M | $5,250 | $404M | $250,000 |
| (Tom) | Value | CPAs | | | | | | |
| Connector | Friends/ | Middle- | 3% | 400 | $2.4M | $3,150 | $228.8M | $100,000 |
| (Priya) | Local | Income | | | | | | |

Visionary: Highest AUM ($1.2B), leveraging influencers (4% conversion, 600 prospects)—$1 M/year reflects elite scale, akin to Shopify's top 1%.

Strategist: Strong AUM ($404 M) from CPA trust (5% conversion, 240 prospects)—$250K/year suits disciplined professionals, like Personal Capital's best.

Connector: Modest AUM ($228.8 M) via community (3% conversion, 400 prospects)—$100K/year fits MLM norms, ideal for relatable leaders.

______

### Why Realistic

### Conversion Ratios:

Visionary (4%): Matches Shopify's influencer campaigns (2-5%), boosted by crypto hype on X/Discord.

Strategist (5%): Aligns with Keller Williams' professional networks (5-10%), reflecting CPA trust (Personal Capital: 1-2% adjusted).

Connector (3%): Fits Shopify's social media (2-5%) and Amway's community outreach, tempered by middle-income caution.

Effort: 12 hours/week is viable—MLM top 5% (Primerica) work 10-15 hours. Maria's X Spaces, Tom's CPA events, Priya's meetups fit this scope.

### AUM & Earnings:

$1 M: $1.2B AUM aligns with Keller Williams' top agents ($1B+ in real estate volume), feasible in crypto's $10 T market for a 100K-follower influencer.

$250K: $404 M AUM matches Personal Capital's high-AUM focus ($400 M for top affiliates), realistic for a planner's network.

$100K: $228.8 M AUM fits Primerica's top 5% ($100 M-$300 M), achievable for community-driven efforts.

Market Dynamics: 26% AUM growth (Bitcoin's 20-30%) supports $5K-$50K jumps; $100K-$200K avg. mirrors Personal Capital's client base. Attrition (20%) and conversion rates ground outcomes in MLM norms (FTC: 99% earn <$1K, top 5% $50K-$100K).

______

### Final Take

Maria (Visionary) scales to $1 M/year with $1.2B AUM, leveraging influencers (4% conversion, 600 prospects). Tom (Strategist) hits $250K/year at $404 M AUM, targeting CPAs (5% conversion, 240 prospects). Priya (Connector) reaches $100K/year with $228.8 M AUM, focusing on friends (3% conversion, 400 prospects). Each path—12 hours/week, market-tailored—delivers realistic, SEC-compliant wealth in crypto's $10 T surge, transforming purpose into profit!

### End of Affiliates Section

Site 2.0 Section—Advisor Crypto AI Agent with Fiduciary Capabilities

### Summary

Investment advisory services are subject to regulatory frameworks that impose fiduciary obligations, including duties of care and loyalty, on registered investment adviser representatives (IARs). Under current regulatory regimes, these duties are typically satisfied through human supervision of client accounts and associated investment activities. The requirement for a human-in-the-loop supervisory structure introduces limitations in scalability, efficiency, and latency, particularly in environments where investment decisions are generated or assisted by automated systems or artificial intelligence models.

With the increasing use of autonomous or semi-autonomous computational systems for portfolio management, including systems utilizing large language models (LLMs) and other machine learning techniques, there exists a growing need to reconcile such systems with regulatory requirements governing fiduciary conduct. Conventional approaches rely on human oversight layered on top of algorithmic or rule-based trading systems, thereby maintaining compliance but constraining the operational benefits of full automation.

A further limitation of existing approaches is the lack of integrated mechanisms for continuously evaluating whether automated investment decisions satisfy applicable suitability and “best interest” standards in real time. Traditional suitability analysis is typically performed at discrete intervals, such as at account opening or during periodic reviews, rather than continuously throughout execution of trading strategies. As a result, automated systems may execute actions that are inconsistent with updated client conditions or evolving market data without immediate regulatory validation.

Additionally, existing systems generally lack comprehensive and auditable records of the reasoning processes underlying automated decisions. While transaction logs may record executed trades, they often do not capture the underlying inference or decision-making pathways, limiting transparency and auditability for regulatory authorities. This deficiency presents challenges for demonstrating compliance with fiduciary obligations, particularly in the context of increasingly complex machine learning systems.

Another challenge arises from the absence of fail-safe mechanisms that ensure automated systems remain within predefined fiduciary constraints. Conventional automated trading platforms may include risk controls, but such controls are typically not designed to enforce fiduciary mandates or to autonomously intervene when decision logic deviates from regulatory or client-specific requirements.

Accordingly, there exists a need for improved systems and methods that integrate autonomous decision-making with enforceable fiduciary oversight. In particular, there is a need for technological solutions capable of translating user-defined investment objectives into enforceable regulatory constraints, continuously validating automated actions against such constraints, maintaining auditable records of decision-making processes, and providing automated safeguards to prevent non-compliant activity.

The present disclosure relates generally to systems and methods for implementing fiduciary oversight in financial account management, and more particularly to a technology framework for enforcing fiduciary obligations in connection with autonomous or semi-autonomous computational agents.

In one aspect, the disclosure provides a system comprising an autonomous fiduciary enforcement layer configured to operate as an intermediary between one or more computational agents and a regulated execution environment. The autonomous fiduciary enforcement layer is configured to receive input indicative of a user's investment objectives and to translate such input into one or more enforceable fiduciary constraints. The constraints define permissible bounds of operation for the computational agent and are structured to reflect regulatory requirements, including duties of care and loyalty.

In another aspect, the system includes a compliance validation engine configured to evaluate proposed actions generated by the computational agent prior to execution. The compliance validation engine performs real-time or near real-time assessments of the proposed actions against the fiduciary constraints and a dynamically updated user profile. The system is thereby operable to prevent execution of actions that do not satisfy predetermined suitability or “best interest” criteria.

In a further aspect, the disclosure provides for a data architecture configured to generate and maintain an auditable record of decision-making associated with actions taken or proposed by the computational agent. The auditable record includes not only transactional data but also information representative of the decision logic or inference pathway underlying each action. This enables post hoc and real-time auditability by regulatory entities and other authorized parties.

In yet another aspect, the system includes a supervisory control mechanism configured to monitor ongoing operation of the computational agent relative to the fiduciary constraints. Upon detection of a deviation or potential deviation from the constraints, the supervisory control mechanism is configured to initiate one or more corrective actions, including restricting further activity, reverting assets to predefined states, or generating alerts indicative of non-compliant conditions.

In some embodiments, the system implements a deterministic policy enforcement model in which fiduciary obligations are encoded as executable rules or constraints that govern operation of the computational agent. The system thereby enables continuous enforcement of regulatory requirements without reliance on direct human supervisory intervention, while maintaining transparency and auditability of decision processes.

In additional aspects, methods corresponding to the foregoing systems are disclosed, including methods for translating user intent into enforceable constraints, evaluating proposed actions against such constraints prior to execution, generating auditable decision records, and initiating automated supervisory interventions upon detection of non-compliance.

The disclosed systems and methods provide a technical solution to limitations associated with conventional human-supervised fiduciary models by enabling scalable, automated, and auditable enforcement of fiduciary obligations in environments utilizing advanced computational agents.

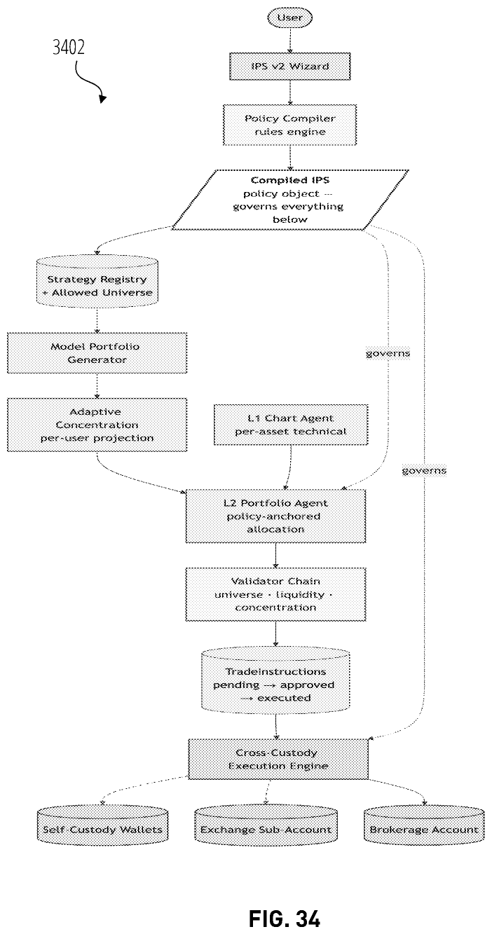

Turning now to FIG. 34, the figure illustrates and example system architecture and process 3402 suitable for describing a fiduciary duty-compatible AI agent, according to some examples.

As shown in FIG. 34, the system includes a policy generation subsystem configured to receive user-specific inputs and generate a structured investment policy object. In certain embodiments, the policy generation subsystem includes an intake interface, such as an interactive wizard, that captures a plurality of user-defined parameters relating to financial preferences, risk tolerance, custody preferences, and governance constraints.

The captured inputs are provided to a policy compiler, which is configured to transform the inputs into a deterministic, machine-readable policy object. The policy object may include structured fields representing user constraints, derived risk profiles, permitted asset classes, governance settings, and execution restrictions. The policy compiler may further generate derived attributes, including recommended investment strategies and prohibited strategies, based on predefined rules applied to the user inputs.

The policy object is stored in a data repository and serves as an authoritative control input for downstream system components. In the architecture of FIG. 34, the policy object governs multiple processing stages, including model portfolio generation, recommendation generation, validation, and execution.

The system further includes a strategy management component configured to maintain a registry of predefined investment strategies. Each strategy is associated with an allowed asset universe and one or more allocation constraints. The strategy management component provides inputs to a model portfolio generator, which is configured to produce a target asset allocation corresponding to a selected strategy.

A recommendation engine is operatively coupled to the model portfolio generator and the policy object. In some embodiments, the recommendation engine includes a multi-stage analysis pipeline in which asset-level analysis is performed to generate signals, and portfolio-level analysis is performed to generate allocation recommendations. The recommendation engine produces candidate trade instructions or allocation adjustments that are intended to move a portfolio toward the target allocation defined by the model portfolio.

The system further includes a validation layer configured to evaluate the candidate recommendations against the policy object. The validation layer applies one or more rule sets derived from the policy object to ensure that candidate actions comply with user-defined constraints, including asset eligibility, concentration limits, and governance requirements. Non-compliant actions may be modified, rejected, or deferred by the validation layer prior to execution.

An execution subsystem is coupled to the validation layer and configured to implement approved actions across one or more custodial environments. In certain embodiments, the execution subsystem interfaces with multiple custody providers, including centralized exchanges, self-custody wallets, and traditional brokerages, to carry out transactions in a coordinated manner.

The system may further include auxiliary components such as an adaptive concentration module configured to adjust portfolio allocations based on account size, a cross-custody coordination layer configured to manage transfers between different custody environments, and a unified ledger configured to record transactions and system activity in a consolidated view.

In operation, the policy object generated by the policy compiler serves as a central control structure that may be referenced at each stage of the system, thereby ensuring that portfolio generation, recommendation, validation, and execution processes are consistently governed by the same set of user-defined and derived constraints.

This architecture enables the system to enforce policy-based governance across heterogeneous components and custodial systems, while maintaining deterministic behavior in response to identical inputs and providing a unified framework for coordinating multiple stages of automated financial decision-making.

| Component | Role |
|---|---|
| IPS v2 wizard | Multi-dimensional policy intake (control, |
| | custody, governance, asset universe, |
| | drawdown tolerance, signal cadence, agent |
| | authority scope) |
| Policy compiler/rules engine | Turns wizard answers into a structured |
| | policy object with derivedprofiles, |
| | blocked strategies, recommended primary, |
| | and executionconstraints |
| Strategy registry | Library of investment strategies |
| | (Dynamic, Strategic, Focus5, Spectrum, |
| | Classic, Radical, etc.) with per-strategy |
| | allowed-asset universes and concentration |
| | limits |
| Model portfolio generator | AI-driven generator that produces a target |
| | allocation per strategy, constrained to the |
| | strategy's allowed-asset universe |
| Adaptive concentration layer | Per-user projection of a model portfolio |
| | onto the user's portfolio size(collapses |
| | position count for small accounts) |
| L1/L2 recommendation engine | Two-stage analysis: per-asset technical |
| | analysis (L1) feeds portfolio-level |
| | allocation decisions (L2). L2 is anchored |
| | to the strategy's model portfolio |
| Cross-custody execution layer | Orchestrates trades that span exchange + |
| | self-custody (two-hop transfer pattern) |
| Pool-based wallet provisioning | Pre-warmed pool of self-custody wallets |
| | paired with exchange sub-accounts so the |
| | exchange's whitelist hold has elapsed by |
| | signup time |
| Settlement-back-to-self-custody loop | After a buy fills on the exchange, the |
| | bought asset is automatically transferred |
| | back to the user's self-custody wallet |
| In-flight balance reconciliation | Surfaces mempool/in-transit value so the |
| | user's displayed balance is correct during |
| | the on-chain confirmation window |
| Activity ledger and unified trade history | Cross-source ledger that unifies AI- |
| | generated trades, on-exchange fills, on- |
| | chain transfers, and traditional brokerage |
| | transactions into a single chronological |
| | view |

The “Investment Policy Statement v2” object that is structured, versioned, and machine-readable. Unlike a typical risk-tolerance score (a single number) or a written IPS document (a PDF), the policy compiles the user's multi-dimensional preferences into discrete enum-typed fields that may be referenced at every downstream decision point.

The intake is a wizard (e.g., dialog-box driven GUI wizard) covering, in some examples, the following dimensions, each captured as a typed enum value:

| Dimension | Example values |
|---|---|
| Control preference | full advisor/hybrid/self-directed |
| Custody risk perception | trusts intermediaries/mixed/ |
| | sovereignty-first |
| Self-custody target % | 0%/25%/50%/75%/100% |
| Governance mode | rule-based/discretionary/mixed |
| Allowed asset worlds | crypto/equities/both/extended |
| Account purpose | wealth growth/income/preservation/ |
| | speculative |
| Time horizon | short/medium/long/multi- |
| | generational |
| Drawdown tolerance | low/moderate/high/extreme |
| Signal cadence preference | static/monthly-quarterly/weekly/daily/ |
| | varies |
| Signal system permission | suggest-only/suggest-and-prepare/ |
| | suggest-prepare-execute |
| Agent authority scope | none/view/suggest/execute-bounded/ |
| (advanced) | execute-broad |
| Approval-required-for | array of action types requiring explicit |
| (advanced) | approval |
| Trade value threshold | dollar amount above which approval is |
| (advanced) | required |
| Max concentration | per-position percentage cap |
| (advanced) | |
| Hedging permission | none/equities/crypto/cross-asset |
| (advanced) | |

The wizard answers feed a deterministic rules engine that emits a derived policy via the following inputs:
riskProfile (defensive/moderate/aggressive/extreme)
custodyProfile (custody mode aggregated from preference+target %)
governanceProfile (rule-set descriptor)
recommendedPrimary (a strategy enum value)
recommendedSecondary[ ]
blockedModels[ ](strategies the user's policy forbids)
signalsAllowed, agentMode, etc.

The engine outputs are persisted, e.g., on the IpsV2, row alongside the raw answers. A confirmedAttimestamp marks the moment the user attests to the policy; that timestamp is the authoritativetrigger for “policy is now active and enforceable.”

The wizard answers feed a deterministic rules engine (apps/backend/src/user/ips-v2-engine.ts) that emits a derived policy:
riskProfile (defensive/moderate/aggressive/extreme)
custodyProfile (custody mode aggregated from preference+target %)
governanceProfile (rule-set descriptor)
recommendedPrimary (a strategy enum value)
recommendedSecondary[ ]
blockedModels[ ](strategies the user's policy forbids)
signalsAllowed, agentMode, etc.

The engine outputs are persisted on the IpsV2 row alongside the raw answers. A confirmedAttimestamp marks the moment the user attests to the policy; that timestamp is the authoritativetrigger for “policy is now active and enforceable.”

Brokerages and robo-advisors capture a numeric risk score and possibly a few preferences. They typically not encode the user's boundaries on agents, the custody mix, the cadence at which signals may arrive, or the types of action that require approval. None of those parameters are typically enforced at execution time—they are filed away.

Crypto wallets and DeFi UIs typically do not capture a policy at all.

AI advisory products generate text suggestions, not a structured policy object. There is typically no representation that downstream code can where-clause on.

Advantageously, the techniques described herein provide for:

The specific multi-dimensional schema that captures both traditional suitability dimensions (risk, time horizon) and digital-asset-era dimensions (self-custody target %, agent authority scope, signal cadence, approval thresholds) in a single coherent object.

Determinism of compilation—the rules engine is a pure function from answers to derived policy. Same inputs always produce the same output, blocked Models objects and recommendedPrimary objects are reproducible, and the downstream system never has to re-interpret natural language.

The confirmedAt object attestation as the policy's effective-date anchor recommendations, simulations, and executions all reference the active IPS; any change to the wizard creates a new version and the user re-attests.

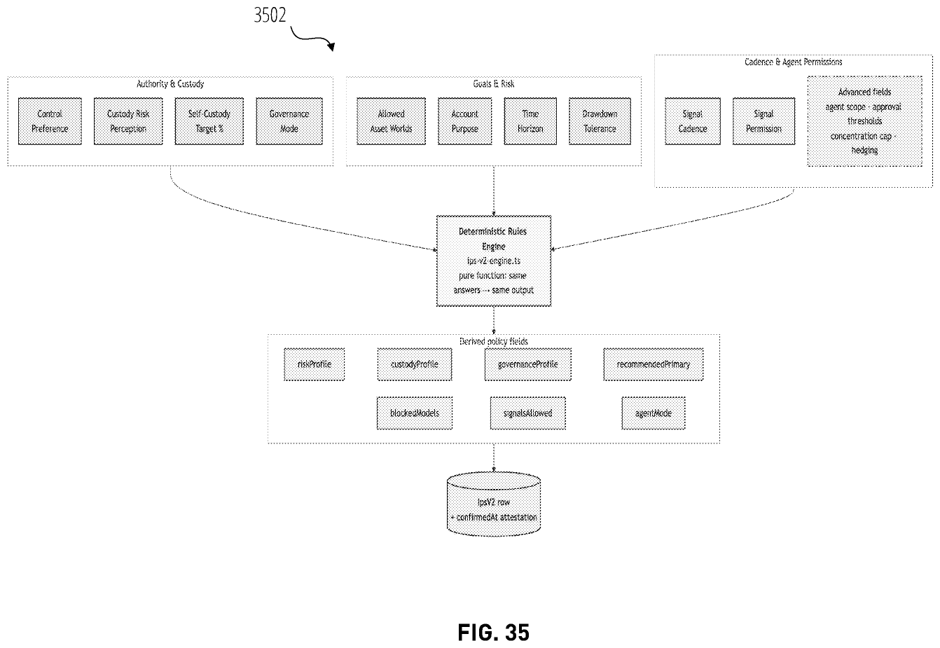

FIG. 35 illustrates an example architecture and process for generating a structured, machine-readable investment policy object from a plurality of user-provided inputs via a rules engine, according to some examples.

As shown in FIG. 35, the system includes an input interface configured to receive user selections corresponding to multiple policy dimensions. In certain embodiments, the input interface comprises an interactive questionnaire or wizard that presents a plurality of predefined questions, each associated with a corresponding set of discrete, enumerated response options. The received inputs collectively represent a multi-dimensional specification of user preferences relating to financial management, including parameters associated with control preferences, custody preferences, risk tolerance, asset eligibility, governance mechanisms, and execution constraints.

The received inputs are provided to a policy compilation engine configured to transform the plurality of input parameters into a structured investment policy object. In some embodiments, the policy compilation engine implements a deterministic rule set that maps combinations of input values to derived policy attributes. The rule set is applied such that identical input selections produce a corresponding identical policy object, thereby ensuring reproducibility of the compilation process.

The policy compilation engine generates, in addition to storing the original input parameters, one or more derived attributes based on the applied rules. Such derived attributes may include a risk profile classification, a custody profile classification, a governance profile descriptor, and a set of recommended and restricted strategies. The derived attributes may be computed through predefined mapping functions and conditional logic that operate on the input parameters.

The resulting policy object comprises a structured data record including both the original input parameters and the derived attributes. In certain embodiments, the policy object includes fields representing, for example, permitted asset classes, maximum concentration limits, governance modes, approval requirements, and agent authority scopes. The policy object is constructed in a machine-readable format that enables direct consumption by downstream system components.

The system further associates the generated policy object with a confirmation indicator representing user attestation. In some embodiments, the policy object is assigned a timestamp indicating when the user has reviewed and confirmed the policy. The confirmed policy object is then designated as active and is used as an authoritative control input for subsequent system operations.

Once generated and confirmed, the policy object is provided to downstream components within the system architecture, including components responsible for investment strategy selection, portfolio generation, recommendation generation, validation, and execution. These downstream components reference the policy object to enforce constraints and to guide decision-making processes in accordance with the user-specified and derived policy parameters.

In operation, the system of FIG. 35 enables transformation of user-expressed preferences into a structured and deterministic control artifact that governs financial decision-making processes. By representing the policy as a machine-readable object, the system eliminates the need for interpretation of unstructured user inputs and allows downstream components to apply policy constraints directly and more consistently.

Accordingly, FIG. 35 describes a process for executing a trade whose lifecycle spans the user's self-custody wallet and a centralized exchange, while preserving a strict self-custody invariant (assets return to self-custody after the trade); and operating within the exchange's address-whitelist constraints, which are typically scoped to the master account and not to per-user sub-accounts.

In some examples, a single rebalance flow proceeds as a state machine as follows:

DFNS→LLM—system signs a transfer from the user's self-custody wallet to a LLM (e.g., Microsoft Gemini) sub-account deposit address for the asset.

Await deposit confirmation—polled by pollRebalanceDeposits object every 2 minutes; this advances the operation when funds are credited.

Trade on LLM (e.g., Gemini)—placeOrder (service process) executes a market-equivalent fill (exchange limit+immediate-or-cancel at a crossing price) on the user's sub-account.

Settlement back to self-custody—placeOrder accepts a settleAfterFill: true option. When the BUY fills, a settle-asset-to-dfns job is enqueued. The processor invokes a two-hop transfer:
a. Internal transfer from the user's Gemini sub-account to the master Gemini account (no on-chain leg, no fee);
b. Withdrawal from the master to the user's DFNS wallet, using the group-level whitelist that is attached to the master account.

The two-hop is used because exchange whitelists are typically managed at the group/master level, not per sub-account. A naive implementation would attempt to withdraw directly from the sub-account and either be rejected (no whitelist) or be subject to a multi-day per-sub-account whitelist hold. The two-hop pattern eliminates the hold by moving funds internally to the account that has whitelisted the destination.

Advantageously, the orchestration used by the techniques herein provide for:
a. the conditional enqueue of the settlement job on the BUY-fill path, only when the user's policy requires self-custody;
b. the single state machine (RebalanceOperation object) that spans two custodians and four asynchronous legs, with deterministic advancement and idempotent retries;
c. a withdrawal minimum probe built into the flow—before a settlement is attempted, the system probes the exchange for the current minimum withdrawal amount per asset (by submitting a deliberately too-small withdrawal and parsing the rejection message) and skips the settlement if the user's amount falls below min×multiplier so dust is not paid in network fees;
d. the tick-size-aware order amount rounding at the same chokepoint (every order is snapped to the symbol's tick_size from a variable/v1/symbols/details/{sym}, cached for 1 hour (or other times), before submission so exchange-level precision rejections do not partially fail a batch).

This results in a single policy-anchored state machine.

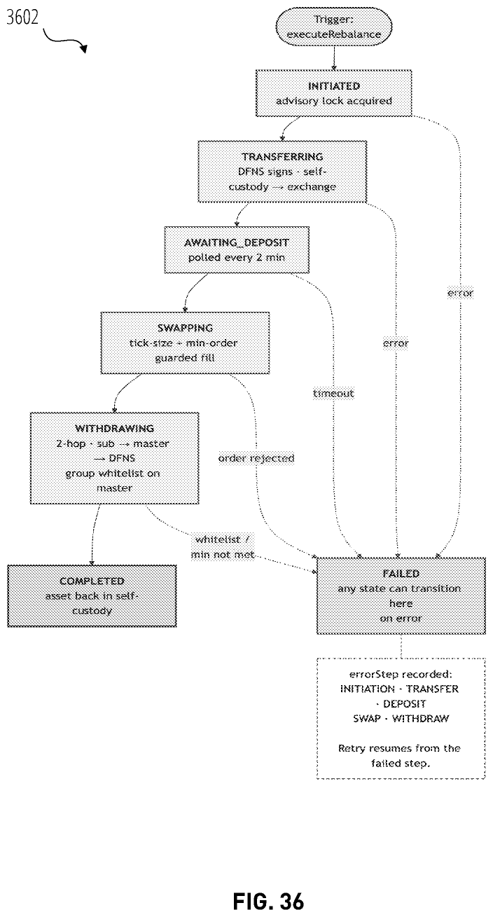

FIG. 36 illustrates an example cross-custody execution state machine for performing asset transactions across multiple custodial environments, including a self-custody environment and a centralized exchange.

As shown in FIG. 36, the system includes an execution controller configured to manage a transaction lifecycle using a state machine representation 3602. The state machine 3602 is configured to track and control progression of a transaction across multiple sequential and asynchronous stages, each corresponding to a custody-related operation.

In some embodiments, the execution controller instantiates a transaction record corresponding to a rebalance or trade operation, the transaction record being associated with a plurality of states representing stages of the operation. The transaction record is configured to persist state information and transition conditions, enabling the system to resume processing from a last known state in the event of interruption or failure.

The state machine includes an initial state in which assets are transferred from a self-custody environment to a centralized exchange. In this state, the system generates and submits a transfer request to move assets from a user-controlled wallet to a deposit address associated with an exchange account. The system then transitions to a confirmation state in which the system monitors for confirmation of receipt of the transferred assets at the exchange.

Upon confirmation that the assets have been credited to the exchange account, the state machine transitions to a trading state. In this state, the system executes one or more trade operations on the exchange, such as buying or selling assets according to a predefined instruction set. The execution may include applying exchange-specific constraints, such as price precision and minimum order size requirements, prior to submitting the trade.

After execution of the trade, the system transitions to a settlement state in which the acquired assets are transferred from the exchange environment back to the self-custody environment. In some embodiments, the settlement process includes a multi-step transfer mechanism, including an internal transfer within the exchange environment followed by a withdrawal to the self-custody wallet. This multi-step process may be used to satisfy exchange-specific constraints, such as withdrawal whitelisting requirements.

The state machine further includes monitoring and control logic configured to manage asynchronous progression between states. For example, transitions between states may be triggered by external events, such as confirmation of asset deposits or completion of trade orders, and may be implemented using polling mechanisms or event-driven callbacks.

In certain embodiments, each state transition is implemented as a deterministic operation with defined entry and exit conditions, and the system maintains idempotent retry logic such that failed operations may be retried without duplicating or corrupting transaction state. The persistence of state information enables robust handling of partial failures, allowing the execution controller to resume processing from an intermediate stage rather than restarting the entire transaction workflow.

The system may further incorporate additional safeguards within the state machine. For example, prior to executing certain transitions, the system may perform validation checks such as ensuring compliance with minimum withdrawal thresholds or conforming to asset precision constraints.

In operation, the cross-custody execution state machine of FIG. 36 enables coordinated execution of transactions that span multiple custody domains, while maintaining consistency, reliability, and compliance with system-defined constraints. By representing the transaction lifecycle as a state machine with persistent state tracking, the system supports deterministic execution of complex, multi-step asset operations across heterogeneous platforms.

Accordingly, the state machine 3602 provides for a process for provisioning a per-user self-custody wallet that is immediately usable for trade execution, without imposing the typical multi-day whitelist hold that exchanges apply to a newly added withdrawal address. Advantageously, the techniques described herein provide for:
a. The user-visible effect is a zero-wait self-custody experience that bypasses what is otherwise a hard product constraint of the underlying exchange.
b. The pool itself is an inventory of “warmed” trust relationships that get reassigned on demand. This is conceptually similar to connection-pooling but applied to trust state (whitelist+7-day hold+sub-account relationship) rather than transient resources.
c. Failure modes (pool exhausted, exchange API rate-limited, whitelist rejected) are absorbed by the replenishment cron (background process) and a deterministic promotion state machine.

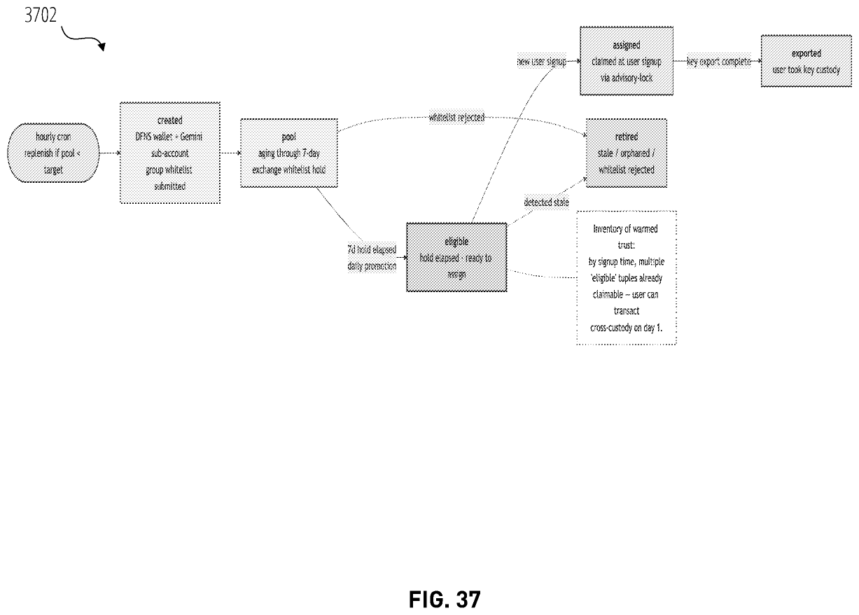

FIG. 37 illustrates an example pool-based provisioning system 3702 for assigning a self-custody wallet and associated exchange account to a user, wherein the provisioned resources are preconfigured to satisfy custody and withdrawal constraints prior to assignment.

As shown in FIG. 37, the system includes a resource pool configured to maintain a plurality of pre-created wallet-account pairs. Each pair comprises (i) a self-custody wallet and (ii) a corresponding exchange account or sub-account, which are logically associated with one another but are not initially assigned to a specific user.

In some embodiments, each wallet-account pair is configured to include a predefined trust relationship between the exchange environment and the self-custody wallet. For example, a withdrawal destination associated with the self-custody wallet may be pre-registered or whitelisted at the exchange. The whitelisting process may be subject to a delay or hold period imposed by the exchange prior to activation.

The system is further configured to manage lifecycle states for each wallet-account pair within the resource pool. In certain embodiments, the lifecycle states include at least a pool state, an eligible state, and an assigned state. A wallet-account pair in the pool state is newly created and undergoing one or more preparatory processes, such as completion of the exchange-imposed hold period associated with the whitelisting process.

Following completion of the preparatory processes, the wallet-account pair transitions from the pool state to the eligible state. In the eligible state, the wallet-account pair is available for assignment and is configured such that transactions involving the associated wallet may be executed without incurring the initial delay associated with the whitelisting process.

Upon receipt of a request to provision resources for a user, the system selects an eligible wallet-account pair from the resource pool and assigns the selected pair to the user. In some embodiments, the selection and assignment process is performed atomically using a locking mechanism to prevent concurrent allocation of the same pair to multiple users.

After assignment, the wallet-account pair transitions to an assigned state in which it is associated with the user and is used for subsequent transaction operations. Because the preparatory processes were completed prior to assignment, the assigned wallet-account pair is immediately usable for operations involving transfers between the exchange and the self-custody wallet.

The system may further include a maintenance process configured to replenish and manage the resource pool. For example, new wallet-account pairs may be created and added to the pool state, and a scheduled process may periodically transition pairs to the eligible state after satisfaction of required conditions. The maintenance process thereby ensures that a sufficient number of eligible pairs are available for assignment at any given time.

In operation, the pool-based provisioning system of FIG. 37 enables assignment of a self-custody wallet that is immediately usable for transaction execution without requiring the user to wait for completion of preparatory processes, such as exchange-imposed whitelisting delays. By decoupling wallet creation and preparation from user assignment, the system improves responsiveness of the provisioning process and enables near-immediate transaction capability upon user onboarding.

A two-stage AI advisory pipeline is provided, in which:
a. Stage 1 (L1) produces per-asset technical analyses (chart pattern, trend, support/resistance, RSI, MACD, volume, written summary).
b. Stage 2 (L2) produces portfolio-level allocation recommendations, consuming both the L1 outputs and the user's strategy-level model portfolio as anchoring inputs. The L2 output is the trade-instruction source of truth.

L2 is anchored to a model portfolio that is itself constrained to the user's policy-allowed asset universe, with multiple defense-in-depth filters that prevent the AI from emitting out-of-universe tickers or violating concentration limits.

For a given user with an active IPS v2:

In certain embodiments, for a given user with an active IPS v2:

1. the IPS pins the user to a strategy (Focus5, Spectrum, etc.) or a self-defined user strategy.

2. A ModelPortfolio object is generated for that strategy, constrained to the strategy's StrategyAllowedAsset universe. The model portfolio generation prompt explicitly enumerates the allowed tickers; a server-side filter additionally drops any AI-emitted ticker not in the universe and re-routes its allocation to cash.

3. At L2 time, the pipeline assembles an AccountContext objecgt containing:
a. The user's current holdings (aggregated by ticker across custodians, so BTC on Gemini and BTC on DFNS appear as a single position)
b. The model portfolio's target allocations
c. A live exchange price feed (so the AI cannot “imagine” prices)
d. A liquidity budget that includes the deficit-to-cash-floor

4. Adaptive concentration projects the strategy-level model portfolio onto the user's actual portfolio size: small accounts (<$250) are collapsed to 1 position; medium (<$1 k) to 2; (<$5 k) to 3; full strategy max above. Same strategy, fewer positions, with the droppedpercentages redistributed proportionally across the kept ones. (Seeapps/backend/src/ai/adaptive-concentration.ts.)

5. The L2 prompt enforces output invariants (positive numbers only, qty×price≈dollarValue, total target percentage matches available liquidity budget) and the response isvalidated against validateLiquidityConstraints before any trade instruction is created.

6. A liquidity budget guard clamps the effective budget to ≥0 so a user already below the cash floor cannot produce negative buy amounts.

Advantageously, the techniques described herein provide for:
a. A Per-asset AI analysis is that is widely available.
b. A Portfolio-level allocation recommendations that are widely available.
c. A policy-pinned strategy that constrains the allowed asset universe.
d. A per-user adaptive projection of a strategy-level model portfolio onto an account-size-aware position count that keeps the strategy's identity and philosophy intact.
e. A defense-in-depth out-of-universe filter (an AI can sometimes invent delisted tickers from its training data; the server-side filter unconditionally drops them and reallocates to cash) that is a pragmatic but improved layer for a production AI advisory pipeline that prevents or minimizes hallucinations.

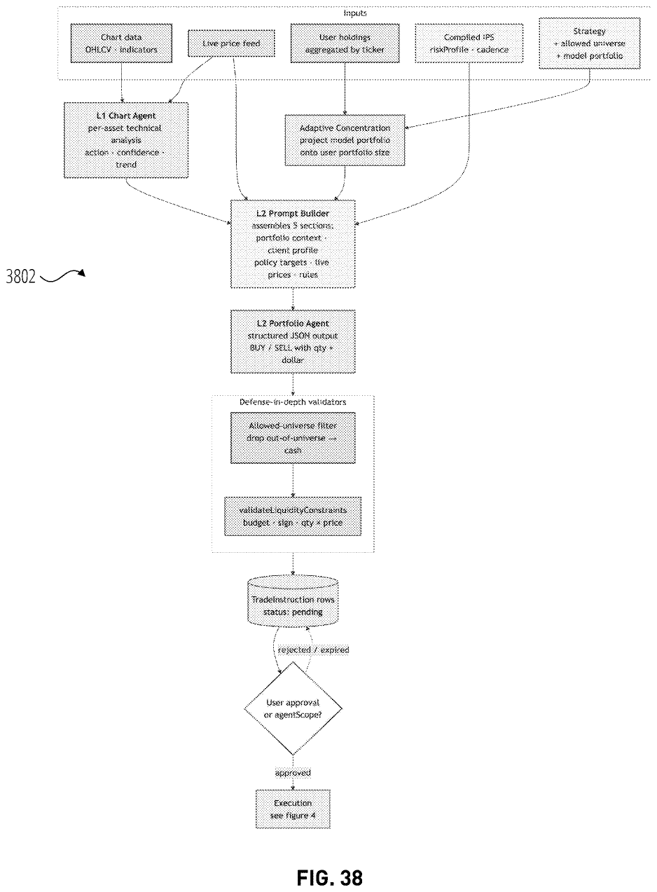

FIG. 38 illustrates an example two-stage analysis and recommendation pipeline 3802 for generating portfolio-level allocation recommendations based on asset-level analysis and policy-constrained portfolio targets.

As shown in FIG. 38, the system includes a first-stage analysis module configured to perform asset-level evaluation for a plurality of financial assets. In certain embodiments, the first-stage analysis module receives market data and generates, for each asset, a corresponding analysis output including one or more indicators of asset-specific characteristics. Such characteristics may include trend direction, confidence level, and other technical attributes derived from underlying market data. The resulting asset-level outputs are structured and stored as discrete analysis records associated with respective assets.

The outputs of the first-stage analysis module are provided to a second-stage recommendation module. The second-stage recommendation module is configured to generate portfolio-level allocation recommendations based on (i) the asset-level outputs from the first-stage module and (ii) one or more policy-derived constraints. In some embodiments, the policy-derived constraints include target allocations associated with a predefined investment strategy, which itself may be determined based on a user-specific policy object.

The system 3802 further includes a model portfolio input configured to provide a target allocation for a plurality of assets. The target allocation is constrained to a predefined set of permitted assets and may include allocation percentages and associated confidence metrics. The second-stage recommendation module uses the model portfolio input as a reference objective and generates recommendations that move an existing portfolio toward the target allocation.

In certain embodiments, the system 3802 assembles a composite input for the second-stage recommendation module that includes multiple distinct data sources. These data sources may include: (i) the current state of the user's portfolio, including asset holdings and allocation distribution; (ii) the policy-derived constraints associated with the user; (iii) the model portfolio target allocations; and (iv) current market data, including asset pricing information. The composite input is formatted into a structured representation prior to submission to the recommendation module.

The second-stage recommendation module generates a structured output that includes a set of recommended actions for one or more assets. The output may include, for each asset, an action type (e.g., buy, sell, or hold), a quantity or allocation adjustment, and a corresponding reasoning or confidence value.

The system 3802 further includes a validation pipeline configured to evaluate the structured output of the second-stage recommendation module prior to execution. In some embodiments, the validation pipeline comprises multiple sequential validation stages, each configured to enforce a distinct constraint type. Such constraints may include, for example, ensuring that recommended assets are within a permitted asset universe, verifying that allocation changes satisfy liquidity or budget conditions, enforcing consistency between quantity and associated values, and limiting the number of asset positions based on account size or other criteria.

The validation pipeline is configured such that only outputs satisfying all validation stages are converted into executable trade instructions. Outputs that fail one or more validation stages may be modified, rejected, or regenerated.

In operation, the two-stage pipeline of FIG. 38 enables generation of portfolio-level recommendations that are informed by asset-level analysis while being constrained by predefined policy parameters and validated prior to execution. By structuring the process into discrete analysis, recommendation, and validation stages, the system provides improved control over recommendation accuracy, ensures compliance with policy constraints, and reduces the likelihood of invalid or unsafe outputs from the recommendation module.

The L2 recommendation engine runs on a per-user cadence derived from the user's IPSsignalCadencePreference object, rather than a single global schedule. A user who selected static as a choice does not receive recommendations at all; a user who selected daily as a choice may; etc.

The unified-recommendations queue processor reads the user's active IPS and computes a nextEligibleAt object with the following:

| Preference | Cadence | |
|---|---|---|
| static | 90 days (effectively off) | |
| monthly_quarterly | 30 | days |
| weekly | 7 | days |
| daily | 1 | day |
| varies | 14 | days |
| (no IPS active) | 14 | days |

The processor short-circuits if now <nextEligibleAt. The cadence is therefore both a user-experience preference and a policy-enforced rate limit on advisory output.

While most advisory products either generate signals on a global cron or on-demand at the user's request, anchoring cadence to a structured policy field—and enforcing it server-side—advantageously turns “how often we bother you” into a first-class policy parameter the user agreed to.

### In-Flight Balance Reconciliation Across Custodians

The dashboard's reported portfolio value is reconciled across:
1. The exchange's reported balance (post-trade, may include unfilled cash);
2. The self-custody wallet's confirmed balance from the custody provider;
3. The self-custody wallet's mempool-pending inbound deposits, queried directly from a public block explorer.

Without (3), the user's hero number drops during the ~30-minute Bitcoin confirmation window between “exchange withdrew” and “self-custody confirmed”—funds appear to vanish.

To implement, a getPendingDfnsBalances object queries blockstream's mempool_stats.funded_txo_sum per BTC wallet, prices the result in USD using the latest BTC price from user_asset_holdings, and surfaces it as a pendingBalance field on the portfolio summary. The dashboard's hero balance is confirmed+pending; the wallet card shows “+$X pending” as a sub-line so the user can see what's in flight without losing the running total. 30-second cache to stay polite with the explorer.

A separate method (getOnChainDepositHistory) provides the historical view: it returns confirmed inbound deposits filtered to those where the user's address is in the outputs but not in any input (so we exclude change legs from our own outbound transactions). 5-minute cache.

Unified cross-source ledger and reasoning attribution

This is a single trade-history view that merges:
1. AI-generated trade executions
2. Centralized-exchange fills
3. Self-custody on-chain transfers (system-initiated)
4. External on-chain inbound deposits (user-initiated funding events)
5. Traditional brokerage transactions
. . . into a chronologically ordered, account-grouped list, with reasoning attribution: each AI or exchange fill is annotated with the L2 recommendation (and underlying L1 chart analysis) that justified it. To implement:
A getAiTradeHistory object loads multiple sources:
1. AiTradeExecution (legacy)
2. SchwabTransaction (brokerage)
3. GeminiTrade (on-exchange fills)
4. DfnsTransfer (system-initiated self-custody movements)
5. On-chain getOnChainDepositHistory results (external deposits)

Each source is mapped into a single UnifiedTrade shape with a discriminator source field.Reasoning attribution uses two layers:
1. Exact match by (userId, recommendationBatchId, ticker, action, accountNumber)—authoritative when the trade carries a batch id.
2. Heuristic match by (ticker, action) within ±14 days for crypto trades that don't carry a batch id (Gemini fills don't), picking the nearest-in-time L2 recommendation.

De-duplication: external on-chain deposits are filtered against any FROM_GEMINI DfnsTransferrows with the same txHash so a single post-trade settlement does not render twice in the ledger. Accordingly, a unified shape across heterogeneous sources plus post-hoc reasoning attribution is provided. Most trade-history views then can either show a single source (the exchange's own ledger) or multiple sources without attribution (so the user sees a fill but never sees why). Connecting the L1/L2 reasoning to a fill that occurred days later, on a different system, via a heuristic time/ticker/action match that doesn't require shared identifiers, is an advantageous step of the techniques described herein.

Guided Migration with Bifurcated Consent

### What it is

In certain embodiments, the system implements a guided migration process configured to transition a user's assets from a custodian-mediated environment to a self-custody environment under policy-governed control. The migration process includes a bifurcated consent framework comprising multiple user-interaction stages designed to capture both informational understanding and explicit acknowledgment of associated responsibilities.

More specifically, the migration flow is structured to separate (i) an informational stage, in which the system presents educational content describing characteristics of self-custody, and (ii) an acknowledgment stage, in which the user explicitly affirms acceptance of the associated risks and responsibilities. In this manner, the system ensures that user consent is collected through discrete, logically separated events rather than a single aggregated interaction.

In addition to the consent stages, the migration process further includes a staged asset transfer plan comprising a plurality of asset-specific operations. The system generates a structured representation of the migration plan, where each asset to be migrated is represented as an individual migration unit including parameters such as source asset, destination asset, execution steps, and associated transaction identifiers.

An administrative or supervisory interface may be configured to present the staged migration plan for review prior to execution, thereby enabling verification of the planned operations across all assets subject to migration.

### How it Works

In operation, the migration process is implemented as a multi-stage workflow executed by a migration controller. The workflow includes the following components:

### Informational Stage (Pre-Acknowledgment):

The system presents information to the user describing one or more aspects of self-custody, including management of cryptographic keys, risk of asset loss, and recovery considerations. This stage is configured to convey relevant operational and security implications prior to any user commitment.

### Acknowledgment Stage (Attestation):

Following presentation of the informational content, the system requires the user to provide an explicit acknowledgment indicating acceptance of the described conditions. The acknowledgment is recorded as a discrete event and is separate from the informational stage to ensure that acknowledgment is not implicit. [advisor cr . . . background |Word]

### Migration Plan Generation:

The system generates a structured, asset-by-asset migration plan. Each asset is represented by a corresponding migration record that includes attributes such as:
1. source and destination asset identifiers,
2. custody environment(s),
3. required transformation steps (e.g., sell, buy, transfer), and
4. references to transaction identifiers or execution instructions.

### Staged Execution via Per-Asset Lifecycle:

Each migration record progresses through a lifecycle managed as a state-driven process. The lifecycle may include stages such as initiation, execution, confirmation, and completion, and is independently tracked for each asset. This enables partial completion of the migration process without requiring all assets to succeed simultaneously. [advisor cr . . . background |Word]

### Reconciliation and Error Handling:

A reconciliation module monitors the status of each asset-level migration record and updates the corresponding state based on execution outcomes. In the event of failure or partial success, the system records the failure state at the asset level rather than at the aggregate migration level, thereby enabling granular recovery and retry operations. [advisor cr . . . background |Word]

### Technical Effects

The architecture described herein provides a structured mechanism for combining user-consent capture with asset migration execution in a unified system. The bifurcated consent framework ensures that informational presentation and acknowledgment actions are independently captured, providing a verifiable separation between user awareness and user authorization.

Additionally, the use of a staged, per-asset migration plan introduces a granular control structure that enables the system to:
track migration progress at the level of individual assets,
isolate failure modes to specific assets rather than entire migration operations, and
provide deterministic reconciliation of migration outcomes.

This design improves reliability and auditability of the migration process by ensuring that each stage—consent, planning, execution, and reconciliation—is explicitly represented and independently verifiable within the system.

### Agentic Permission Scoping

### What it is

In certain embodiments, the system includes a policy-driven framework for defining and enforcing permissions associated with non-human actors operating within a financial management environment. These non-human actors may include, for example, automated agents, artificial intelligence systems, or other computational entities configured to generate recommendations or perform actions on behalf of a user.

The system encodes such permissions within a structured policy object, such as an investment policy statement, that includes fields specifically configured to govern permitted actions of such agents. These fields define, in a machine-readable manner, the scope of authority granted to an agent, conditions under which actions must be approved, and thresholds beyond which additional authorization is required.

In this manner, the system provides a formalized representation of “what an agent may do” that is distinct from, and independent of, the internal logic or behavior of the agent itself. The permissions are therefore externally defined, policy-driven constraints that govern agent behavior within the system.

### How it Works

In operation, the system defines a plurality of policy parameters that collectively determine the permissible scope of agent actions. These parameters may include, for example:
1. an agent authority scope parameter specifying the categories of actions an agent is permitted to perform, such as viewing data, generating suggestions, or executing transactions within defined bounds;
2. an approval-required parameter identifying one or more types of actions that require explicit user authorization prior to execution;
3. a transaction value threshold parameter specifying a quantitative limit above which actions must be approved before execution; and
4. a system permission parameter governing actions initiated by internal system components or automated workflows.

These parameters are stored within the structured policy object and are enforced at one or more stages of the system workflow, including recommendation generation and execution.

When an agent generates a proposed action, such as a trade instruction or portfolio adjustment, the system evaluates the proposed action against the policy parameters. The evaluation includes determining whether the proposed action falls within the agent authority scope, whether the action type is subject to approval requirements, and whether the quantitative characteristics of the action exceed the specified threshold. [advisor cr . . . background |Word]

If the proposed action satisfies all applicable policy constraints, the system may permit automatic execution of the action without further intervention. If one or more constraints are not satisfied, the system generates a pending instruction requiring explicit user approval prior to execution. In such cases, the system does not execute the action until the required approval is received.

The enforcement of these policy parameters occurs consistently across different system stages, such that the same policy governs both recommendation outputs and execution behavior. As a result, an agent's output does not directly cause an action; rather, the output is first evaluated within the context of the defined policy constraints.

### Technical Effects

The architecture described herein introduces a machine-readable permission model for agent-based systems that separates agent behavior from execution authority. By encoding permissions within a structured policy object and enforcing those permissions at runtime, the system ensures that agents operate within explicitly defined boundaries that are externally verifiable and consistently applied.

This approach enables the system to:
1. provide deterministic enforcement of agent permissions independent of agent implementation,
2. support safe delegation of limited authority to automated systems,
3. require conditional user authorization for actions exceeding predefined constraints, and
4. maintain auditability of agent actions and corresponding approval states.

The result is a governance framework in which automated agents are permitted to propose or execute actions only within the scope explicitly granted by the user, thereby enabling controlled interaction between autonomous systems and regulated financial operations.

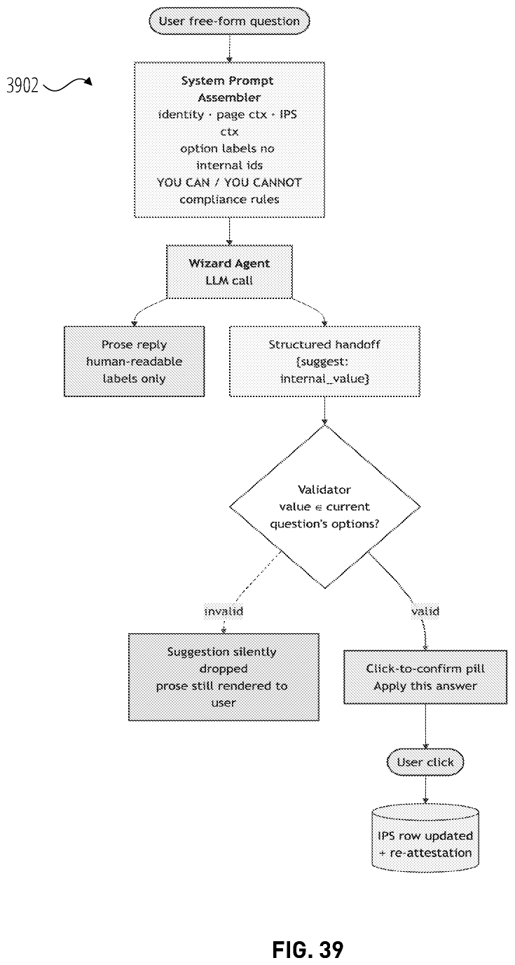

FIG. 39 illustrates an example interaction and processing flow for converting a natural-language agent output into a validated and user-confirmed structured action within a policy-governed system.

As shown in FIG. 39, the system includes an agent interface configured to generate a response to a user input expressed in natural language. In certain embodiments, the agent interface produces a composite output comprising (i) a human-readable explanatory portion and (ii) a structured data segment representing a proposed action or selection.

The structured data segment is formatted in a machine-readable representation and encodes a proposed value corresponding to a predefined set of permissible options associated with a current system context. The structured data segment is appended to, but logically distinct from, the human-readable portion of the response, thereby enabling independent downstream processing.

A validation component is configured to receive the structured data segment and to evaluate whether the proposed value corresponds to a valid option within the currently active set of allowable values. The validation component performs this evaluation by comparing the proposed value against a context-specific enumeration or schema defining permissible selections for the active interaction state.

If the proposed value is determined to be valid, the system generates a user interface element configured to present the proposed action for explicit user confirmation. For example, the system may render a selectable control corresponding to the proposed value, allowing the user to approve or reject the suggested selection. If the proposed value is not valid, the structured data segment is disregarded, and no corresponding action is generated within the user interface.

The system enforces a constraint that the agent interface is not permitted to directly modify system state. Instead, any modification to system data structures occurs only after successful validation of the structured data segment and, in certain embodiments, after receipt of explicit user confirmation.

Upon user confirmation of a validated proposed value, the system updates a corresponding data record within a persistent data store. For example, the system may update a structured policy object or other data structure to reflect the selected value. This update is performed through a deterministic system-controlled operation rather than through direct agent action.

In certain embodiments, the processing flow illustrated in FIG. 6 is reusable across multiple system layers, including user input workflows and automated recommendation pipelines. In each case, the agent produces a structured proposal, the system validates the proposal against predefined constraints, and the final action is executed only upon satisfaction of validation and authorization conditions.

In operation, the architecture of FIG. 39 provides a conversion mechanism from unstructured, natural-language outputs to discrete, policy-compliant system actions. By separating agent-generated proposals from system-executed state changes and introducing a validation and confirmation step, the system ensures that agent interactions remain constrained within defined operational boundaries and that all state modifications are controlled, auditable, and deterministic.

According, FIG. 39 illustrates a Wizard agent handoff. The agent emits prose (with human-readable labels only) and a structured JSON suggestion. The validator checks the suggestion against the live option set for the active question. Only after a user click does the IPS row update the agent never has direct write authority. The same pattern recurs at the L2 trade pipeline.

Model Specialization without Fine-Tuning

### What it is

In certain embodiments, the system implements a mechanism for achieving domain-specific behavior from one or more general-purpose machine learning models without performing model fine-tuning or modification of model parameters. Instead, specialization is achieved through a layered orchestration architecture that controls inputs, outputs, and execution context associated with each model invocation.

More specifically, a general-purpose inference model is treated as a replaceable computational component, while domain-specific behavior is derived from a surrounding system that provides structured inputs, applies deterministic policy constraints, and enforces output validation. The resulting system produces specialized outputs corresponding to a defined application domain, such as policy-governed financial decision-making, without requiring retraining or fine-tuning of the underlying model.

In this manner, the system separates model capability from application-specific behavior, allowing the model to function as a generic inference engine while specialization is implemented externally.

### How it Works

The system achieves specialization through coordinated operation of multiple system components surrounding the model. In certain embodiments, the process includes:

### Deterministic Policy Compilation:

A structured policy object is generated from user inputs, representing constraints, preferences, and operational parameters. This policy object is deterministically generated and is included as a structured input to each inference call.

### Programmatic Prompt Assembly:

For each inference invocation, the system constructs a composite input using a plurality of predefined components. These components may include:
1. policy-derived constraints,
2. current system state,
3. permissible action domains or asset universes, and
4. applicable compliance rules or operational constraints.

The composite input is assembled according to a predefined structure that ensures consistent formatting across invocations.

### Multi-Layer Output Validation:

Outputs generated by the model are processed through one or more validation stages configured to enforce system constraints. Validation stages may include filtering outputs to permitted domains, verifying numerical consistency, enforcing budget or resource constraints, and ensuring compliance with policy parameters.

### Structured Action Gating:

Any output corresponding to a potential system action is converted into a structured representation that is independently validated and, where applicable, subject to user approval or policy-based authorization prior to execution.

In operation, these components collectively define the effective behavior of the model without altering its internal structure or training.

Model Specialization without Fine-Tuning—Orthogonal Input Sources

In certain embodiments, each inference request is constructed from multiple distinct categories of input data, each representing a different aspect of system context. These input categories are assembled deterministically prior to model invocation and may include:
1. a compiled policy object providing user-specific constraints and preferences;
2. a strategy or ruleset repository defining permissible actions and domain-specific boundaries;
3. a representation of current system state, such as current holdings or resource allocations; and
4. live or recently updated external data relevant to the decision context.

The system restricts model access to only the assembled input, preventing the model from independently retrieving or inferring external data outside the defined input structure.

Model Specialization without Fine-Tuning—Specialization Mechanisms

In some embodiments, the system implements additional mechanisms to further constrain and shape model outputs, including:
1. policy-derived constraint injection, wherein numerical limits or thresholds derived from the policy object are represented within the model input in a structured form;
2. domain-restricted input spaces, wherein permissible outputs are limited to enumerated or specified domains provided in the input;
3. authoritative data injection, wherein externally validated data values are provided as the exclusive source of truth for quantitative computations;
4. output invariants, wherein the output format is constrained such that specific structural or numerical conditions must be satisfied; and
5. post-processing enforcement, wherein outputs that do not satisfy required constraints are modified, discarded, or regenerated prior to further processing.

These mechanisms operate collectively to constrain the model's output space to a subset of domain-compliant results.

Model Specialization without Fine-Tuning—Operational characteristics

The described architecture provides several operational characteristics:
1. model-agnostic implementation, allowing substitution of different underlying models without modification to the surrounding system;
2. deterministic input construction, ensuring that identical inputs yield consistent behavior across model invocations;
3. separation of inference and control, such that domain constraints are enforced outside the model; and
4. incremental extensibility, enabling addition of new constraints or input components without retraining the model.

### Technical Effects

The system enables domain-specific specialization of general-purpose models through orchestration rather than through training-based approaches. By relocating domain logic, constraints, and validation mechanisms outside the model, the system achieves:
1. improved transparency, as each component of the orchestration pipeline is explicitly defined and inspectable;
2. reduced dependency on model-specific behavior or training artifacts;
3. enhanced auditability, as inputs and outputs are structured and logged; and
4. improved adaptability, as updates to policy or constraints can be implemented without retraining or redeploying the model.

This architecture provides a technically distinct alternative to fine-tuning approaches, in which domain specialization is embedded within model parameters and may not be directly observable or controllable.

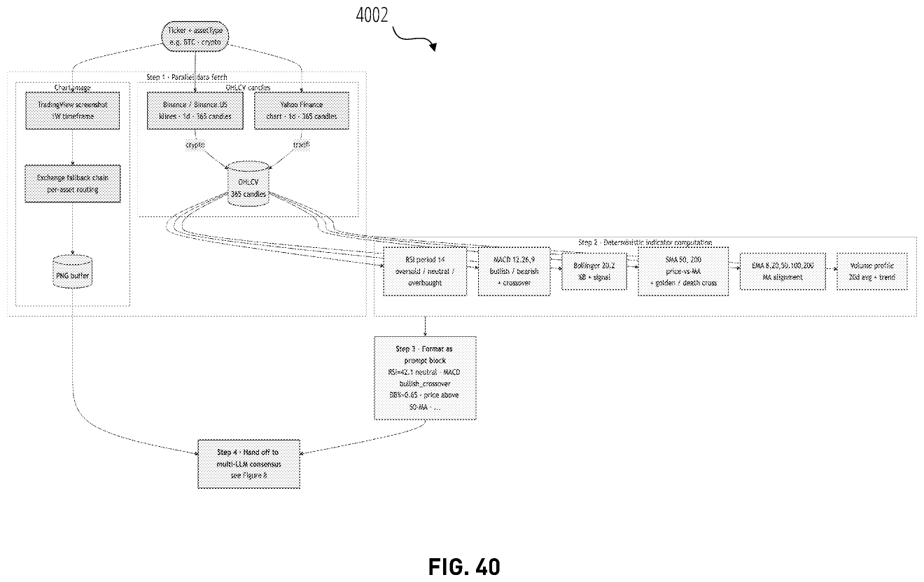

FIG. 40 illustrates an example data ingestion and preprocessing architecture 4002 for generating structured technical-analysis inputs provided to downstream analytical components within an automated financial analysis system.

As shown in FIG. 40, the system includes a data acquisition module configured to retrieve market data corresponding to one or more financial assets from one or more external data sources. In certain embodiments, the data acquisition module obtains open-high-low-close-volume (OHLCV) data representing historical price and volume information over a predefined time interval.

The retrieved OHLCV data is provided to an indicator computation module configured to generate a plurality of technical indicators based on the historical data. The indicator computation module applies one or more predefined mathematical functions to the OHLCV data to compute numerical values corresponding to multiple technical signals. In some embodiments, the computed indicators include, but are not limited to:
a relative strength index (RSI) computed over a predefined period and classified into categorical states such as oversold, neutral, or overbought;
a moving average convergence divergence (MACD) indicator computed using predefined parameters, including generation of a signal line, histogram, and associated classification states such as bullish or bearish conditions;
Bollinger Bands computed using a predefined period and deviation parameter, yielding upper, middle, and lower bounds and associated classification states;
simple moving averages (SMA) over multiple time horizons, including derived signals such as price relative to moving average thresholds and detection of crossover events;
exponential moving averages (EMA) over multiple time intervals, including derived alignment classifications indicative of trend conditions; and
volume-based indicators, including average volume and associated trend classifications.

The indicator computation module is configured to operate deterministically such that identical OHLCV inputs produce identical indicator outputs. In certain embodiments, the computed indicators are cached in a memory structure and reused across multiple downstream processes to ensure consistency across analyses performed within the same evaluation cycle.

The system further includes a formatting module configured to convert the computed indicator values into a structured representation suitable for downstream processing. In some embodiments, the formatting module generates a text-based representation comprising the numerical indicator values and corresponding categorical interpretations, arranged in a predefined format that is compatible with downstream analytical components.

In addition, the system generates or retrieves a graphical representation of asset price behavior, such as a chart image derived from the OHLCV data. The graphical representation is provided in conjunction with the structured indicator representation to a downstream analysis stage.

In certain embodiments, the structured indicator representation and the graphical representation are supplied as inputs to one or more computational analysis modules, such as machine learning or inference engines. Because the indicator values are precomputed and provided explicitly, the downstream module need not independently derive such indicators, thereby constraining analysis to a consistent and reproducible input set.

In operation, the architecture of FIG. 7 separates the computation of technical indicators from downstream analytical inference by performing deterministic preprocessing of market data and converting the resulting indicators into a structured format. This separation enables consistent, auditable, and reproducible analytical outputs by ensuring that all downstream components operate on the same predefined indicator set rather than independently deriving such values.

### Structured Prompt Construction and Constraint Injection

### Overview

In certain embodiments, the system implements a structured prompt-construction framework for interfacing between deterministic system components and one or more machine learning inference engines. The framework provides a mechanism by which domain-specific constraints, policy-derived parameters, and system state are programmatically assembled into model inputs, thereby controlling the behavior of the inference engine without modifying the model itself.

This appendix describes representative embodiments of such prompt structures and associated construction mechanisms. The described structures illustrate how multiple independent system inputs are combined into a single, constrained inference request.

Structured Prompt Construction and Constraint Injection—Deterministic Constraint Generation from Policy

In certain embodiments, the system includes a deterministic constraint-generation module configured to convert policy-derived parameters into structured textual constraint blocks for inclusion in a model input.

For example, a user-specific risk profile classification may be deterministically mapped to a corresponding constraint set. The constraint set may include:
1. maximum allowable position sizes,
2. minimum reserve thresholds,
3. permitted levels of risk tolerance, and
4. corresponding explanatory descriptors associated with each classification tier.

The system selects a single applicable constraint block based on the user's compiled policy and injects the selected block into the model input. In this manner, the inference engine receives only the constraints relevant to the user, rather than a full set of possible constraints.

This approach ensures that constraint selection occurs deterministically at prompt-construction time, thereby eliminating the need for the model to infer or select among multiple policy options at inference time.

### Structured Prompt Construction and Constraint Injection—Domain-Restricted Prompt Sections

In certain embodiments, the prompt-construction framework defines domain-restricted sections that explicitly enumerate permissible entities for model output.

For example, a model portfolio generation prompt may include a section specifying an allowed universe of assets. The allowed universe is constructed programmatically from a system-maintained registry of permitted entities and is embedded directly in the model input as a hard constraint.

The system further instructs the inference engine, via the structured prompt, to limit outputs exclusively to the enumerated set. In some embodiments, the prompt includes explicit instructions prohibiting selection of entities outside the allowed set.

This domain-restriction mechanism is complemented by post-processing validation stages that enforce the same constraint at the system level, thereby providing multiple layers of enforcement.

### Structured Prompt Construction and Constraint Injection—Multi-Source Input Assembly

In certain embodiments, each model input is constructed from a plurality of distinct and orthogonal data sources. The input assembly process aggregates these sources into a structured prompt comprising multiple sections, each reflecting a different aspect of system state.

The input sources may include:
1. a compiled policy object representing user-specific constraints,
2. a strategy or model definition providing target allocations and permitted domains,
3. a current-state representation including portfolio positions and allocations, and
4. externally sourced or real-time data, such as asset prices or signals.

Each source is processed by a corresponding assembly function and incorporated into the prompt according to a predefined structure. The system ensures that the inference engine receives the assembled representation as a single input and does not access underlying data directly.

This structured aggregation provides a controlled interface between system state and inference behavior.

### Structured Prompt Construction and Constraint Injection—Authoritative Data Injection and Invariants

In certain embodiments, the system designates specific data elements within the prompt as authoritative sources for quantitative calculations. For example, a prompt may include a section specifying current asset prices, with explicit instructions that such values are to be treated as the exclusive source for numerical computations.

The prompt may further define output invariants that must be satisfied by any generated result. Such invariants may include:
1. consistency relationships between numerical fields,
2. constraints on sign or value ranges, and
3. formatting requirements for structured outputs.

These invariants are communicated to the inference engine through structured instructions within the prompt and are subsequently enforced by system-level validation components.

### Structured Prompt Construction and Constraint Injection—Liquidity and Resource Constraint Embedding

In certain embodiments, the prompt-construction framework encodes resource constraints, such as liquidity budgets or allocation limits, directly within the prompt as both computational rules and explanatory text.

For example, a liquidity constraint may be expressed as a formula describing how available resources are calculated based on current system state and proposed actions. The prompt may further include descriptive guidance explaining how the constraint is to be applied.

A corresponding validation module independently verifies compliance with the same constraint after inference, thereby implementing a dual-layer approach in which:
the prompt encourages constraint compliance, and
the validator enforces constraint compliance.

### Structured Prompt Construction and Constraint Injection—Structured Output Contracts

In certain embodiments, the system defines strict output schemas that govern the format and semantics of model responses. These schemas specify required fields, permissible values, and relationships between fields.

The prompt includes explicit instructions requiring the inference engine to return responses in a predefined structured format. For example, outputs may be required to include fields such as action type, quantity, numerical value, and explanatory reasoning, each subject to defined constraints.

The system enforces compliance with the output schema through validation and parsing components, ensuring that only outputs satisfying the schema are accepted for further processing.

### Structured Prompt Construction and Constraint Injection—Defense-In-Depth Validation

In certain embodiments, the system implements a layered validation architecture to ensure that outputs from the inference engine conform to all applicable constraints.

Even when constraints are specified within the prompt, the system performs independent validation of outputs to detect and correct deviations. For example:
outputs containing values outside a permitted domain may be filtered or adjusted,
numerical inconsistencies may trigger rejection or regeneration of outputs, and
invalid structured responses may be discarded. [advisor cr . . . background |Word]

This defense-in-depth approach acknowledges the non-deterministic nature of inference engines and ensures reliable system operation through redundant enforcement mechanisms.

### Structured Prompt Construction and Constraint Injection—Natural-Language to Structured-Action Adaptation

In certain embodiments, the prompt framework supports conversion of natural-language interactions into structured representations suitable for deterministic processing. An agent may interpret user input and produce both an explanatory response and a structured output corresponding to one of a predefined set of permissible actions.

The structured output is subsequently validated and, where appropriate, presented for user confirmation prior to execution. This mechanism provides a bridge between unstructured user input and structured system operations.

### Technical Effects

The structured prompt-construction framework described herein provides a mechanism for constraining the behavior of general-purpose inference engines through deterministic input assembly, explicit constraint encoding, and layered output validation.

This architecture enables:
1. externalization of domain logic and constraints from the inference engine,
2. consistent and reproducible model behavior across identical inputs,
3. enforcement of policy-driven constraints without model modification, and
4. integration of natural-language interfaces with deterministic system control mechanisms.

Accordingly, the system achieves domain-specific specialization of inference behavior through orchestration of inputs and outputs, rather than through alteration of model parameters or training data.

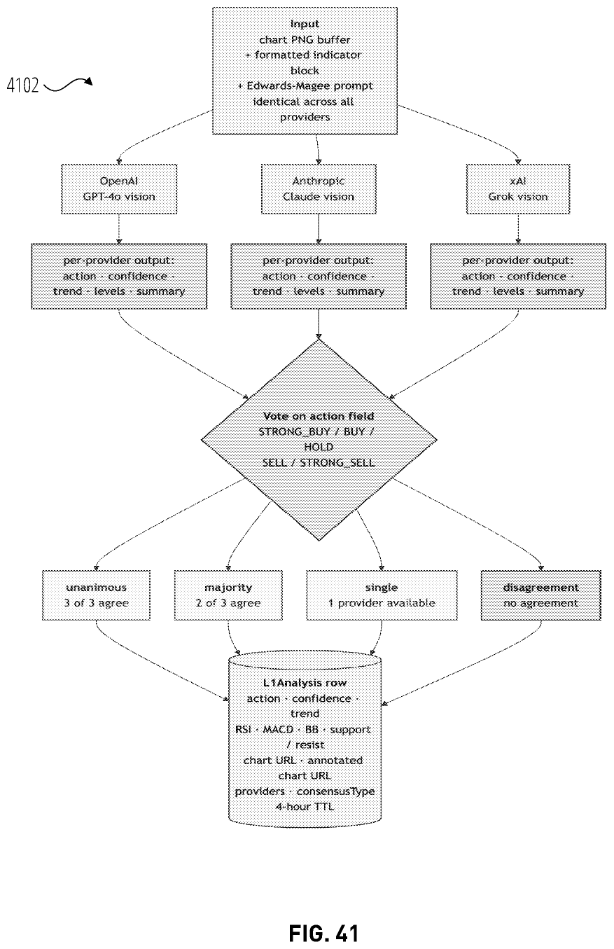

FIG. 41 illustrates an example multi-model consensus architecture for generating an asset-level analytical output based on inputs provided to a plurality of independent inference engines.

As shown in FIG. 41, the system includes an input preparation module configured to generate a composite input corresponding to a financial asset. In certain embodiments, the composite input includes a graphical representation of asset data, such as a chart image, and a structured data representation including precomputed indicator values or other analytical features derived from underlying market data.

The composite input is provided in parallel to a plurality of inference engines, each inference engine corresponding to a distinct machine learning model or provider. In some embodiments, the plurality of inference engines comprises a set of independently trained models configured to analyze the same input and generate corresponding outputs.

Each inference engine generates an analysis output including one or more fields representing an assessment of the asset. Such fields may include, for example, a directional action classification (e.g., buy, sell, or hold), a confidence value, and supporting attributes associated with the analysis.

The outputs generated by the plurality of inference engines are provided to an aggregation module configured to compute a consensus result. In some embodiments, the aggregation module performs a voting operation over one or more selected output fields, such as the action classification field, to determine a consensus outcome. The voting operation may involve identifying agreement among outputs and selecting a consensus value based on predefined criteria.

The aggregation module further classifies the consensus result according to a consensus type. For example, the consensus type may indicate whether all inference engines produced the same output (unanimous), a majority subset produced the same output (majority), a single model produced a distinct output (single), or outputs are divergent without agreement (disagreement).

The system stores the consensus result and associated metadata, including per-model outputs and consensus classification, within a structured data record corresponding to the asset analysis. The stored record may be utilized by downstream system components, including higher-level recommendation modules, to inform subsequent decision-making processes.

In certain embodiments, the system caches the analysis record for a predefined duration, enabling reuse of the computed consensus result across multiple downstream operations without repeated invocation of the inference engines.

In operation, the architecture of FIG. 41 enables generation of analysis outputs based on a consensus across multiple independent inference engines, thereby reducing reliance on a single model and mitigating the effects of model-specific variability. By applying a voting-based aggregation and classification process, the system produces an output that reflects agreement levels among models and provides additional metadata for downstream interpretation of confidence and reliability.

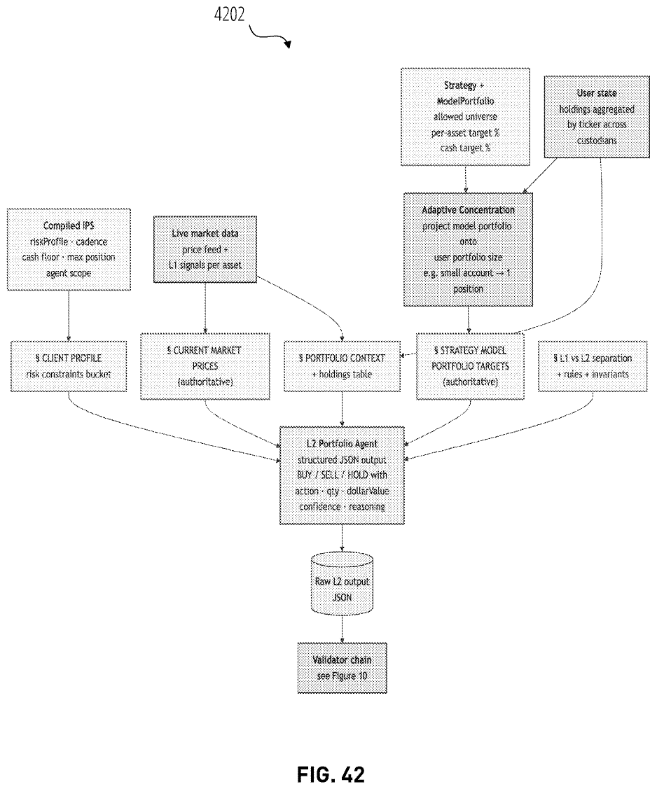

FIG. 42 illustrates an example architecture for assembling a structured input for a portfolio-level recommendation module, wherein multiple independent data sources are combined into a unified prompt provided to a computational inference engine.

As shown in FIG. 42, the system includes an input assembly module configured to construct a composite input from a plurality of distinct data sources. In certain embodiments, the composite input is structured as a multi-section representation, where each section corresponds to a different category of system data relevant to portfolio evaluation.

In at least one embodiment, the input assembly module receives data from four primary sources, including:
1. a policy-derived input representing constraints and preferences associated with a user-specific policy object;
2. a strategy and model portfolio input representing target allocation values and permitted asset universes;
3. a current-state input representing the user's existing portfolio, including holdings and allocation percentages; and
4. a market data input representing current asset pricing or other external data relevant to valuation and allocation.

Each input source is processed and transformed into a structured representation prior to inclusion in the composite input. The system ensures that each component is incorporated according to a predefined ordering and formatting schema, thereby producing a consistent input structure for each inference call.

The composite input includes multiple sections corresponding to different functional roles within the recommendation process. In some embodiments, these sections include:
1. a portfolio context section describing current holdings, asset quantities, and allocation percentages;
2. a client profile section including policy-derived constraints such as risk thresholds, liquidity requirements, and allocation limits;
3. a strategy target section specifying model portfolio targets and desired allocation percentages;
4. a market data section specifying authoritative price values for each asset; and
5. a rule and constraint section specifying operational rules, including relationships between variables and constraints governing valid outputs.

The system designates certain sections of the composite input as authoritative. For example, the strategy target section is treated as a reference objective toward which portfolio adjustments are to be directed, while the market data section provides authoritative values for numerical calculations. The system further encodes explicit instructions indicating that the inference engine is to rely exclusively on these designated sections for corresponding computations.

The input assembly module is configured to construct the composite input deterministically such that identical source data produces an identical structured input. This ensures that variations in output are attributable to the inference engine rather than inconsistencies in input construction.

The composite input is then provided to a recommendation module, such as a machine learning inference engine, which generates a structured output representing portfolio-level recommendations. Because the input is pre-assembled from multiple constrained sources, the inference engine operates within a controlled context that limits the scope of possible outputs to those consistent with the assembled data.

In operation, the architecture illustrated in FIG. 42 provides a mechanism for combining policy constraints, strategy definitions, system state, and external data into a unified representation that governs recommendation generation. By structuring and constraining the input in this manner, the system reduces variability in model behavior, improves consistency of outputs, and enables deterministic integration with downstream validation and execution components.

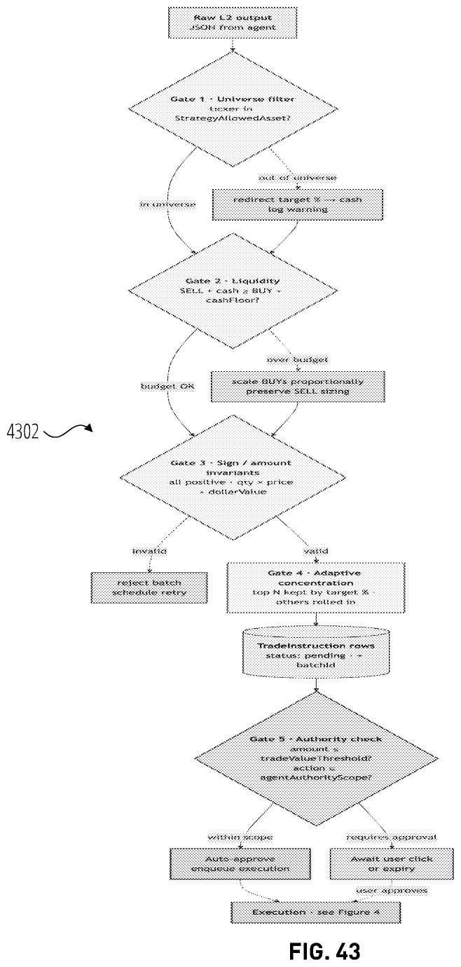

FIG. 43 illustrates an example validation pipeline architecture for processing and transforming outputs generated by a recommendation module into policy-compliant and executable instructions.

As shown in FIG. 43, the system includes a validation pipeline comprising a plurality of sequential validation stages, each configured to detect and correct a specific class of deficiencies in an input generated by an upstream module, such as a machine learning inference engine. The input to the validation pipeline is a structured representation of proposed actions, including, for example, asset allocations, trade instructions, or other portfolio adjustment parameters.

The validation pipeline operates as a multi-stage processing chain in which outputs from a prior stage are provided as inputs to a subsequent stage. In certain embodiments, the validation pipeline includes at least the following stages:

### Domain Enforcement Stage (Universe Filter):

A first validation stage evaluates whether entities referenced in the proposed actions are members of a permitted domain. For example, the system determines whether specified assets are included within a predefined set of allowable assets. Any elements that do not satisfy the domain constraint are removed or modified, and associated quantities or allocations may be reassigned according to system rules.

### Resource and Budget Validation Stage (Liquidity Constraints):

A subsequent stage evaluates whether the proposed actions satisfy resource availability constraints. In certain embodiments, the system verifies that proposed allocation increases or purchasing actions do not exceed available resources when accounting for existing holdings, planned reductions, and predefined reserve requirements. Where violations are detected, the system adjusts proposed actions to conform to the constraints or rejects the input for regeneration.

### Numerical Consistency and Invariant Enforcement Stage:

A further stage verifies that numerical values contained within the proposed actions satisfy predefined invariants. Such invariants may include relationships between quantities and corresponding values, consistency among allocation percentages, and constraints on permissible value ranges. If numerical inconsistencies are detected, the system may reject the input or trigger a regeneration process.

### Adaptive Constraint Stage (Position or Complexity Limits):

Another stage enforces system-defined structural constraints, such as limits on the number of positions within a portfolio or constraints based on account size. In certain embodiments, the system reduces the number of positions by selecting a subset of items according to predefined selection criteria and redistributes associated values across the retained items.

Following completion of the validation stages, the system produces a validated output representing compliant actions suitable for conversion into executable instructions. The validated output is then provided to an execution preparation module, which converts the output into one or more instruction records.

In certain embodiments, the system further applies an authority-checking stage subsequent to validation, in which it evaluates whether execution of each instruction is permissible based on policy-derived authorization parameters. Such parameters may include thresholds, approval requirements, or agent authority constraints. If an instruction exceeds the permitted scope, it is held in a pending state awaiting authorization; otherwise, it is forwarded for execution.

The validation pipeline is designed to operate deterministically, such that identical inputs result in identical outputs after processing through the stages. Additionally, each stage is configured to address a distinct class of potential errors, thereby collectively ensuring that the final output satisfies all applicable system constraints.

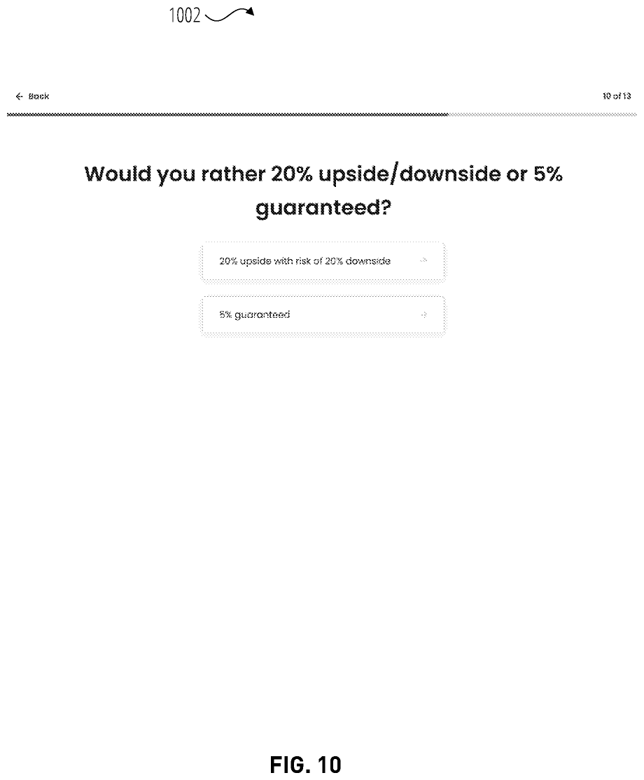

In operation, the architecture of FIG. 10 enables transformation of outputs generated by a non-deterministic inference process into structured, policy-compliant instructions that may be executed within a controlled environment. By applying multiple validation stages in sequence, the system ensures that domain constraints, resource constraints, numerical integrity, and structural limits are all satisfied prior to execution.

### Example Implementation Website Screenshots

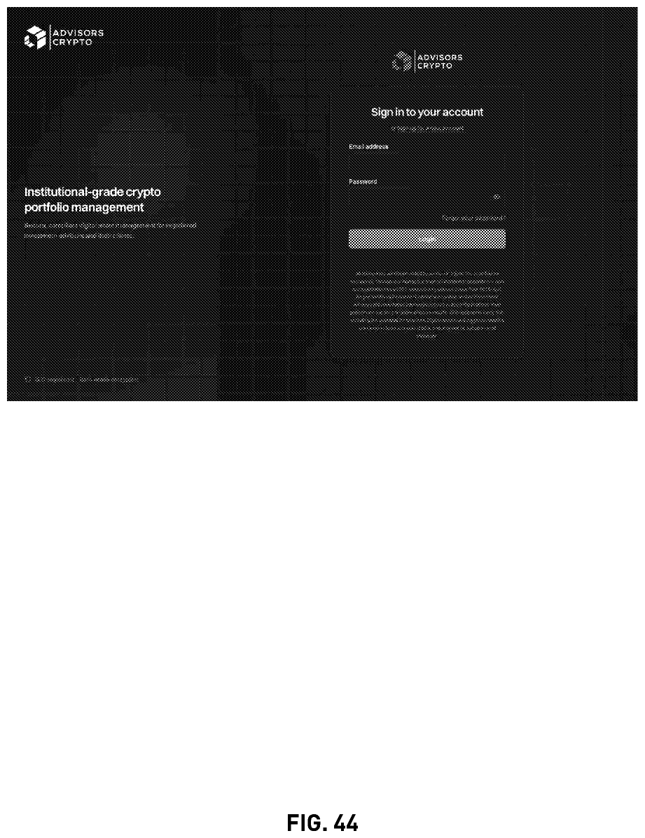

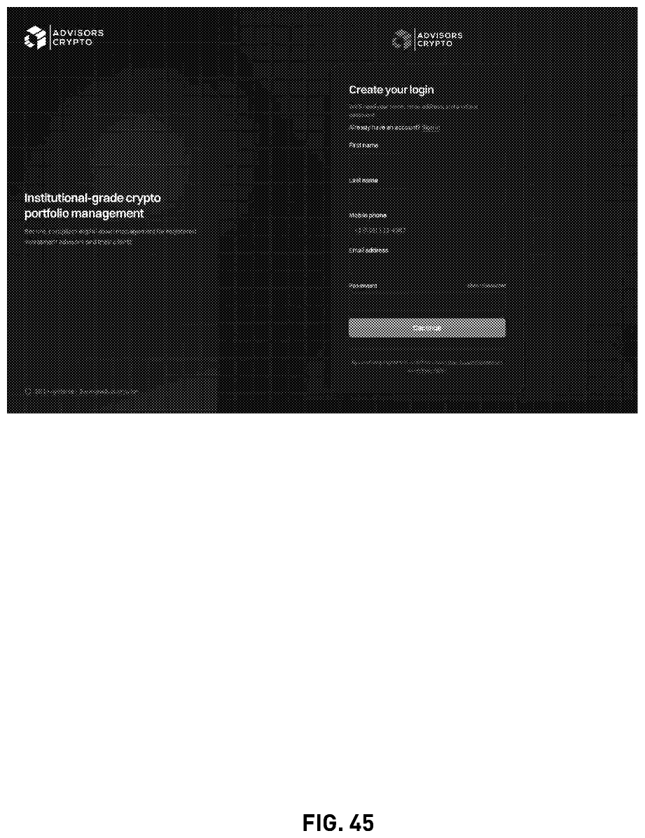

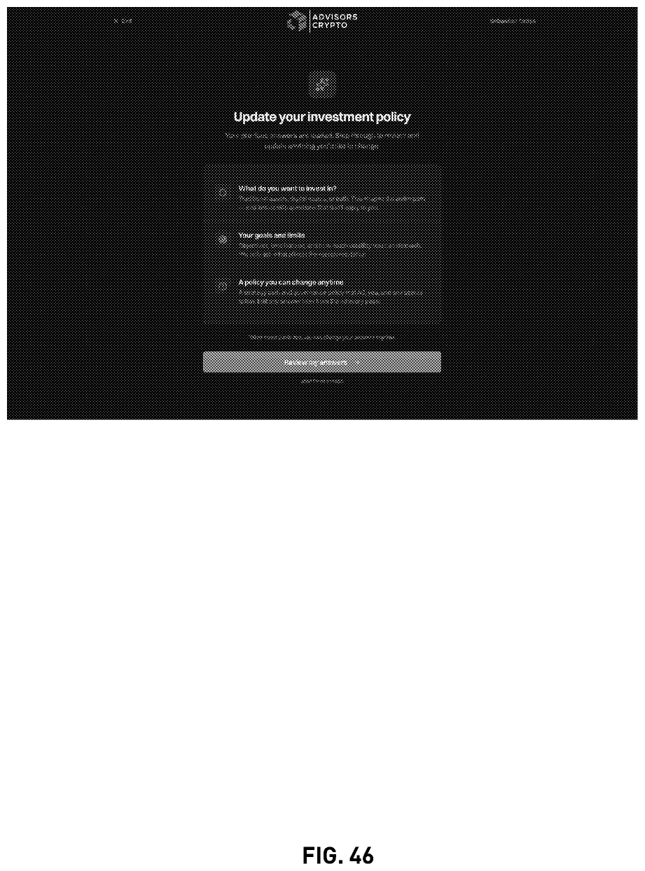

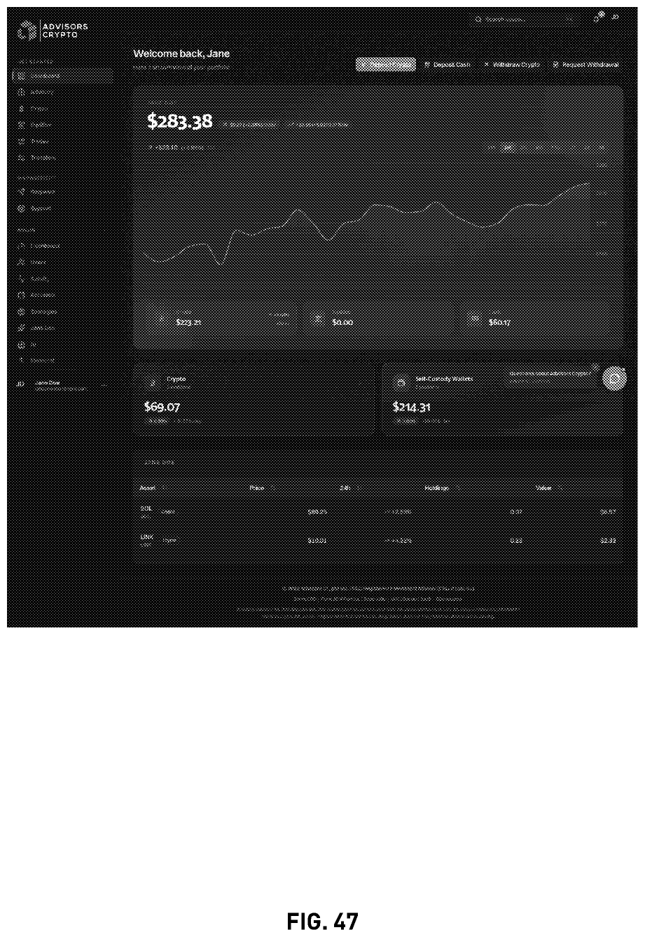

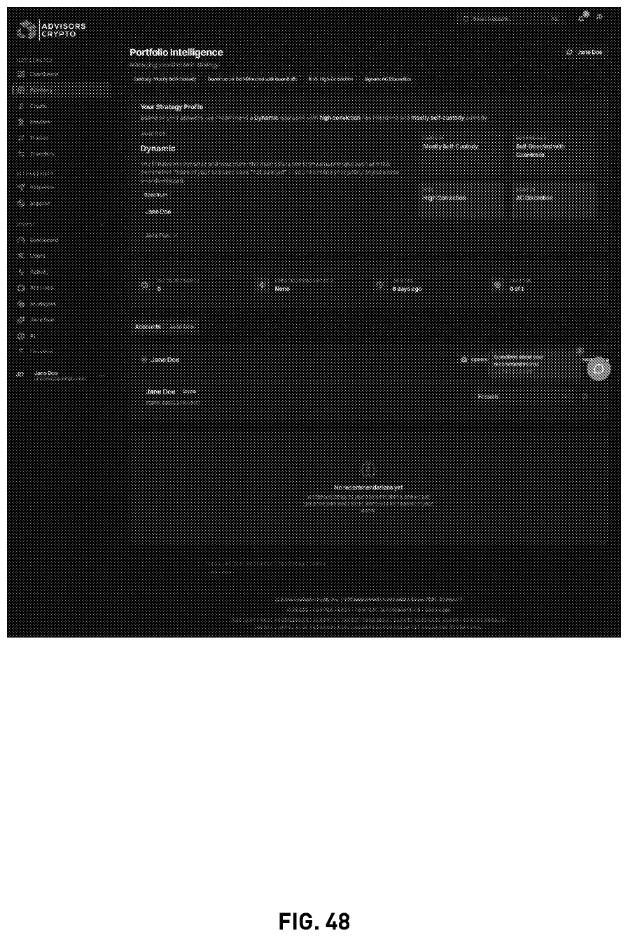

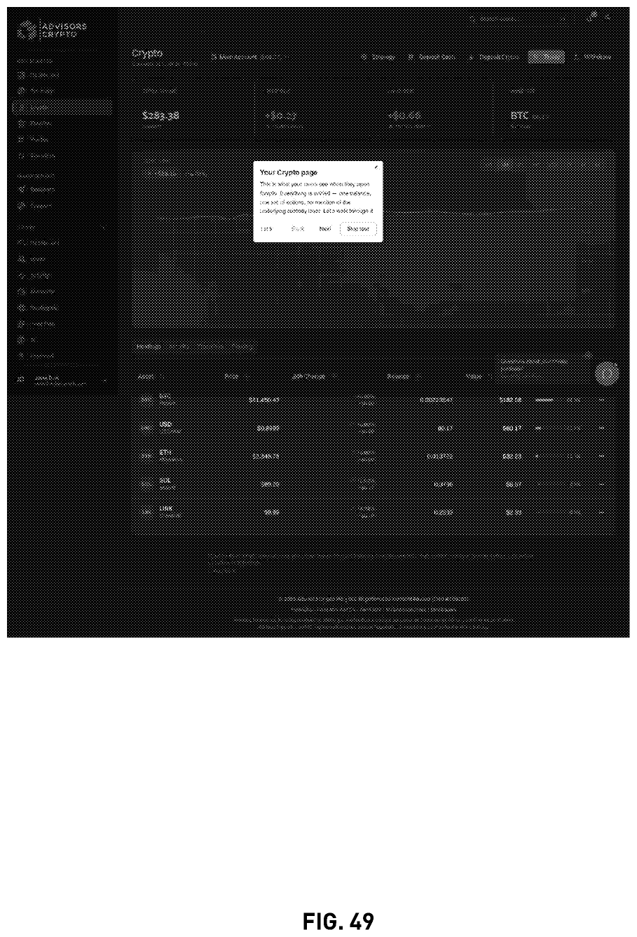

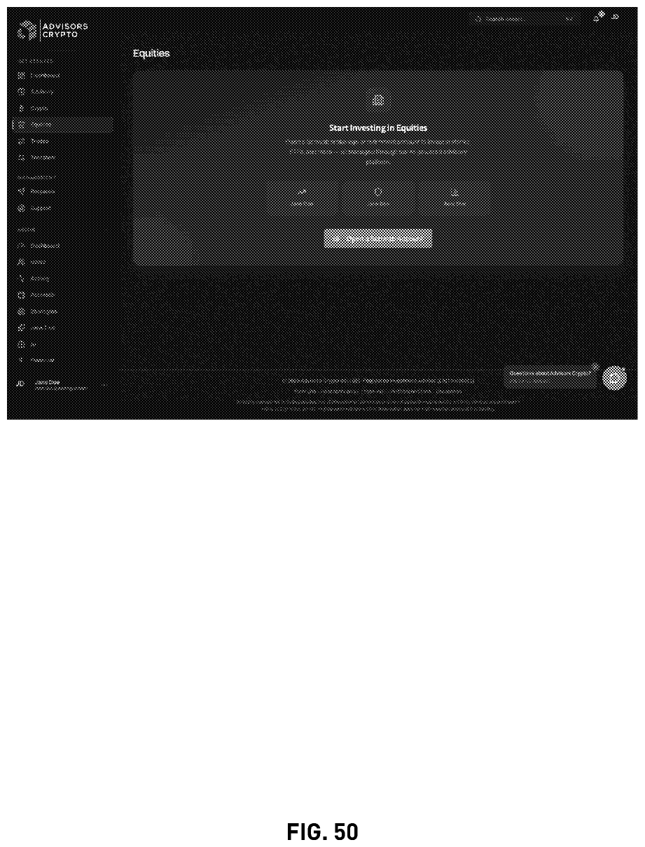

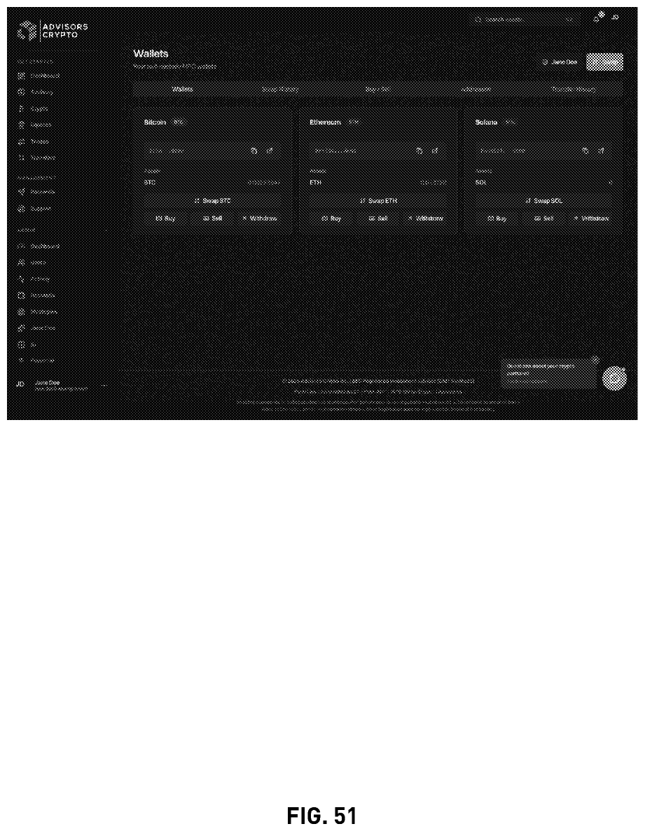

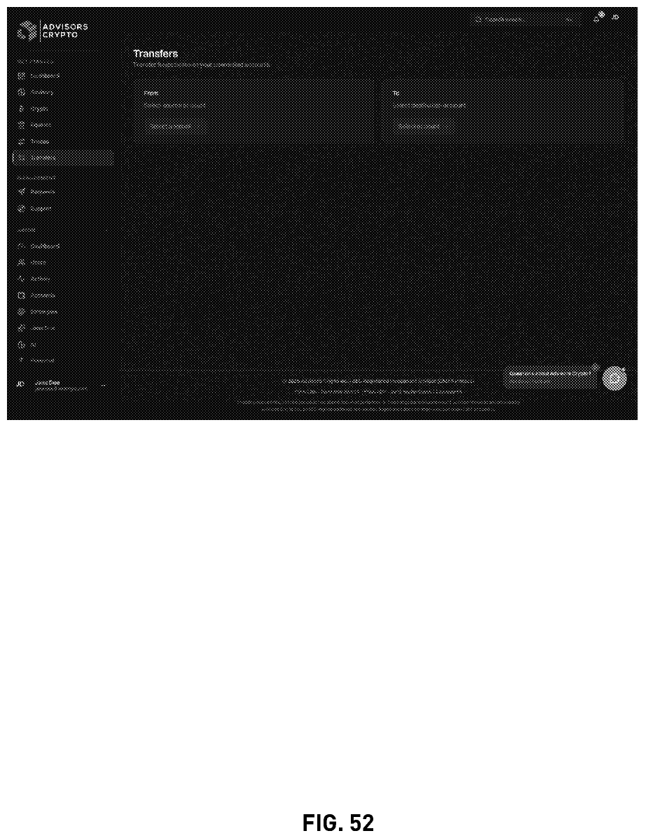

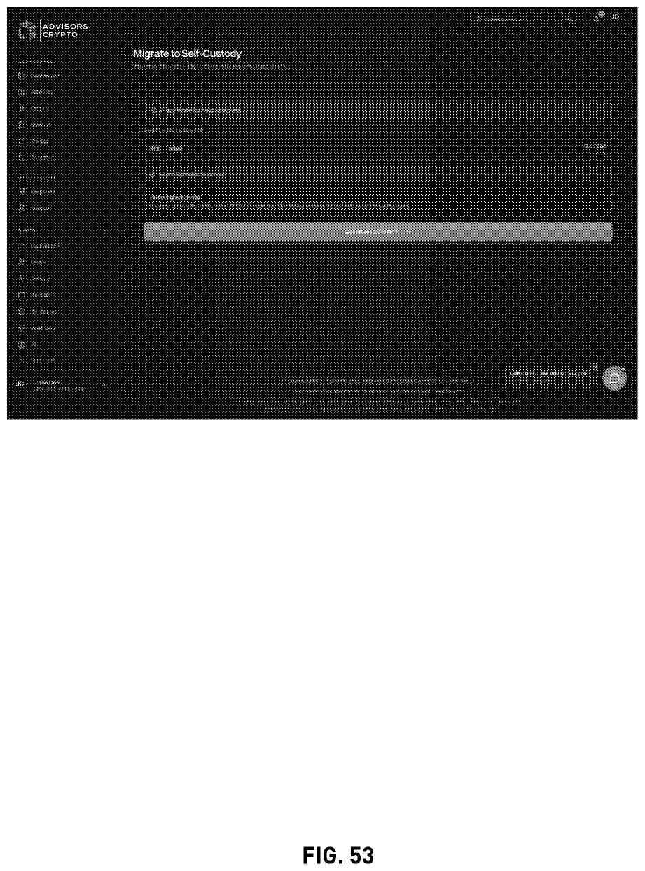

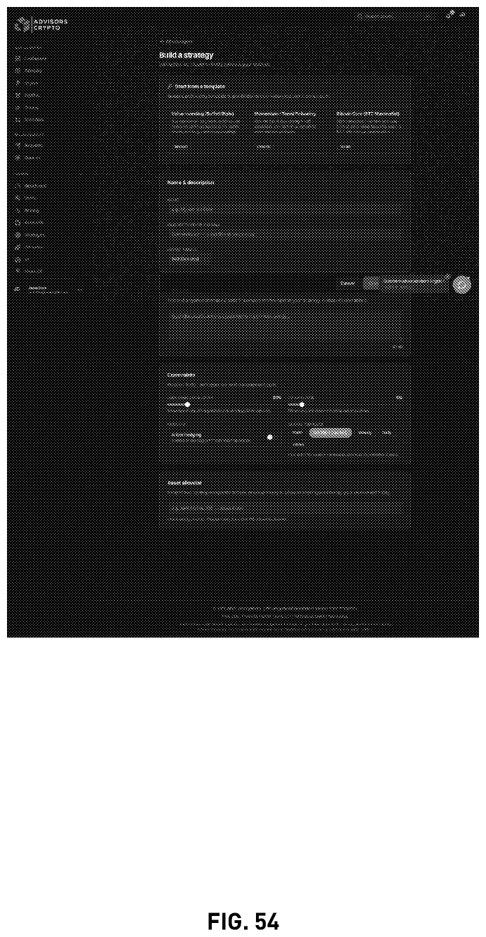

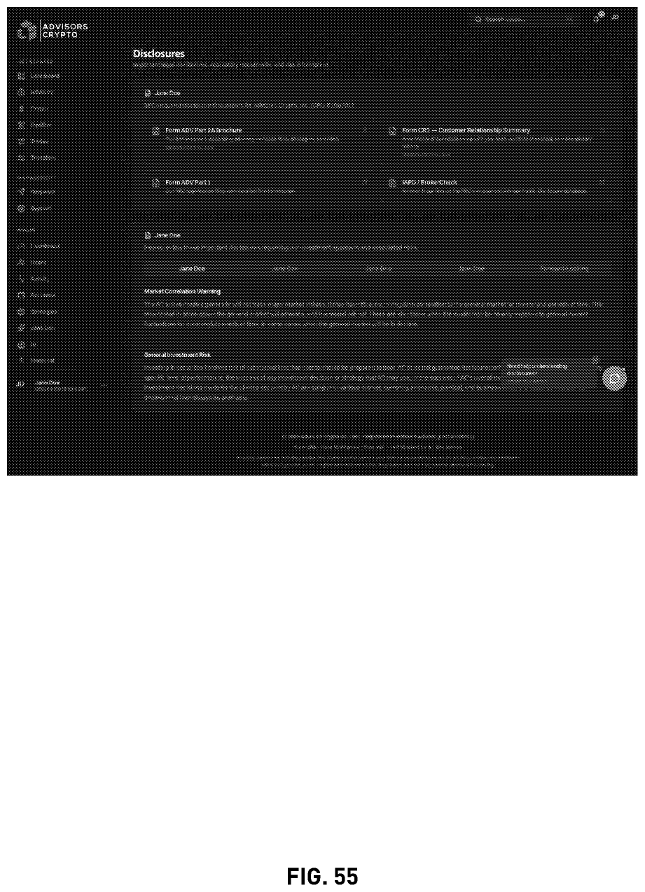

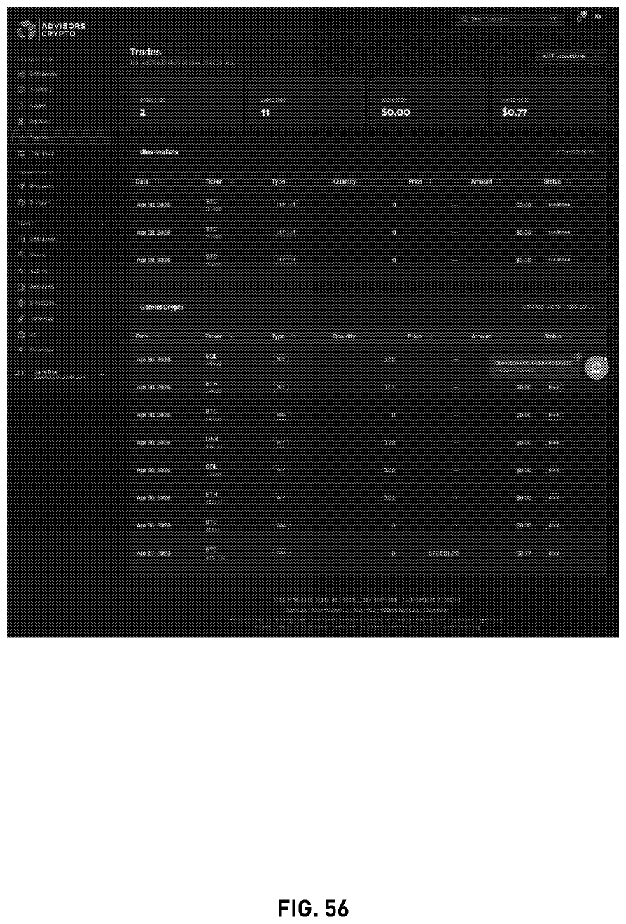

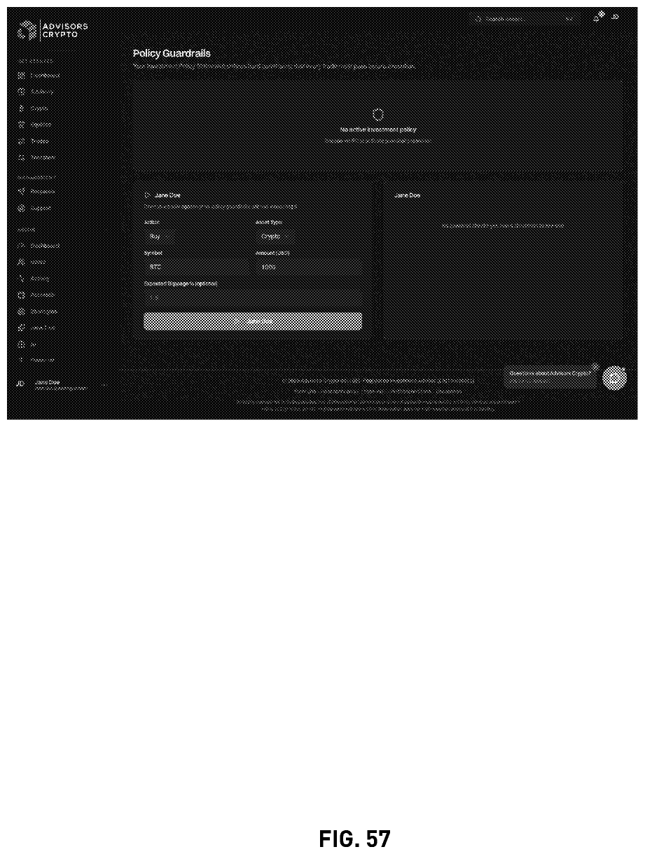

FIGS. 44-57 illustrate example implementations of several screens that incorporate the techniques described herein.

1. A non-transitory computer-readable medium storing instructions that, when executed by one or more processors, cause the one or more processors to perform operations comprising:
(a) receiving an investment-policy intake dataset for an account, portfolio, or mandate, the intake dataset comprising a plurality of policy dimensions that include at least: (i) investment objectives, (ii) risk parameters, (iii) asset-class and instrument eligibility constraints, (iv) exposure limits, (v) liquidity constraints, and (vi) regulatory, tax, jurisdictional, or client-specific restrictions;
(b) validating the intake dataset against a predefined schema that specifies permissible types, ranges, enumerations, and required fields for each policy dimension, and generating one or more validation results identifying missing, conflicting, or out-of-range values;
(c) normalizing the intake dataset into a canonical intermediate policy representation by: (i) converting heterogeneous units and representations into standardized units, (ii) mapping synonymous terms to canonical identifiers, (iii) applying a deterministic precedence rule set to resolve conflicts among policy dimensions, and (iv) ordering fields and constraint expressions according to a canonical ordering specification;
(d) constructing, from the canonical intermediate policy representation, a structured policy model comprising (i) a set of constraint expressions, (ii) a set of objective expressions, and (iii) a set of evaluation contexts that bind the constraint expressions and objective expressions to portfolio state variables, market data variables, and account metadata;
(e) deterministically compiling the structured policy model into a machine-readable investment policy artifact by executing a compilation pipeline that includes at least lexical analysis, parsing into an abstract syntax tree, semantic checking, and code generation, wherein determinism is enforced by use of the canonical ordering specification and deterministic serialization such that identical canonical intermediate policy representations yield byte-identical machine-readable investment policy artifacts;
(f) generating, from the machine-readable investment policy artifact, one or more executable compliance evaluators configured to (i) evaluate proposed trades, orders, or allocations against the set of constraint expressions, and (ii) output an allow/deny decision and one or more violation descriptors identifying violated constraints and associated policy dimensions;
(g) assigning a unique policy identifier to the machine-readable investment policy artifact by computing a cryptographic digest over at least the deterministic serialization of the canonical intermediate policy representation and storing the unique policy identifier in association with the machine-readable investment policy artifact; and
(h) storing the machine-readable investment policy artifact, the unique policy identifier, and an audit record describing at least the validation results, the deterministic precedence rule set applied, and compilation metadata, and providing the machine-readable investment policy artifact to a downstream portfolio construction, order management, execution, rebalancing, or compliance system for runtime enforcement.

2. The non-transitory computer-readable medium of claim 1,
wherein the plurality of policy dimensions further comprises at least one of: environmental, social, and governance (ESG) constraints, concentration limits by issuer, sector, or geography, leverage limits, derivative usage constraints, or time-based rebalancing constraints.

3. The non-transitory computer-readable medium of claim 1,
wherein validating the intake dataset comprises executing a rule-based validation engine that applies cross-dimensional consistency checks to detect logical conflicts between risk parameters and asset-class eligibility constraints.

4. The non-transitory computer-readable medium of claim 1,
wherein normalizing the intake dataset further comprises mapping free-form textual policy inputs to canonical constraint templates using a predefined ontology of investment policy terms.

5. The non-transitory computer-readable medium of claim 1,
wherein the deterministic precedence rule set assigns hierarchical priority among regulatory restrictions, client-imposed restrictions, and discretionary investment guidelines.

6. The non-transitory computer-readable medium of claim 1,
wherein the structured policy model represents constraint expressions using a declarative constraint language that is independent of any downstream portfolio management system.

7. The non-transitory computer-readable medium of claim 1,
wherein deterministically compiling the structured policy model comprises generating a versioned policy bytecode format that is executable by a runtime policy evaluation engine.

8. The non-transitory computer-readable medium of claim 1,
wherein the deterministic serialization comprises lexicographically ordering constraint expressions and eliminating non-semantic whitespace prior to computing the cryptographic digest.

9. The non-transitory computer-readable medium of claim 1,
wherein the executable compliance evaluators are configured to evaluate proposed trades in real time prior to order submission to an execution venue.

10. The non-transitory computer-readable medium of claim 1,
wherein the violation descriptors include machine-readable identifiers corresponding to individual constraint expressions and human-readable explanations derived from the canonical intermediate policy representation.

11. The non-transitory computer-readable medium of claim 1,
wherein storing the audit record further comprises storing a lineage graph that links the machine-readable investment policy artifact to prior versions of the policy and to changes in the intake dataset.

12. The non-transitory computer-readable medium of claim 1,
wherein providing the machine-readable investment policy artifact comprises transmitting the artifact via an application programming interface to a portfolio construction engine configured to generate allocations that are provably compliant with the set of constraint expressions.

13. The non-transitory computer-readable medium of claim 1,
wherein the unique policy identifier is used to enforce consistency of policy application across multiple portfolio management systems operating in distributed computing environments.

14. The non-transitory computer-readable medium of claim 1,
wherein identical investment-policy intake datasets received at different times or from different sources produce identical machine-readable investment policy artifacts.

15. A computer-implemented method for cross-custody trade execution using a deterministic execution state machine, the method comprising:
(a) receiving, by one or more processors, a trade intent for an account having assets custodied across a plurality of custodian systems, the trade intent specifying at least an instrument identifier, a buy or sell side, and a target quantity or target notional amount;
(b) determining, from custody position data and account metadata, (i) a source custody location at which deliverable units, cash, or margin capacity is available to support the trade intent and (ii) a destination custody location at which a resulting position is to be reflected after execution and settlement;
(c) executing, by the one or more processors, a cross-custody execution state machine comprising a plurality of deterministic states and state transitions, including transitioning from an intake state to a funding state in which the method performs a first hop transfer by initiating a movement, reservation, earmark, or pledge of at least one of deliverable units, cash, or margin capacity from the source custody location to an intermediary settlement location comprising an omnibus account, prime broker account, clearing account, or settlement bridge account;
(d) monitoring transfer events and custody-ledger acknowledgements to determine whether the first hop transfer has reached a confirmed state, and blocking release of venue-facing order instructions until the confirmed state is determined;
(e) obtaining market microstructure parameters for an execution venue applicable to the instrument identifier, the market microstructure parameters including at least a tick size and a minimum order quantity and/or minimum order notional;
(f) upon determining that the first hop transfer is confirmed, generating one or more venue-eligible executable order instructions by transforming the target quantity or target notional amount into one or more order quantities that satisfy the tick size and the minimum order quantity and/or minimum order notional, including performing at least one of: rounding to an allowed tick increment, converting between notional and quantity, clipping an order quantity to a permissible minimum, and splitting the trade intent into multiple orders;
(g) submitting the one or more venue-eligible executable order instructions to the execution venue and updating the cross-custody execution state machine responsive to execution events including fills, partial fills, cancellations, or rejections;
(h) responsive to a fill or a set of fills, initiating a second hop transfer that moves, delivers, or books settlement assets from the intermediary settlement location to the destination custody location so that the filled position is reflected at the destination custody location;
(i) reconciling executed quantities derived from the execution events with custody-ledger updates associated with the second hop transfer to detect mismatches between executed amounts and booked amounts;
(j) persisting an execution audit trail that cryptographically or uniquely links the trade intent to (i) the first hop transfer, (ii) the one or more venue-eligible executable order instructions including the tick-size and minimum-aware transformations applied, (iii) execution events received from the execution venue, and (iv) the second hop transfer, together with timestamps and state identifiers for the plurality of deterministic states; and
(k) performing, by the cross-custody execution state machine, at least one deterministic fault-handling action including: (i) re-parameterizing the one or more venue-eligible executable order instructions responsive to a change in the tick size or the minimum order quantity and/or minimum order notional, or (ii) executing an unwind or rollback that reverses at least one of the first hop transfer or the second hop transfer responsive to a rejection, timeout, or settlement failure.

16. The computer-implemented method of claim 15, wherein executing the cross-custody execution state machine comprises transitioning through an ordered sequence of predefined execution states including INTAKE, SOURCE_LOCKED, FIRST_HOP_CONFIRMED, ORDER_RELEASED, EXECUTING, SECOND_HOP_CONFIRMED, and COMPLETE, and wherein each transition is conditioned on satisfaction of custody-ledger, transfer-confirmation, or execution-event predicates.

17. The computer-implemented method of claim 15, wherein generating the one or more venue-eligible executable order instructions further comprises computing a residual quantity or residual notional resulting from enforcement of the tick size and the minimum order quantity and/or minimum order notional, and wherein the method further comprises at least one of:
(i) deferring execution of the residual quantity to a subsequent execution cycle, or
(ii) netting the residual quantity against a later trade intent associated with the same account or instrument.

18. A system for generating investment advice using a two-stage artificial-intelligence advisory pipeline anchored to a policy-derived, allowed-universe-constrained model portfolio, the system comprising:
(a) one or more processors;
(b) a non-transitory memory storing instructions that, when executed by the one or more processors, cause the system to perform operations;
(c) a policy ingestion interface configured to receive an investment policy for an account, mandate, or household, the investment policy comprising at least eligibility constraints and allocation constraints;
(d) a policy-to-universe engine configured to transform the investment policy into (i) an allowed investment universe identifying eligible instruments, asset classes, sleeves, or strategies and (ii) one or more policy-derived constraint functions that are executable to evaluate compliance of portfolios and trades;
(e) a model-portfolio constructor configured to generate, from at least the allowed investment universe and the policy-derived constraint functions, a model portfolio comprising target weights or target exposures that satisfy the policy-derived constraint functions, wherein the model portfolio defines a bounded feasible region for recommendations;
(f) a first-stage advisory model comprising a first machine-learning model executed by the one or more processors and configured to:
(i) receive account state data including at least current holdings, cash, tax-lot or cost basis data when available, risk profile data, and time horizon data, together with the model portfolio;
(ii) generate one or more candidate advisory actions comprising at least one of: a proposed allocation change, a rebalance plan, a set of trade instructions, or a recommended product substitution; and
(iii) generate the candidate advisory actions subject to an allowed-action envelope defined by the model portfolio and the policy-derived constraint functions, including suppressing or modifying candidate advisory actions that would cause a violation of the policy-derived constraint functions;
(g) a second-stage advisory model comprising a second machine-learning model executed by the one or more processors and configured to:
(i) receive the candidate advisory actions produced by the first-stage advisory model;
(ii) evaluate each candidate advisory action against the policy-derived constraint functions and against one or more suitability or objective criteria derived from the investment policy and the account state data;
(iii) produce an advice output that includes (A) a selected advisory action or ranked set of advisory actions that remain within the bounded feasible region defined by the model portfolio, and (B) an explanation artifact comprising machine-readable and human-readable rationale that cites which policy-derived constraints and model-portfolio targets were applied; and
(iv) when a candidate advisory action fails a constraint or suitability evaluation, trigger a revision workflow that causes at least one of: (A) rejection of the candidate advisory action, (B) constraint-aware modification of the candidate advisory action, or (C) regeneration of candidate advisory actions by the first-stage advisory model under tightened bounds;
(h) an execution packaging module configured to convert the advice output into a venue-, custodian-, or order-management-system compatible representation comprising at least one of: an allocation instruction set, an order list, a rebalance ticket, or a trade blotter; and
(i) an audit and lineage store configured to persist an auditable linkage among (i) the investment policy as received, (ii) the allowed investment universe, (iii) the model portfolio,
(iv) intermediate candidate advisory actions generated by the first-stage advisory model, (v) constraint and suitability evaluation results generated by the second-stage advisory model, and
(vi) the advice output, together with timestamps, model identifiers, and version identifiers, wherein the two-stage artificial-intelligence advisory pipeline is anchored to the policy-derived, allowed-universe-constrained model portfolio by requiring that both the first-stage advisory model and the second-stage advisory model restrict generation and selection of advisory actions to those that remain compliant with the policy-derived constraint functions and within the bounded feasible region defined by the model portfolio.

19. The system of claim 18, wherein the model-portfolio constructor is configured to generate the model portfolio by solving a constrained optimization problem over the allowed investment universe, the constrained optimization problem enforcing the policy-derived constraint functions as hard constraints and producing target weights that define the bounded feasible region for both the first-stage advisory model and the second-stage advisory model.

20. The system of claim 18, wherein the first-stage advisory model is configured to generate candidate advisory actions only by selecting from instruments contained in the allowed investment universe and by penalizing or suppressing advisory actions that deviate from the model portfolio beyond a predefined tolerance band derived from the investment policy.
